(19) United States
(12) Patent Application Publication
(10) Pub. No.: US 2024/0045053 A1
(43) Pub. Date: Feb. 8, 2024

(54) POSITIONING VIA ROUND-TRIP CARRIER-PHASE METHOD WITH MULTIPLE-CARRIERS

(71) Applicant: Samsung Electronics Co., Ltd., Suwon-si (KR)

(72) Inventor: Emad Nader Farag, Flanders, NJ (US)

(21) Appl. No.: 18/349,106

(22) Filed: Jul. 7, 2023

Related U.S. Application Data
(60) Provisional application No. 63/390,587, filed on Jul. 19, 2022.
(60) Provisional application No. 63/392,805, filed on Jul. 27, 2022.
(60) Provisional application No. 63/395,669, filed on Aug. 5, 2022.
(60) Provisional application No. 63/395,716, filed on Aug. 5, 2022.
(60) Provisional application No. 63/412,170, filed on Sep. 30, 2022.
(60) Provisional application No. 63/440,318, filed on Jan. 20, 2023.
(60) Provisional application No. 63/456,955, filed on Apr. 4, 2023.
(60) Provisional application No. 63/466,141, filed on May 12, 2023.

(51) Int. Cl. G01S 13/76; H04W 24/08; H04W 24/10; H04L 5/00

(52) U.S. Cl. CPC G01S 13/765; H04W 24/08; H04W 24/10; H04L 5/0048

(57) ABSTRACT

Apparatuses and methods for positioning via a method with multiple carriers. A user equipment (UE) includes a transceiver configured to receive, from a first transmit receive point (TRP), a first downlink (DL) positioning reference signal (PRS). The UE further includes a processor operably coupled to the transceiver. The processor is configured to measure a first carrier phase associated with a first frequency of the first DL PRS, measure a second carrier phase associated with a second frequency of the first DL PRS, and include, in a measurement report, a carrier phase measurement based on the measurement of the first carrier phase and the second carrier phase. The transceiver is further configured to transmit the measurement report to a network.

### CROSS-REFERENCE TO RELATED APPLICATION(S) AND CLAIM OF PRIORITY

This application claims priority under 35 U.S.C. § 119(e) to U.S. Provisional Patent Application No. 63/390,587 filed on Jul. 19, 2022, U.S. Provisional Patent Application No. 63/392,805 filed on Jul. 27, 2022, U.S. Provisional Patent Application No. 63/395,669 filed on Aug. 5, 2022, U.S. Provisional Patent Application No. 63/395,716 filed on Aug. 5, 2022, U.S. Provisional Patent Application No. 63/412,170 filed on Sep. 30, 2022, U.S. Provisional Patent Application No. 63/440,318 filed on Jan. 20, 2023, U.S. Provisional Patent Application No. 63/456,955 filed on Apr. 4, 2023, and U.S. Provisional Patent Application No. 63/466,141 filed on May 12, 2023. The above-identified provisional patent applications are hereby incorporated by reference in their entirety.

### TECHNICAL FIELD

This disclosure relates generally to wireless networks. More specifically, this disclosure relates to positioning via a round-trip carrier phase method with multiple carriers.

### BACKGROUND

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage is of paramount importance.

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

This disclosure provides apparatuses and methods for positioning via a round-trip carrier phase method with multiple carriers.

In one embodiment a user equipment (UE) is provided. The UE includes a transceiver configured to receive, from a first transmit receive point (TRP), a first downlink (DL) positioning reference signal (PRS). The UE further includes a processor operably coupled to the transceiver. The processor is configured to measure a first carrier phase associated with a first frequency of the first DL PRS, measure a second carrier phase associated with a second frequency of the first DL PRS, and include, in a measurement report, a carrier phase measurement based on the measurement of the first carrier phase and the second carrier phase. The transceiver is further configured to transmit the measurement report to a network.

In another embodiment, a base station (BS) is provided. The base station includes a transceiver configured to receive, from a UE, a sounding reference signal (SRS) for positioning. The BS further includes a processor operably coupled to the transceiver. The processor is configured to measure a first carrier phase associated with a first frequency of the SRS, measure a second carrier phase associated with a second frequency of the SRS, include, in a first measurement report, a carrier phase measurement, and transmit, to a location management function (LMF), the measurement report. The carrier phase measurement is based on the measurement of the first carrier phase and measurement of the second carrier phase.

In yet another embodiment, a method of operating a UE is provided. The method includes receiving, from a TRP, a first DL positioning reference signal PRS, measuring a first carrier phase associated with a first frequency of the first DL PRS, measuring a second carrier phase associated with a second frequency of the first DL PRS, including, in a measurement report, a carrier phase measurement based on the measurement of the first carrier phase and the second carrier phase, and transmitting the measurement report to a network.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to embodiments of the present disclosure;

FIGS. 2A and 2B illustrate example wireless transmit and receive paths according to embodiments of the present disclosure;

FIG. 3A illustrates an example gNodeB (gNB) according to embodiments of the present disclosure;

FIG. 3B illustrates an example UE according to embodiments of the present disclosure;

FIG. 4 illustrates an example of DL PRS resources within a slot according to embodiments of the present disclosure;

FIG. 5A illustrates an example overall positioning architecture along with positioning measurements and methods according to embodiments of the present disclosure.

FIG. 5B illustrates an example location management function (LMF) according to embodiments of the present disclosure;

FIG. 6 illustrates an example carrier phase method according to embodiments of the present disclosure;

FIG. 7 illustrates an example round trip carrier-phase method according to embodiments of the present disclosure;

FIG. 8A illustrates an example round trip carrier-phase method according to embodiments of the present disclosure;

FIG. 8B illustrates an example carrier phase method according to embodiments of the present disclosure;

FIG. 8C illustrates an example slope from a best fit phase measurement curve according to embodiments of the present disclosure;

FIG. 8D illustrates an example wireless network according to embodiments of the present disclosure;

FIG. 9 illustrates an example two element antenna array according to embodiments of the present disclosure; and

FIG. 10 illustrates an example method of positioning via round-trip carrier-phase method with multiple-carriers according to embodiments of the present disclosure.

### DETAILED DESCRIPTION

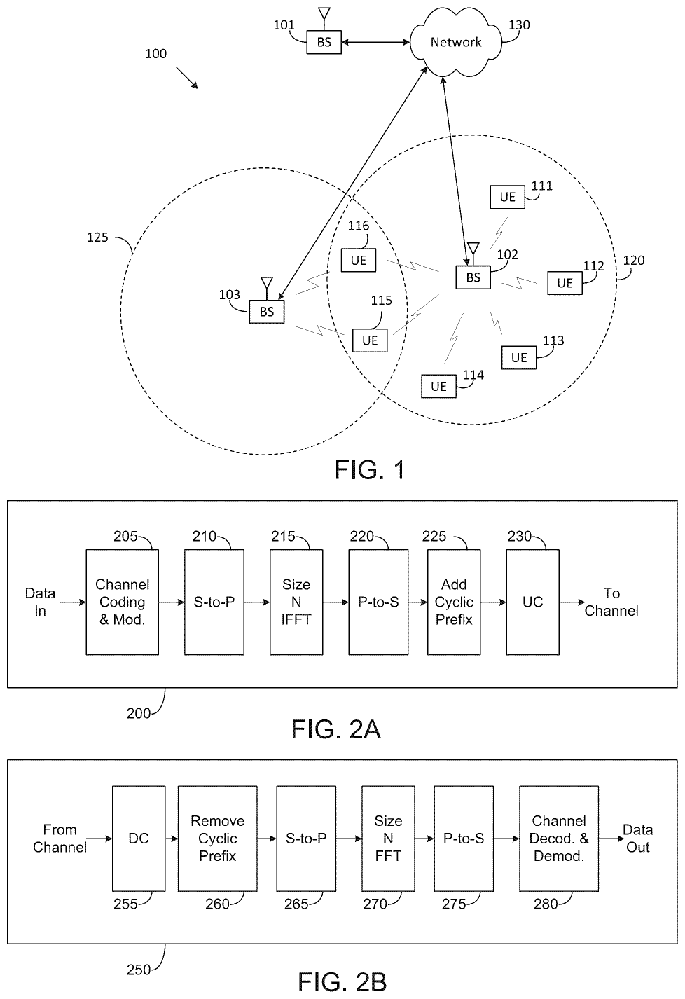

FIGS. 1 through 10, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation, radio access technology (RAT)-dependent positioning and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3B below describe various embodiments implemented in wireless communications systems and with the use of orthogonal frequency division multiplexing (OFDM) or orthogonal frequency division multiple access (OFDMA) communication techniques. The descriptions of FIGS. 1-3B are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (Ues) within a coverage area 120 of the gNB 102. The first plurality of Ues includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of Ues within a coverage area 125 of the gNB 103. The second plurality of Ues includes the UE 115 and the UE 116. In some embodiments, one or more of the gNBs 101-103 may communicate with each other and with the Ues 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the uEs 111-116 include circuitry, programing, or a combination thereof, for positioning via a round-trip carrier phase method with multiple carriers. In certain embodiments, one or more of the gNBs 101-103 includes circuitry, programing, or a combination thereof, to support positioning via a round-trip carrier phase method with multiple carriers in a wireless communication system.

Although FIG. 1 illustrates one example of a wireless network, various changes may be made to FIG. 1. For example, the wireless network could include any number of gNBs and any number of uEs in any suitable arrangement. Also, the gNB 101 could communicate directly with any number of uEs and provide those uEs with wireless broadband access to the network 130. Similarly, each gNB 102-103 could communicate directly with the network 130 and provide uEs with direct wireless broadband access to the network 130. Further, the gNBs 101, 102, and/or 103 could provide access to other or additional external networks, such as external telephone networks or other types of data networks.

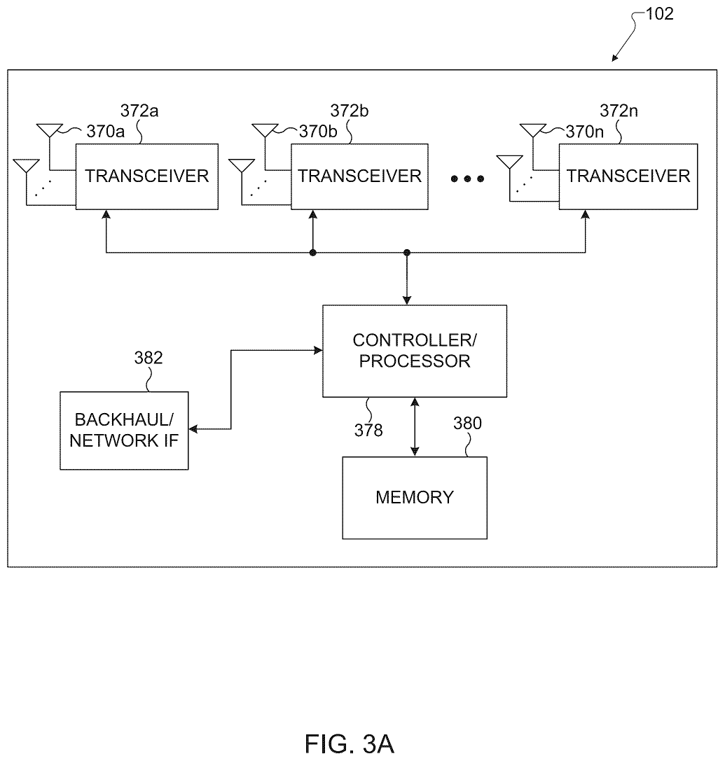

FIGS. 2A and 2B illustrate example wireless transmit and receive paths according to embodiments of the present disclosure. In the following description, a transmit path 200 may be described as being implemented in an gNB (such as gNB 102), while a receive path 250 may be described as being implemented in a UE (such as UE 116). However, it will be understood that the receive path 250 can be implemented in an gNB and that the transmit path 200 can be implemented in a UE. In some embodiments, the transmit path 200 and the receive path 250 are configured to support positioning via a round-trip carrier phase method with multiple carriers in a wireless communication system as described in embodiments of the present disclosure.

The transmit path 200 includes a channel coding and modulation block 205, a serial-to-parallel (S-to-P) block 210, a size N Inverse Fast Fourier Transform (IFFT) block 215, a parallel-to-serial (P-to-S) block 220, an add cyclic prefix block 225, and an up-converter (UC) 230. The receive path 250 includes a down-converter (DC) 255, a remove cyclic prefix block 260, a serial-to-parallel (S-to-P) block 265, a size N Fast Fourier Transform (FFT) block 270, a parallel-to-serial (P-to-S) block 275, and a channel decoding and demodulation block 280.

In the transmit path 200, the channel coding and modulation block 205 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 210 converts (such as de-multiplexes) the serial modulated symbols to parallel data in order to generate N parallel symbol streams, where N is the IFFT/FFT size used in the gNB 102 and the UE 116. The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 in order to generate a serial time-domain signal. The add cyclic prefix block 225 inserts a cyclic prefix to the time-domain signal. The up-converter 230 modulates (such as up-converts) the output of the add cyclic prefix block 225 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116. The down-converter 255 down-converts the received signal to a baseband frequency, and the remove cyclic prefix block 260 removes the cyclic prefix to generate a serial time-domain baseband signal. The serial-to-parallel block 265 converts the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream.

Each of the gNBs 101-103 may implement a transmit path 200 that is analogous to transmitting in the downlink to uEs 111-116 and may implement a receive path 250 that is analogous to receiving in the uplink from uEs 111-116. Similarly, each of uEs 111-116 may implement a transmit path 200 for transmitting in the uplink to gNBs 101-103 and may implement a receive path 250 for receiving in the downlink from gNBs 101-103.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 2A and 2B illustrate one example of wireless transmit and receive paths, various changes may be made to FIGS. 2A and 2B. For example, the blocks could be arranged in a different order or arranged to operate concurrently, additional blocks may be added, some blocks may be omitted, etc.

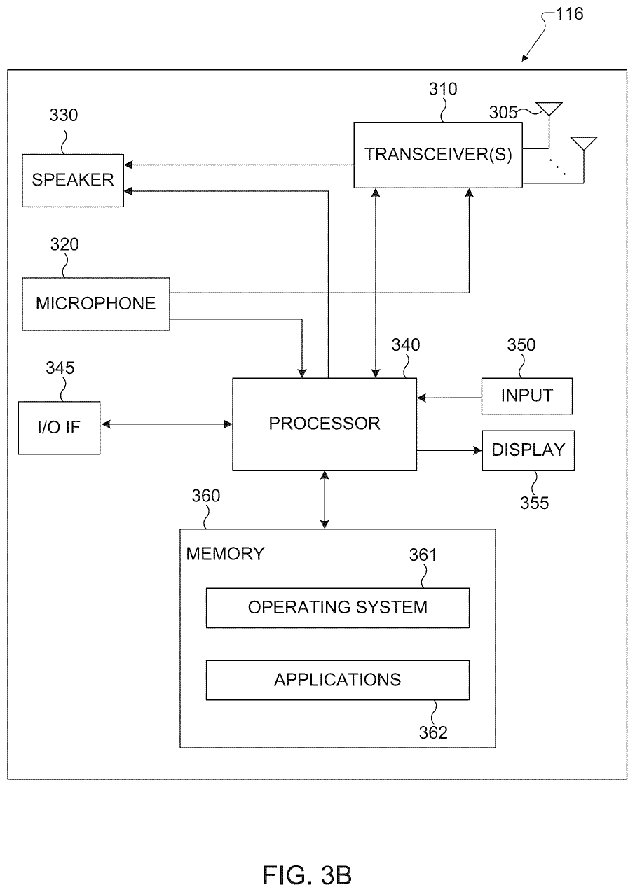

FIG. 3A illustrates an example gNB 102 according to embodiments of the present disclosure. The embodiment of the gNB 102 illustrated in FIG. 3A is for illustration only, and the gNBs 101 and 103 of FIG. 1 could have the same or similar configuration. However, gNBs come in a wide variety of configurations, and FIG. 3A does not limit the scope of this disclosure to any particular implementation of a gNB.

As shown in FIG. 3A, the gNB 102 includes multiple antennas 370a-370n, multiple transceivers 372a-327n, a controller/processor 378, a memory 380, and a backhaul or network interface 382.

The transceivers 372a-372n receive, from the antennas 370a-370n, incoming RF signals, such as signals transmitted by uEs in the network 100. The transceivers 372a-372n down-convert the incoming RF signals to generate IF or baseband signals. The IF or baseband signals are processed by receive (RX) processing circuitry in the transceivers 372a-372n and/or controller/processor 378, which generates processed baseband signals by filtering, decoding, and/or digitizing the baseband or IF signals. The controller/processor 378 may further process the baseband signals.

Transmit (TX) processing circuitry in the transceivers 372a-372n and/or controller/processor 378 receives analog or digital data (such as voice data, web data, e-mail, or interactive video game data) from the controller/processor 378. The TX processing circuitry encodes, multiplexes, and/or digitizes the outgoing baseband data to generate processed baseband or IF signals. The transceivers 372a-372n up-converts the baseband or IF signals to RF signals that are transmitted via the antennas 370a-370n.

The controller/processor 378 can include one or more processors or other processing devices that control the overall operation of the gNB 102. For example, the controller/processor 378 could control the reception of UL channels and/or signals and the transmission of DL channels and/or signals by the transceivers 372a-372n in accordance with well-known principles. The controller/processor 378 could support additional functions as well, such as more advanced wireless communication functions and/or positioning functions. For instance, the controller/processor 378 could support beam forming or directional routing operations in which outgoing/incoming signals from/to multiple antennas 370a-370n are weighted differently to effectively steer the outgoing signals in a desired direction. Any of a wide variety of other functions could be supported in the gNB 102 by the controller/processor 378.

The controller/processor 378 is also capable of executing programs and other processes resident in the memory 380, such as an OS and, for example, processes to support positioning via a round-trip carrier phase method with multiple carriers as discussed in greater detail below. The controller/processor 378 can move data into or out of the memory 380 as required by an executing process.

The controller/processor 378 is also coupled to the backhaul or network interface 382. The backhaul or network interface 382 allows the gNB 102 to communicate with other devices or systems over a backhaul connection or over a network. The interface 382 could support communications over any suitable wired or wireless connection(s). For example, when the gNB 102 is implemented as part of a cellular communication system (such as one supporting 5G/NR, LTE, or LTE-A), the interface 382 could allow the gNB 102 to communicate with other gNBs over a wired or wireless backhaul connection. When the gNB 102 is implemented as an access point, the interface 382 could allow the gNB 102 to communicate over a wired or wireless local area network or over a wired or wireless connection to a larger network (such as the Internet). The interface 382 includes any suitable structure supporting communications over a wired or wireless connection, such as an Ethernet or transceiver.

The memory 380 is coupled to the controller/processor 378. Part of the memory 380 could include a RAM, and another part of the memory 380 could include a Flash memory or other ROM.

Although FIG. 3A illustrates one example of gNB 102, various changes may be made to FIG. 3A. For example, the gNB 102 could include any number of each component shown in FIG. 3A. Also, various components in FIG. 3A could be combined, further subdivided, or omitted and additional components could be added according to particular needs.

FIG. 3B illustrates an example UE 116 according to embodiments of the present disclosure. The embodiment of the UE 116 illustrated in FIG. 3B is for illustration only, and the uEs 111-115 of FIG. 1 could have the same or similar configuration. However, uEs come in a wide variety of configurations, and FIG. 3B does not limit the scope of this disclosure to any particular implementation of a UE.

As shown in FIG. 3B, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channels and/or signals and the transmission of UL channels and/or signals by the transceiver(s) 310 in accordance with well-known principles. In some embodiments, the processor 340 includes at least one microprocessor or microcontroller.

The processor 340 is also capable of executing other processes and programs resident in the memory 360, for example, processes for positioning via a round-trip carrier phase method with multiple carriers as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3B illustrates one example of UE 116, various changes may be made to FIG. 3B. For example, various components in FIG. 3B could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3B illustrates the UE 116 configured as a mobile telephone or smartphone, uEs could be configured to operate as other types of mobile or stationary devices.

The following documents and standards descriptions are hereby incorporated into the present disclosure as if fully set forth herein: [1] 3GPP TS 38.211 v17.4.0, “NR; Physical channels and modulation.” [2] 3GPP TS 38.212 v17.4.0, “NR; Multiplexing and Channel coding.” [3] 3GPP TS 38.213 v17.4.0, “NR; Physical Layer Procedures for Control.” [4] 3GPP TS 38.214 v17.4.0, “NR; Physical Layer Procedures for Data.” [5] 3GPP TS 38.215 v17.2.0, “NR; Physical Layer Measurements.” [6] 3GPP TS 38.321 v17.3.0, “NR; Medium Access Control (MAC) protocol specification.” [7] 3GPP TS 38.331 v17.3.0, “NR; Radio Resource Control (RRC) Protocol Specification.” [8] 3GPP TS 36.213 v17.4.0, “Evolved Universal Terrestrial Radio Access (E-UTRA); Physical layer procedures.”

A time unit for DL signaling, for UL signaling, or for SL signaling on a cell is one symbol. A symbol belongs to a slot that includes a number of symbols such as 14 symbols. A slot may also be used as a time unit. A bandwidth (BW) unit is referred to as a resource block (RB). One RB includes a number of sub-carriers (SCs). For example, a slot may have duration of one millisecond and an RB may have a bandwidth of 180 kHz and include 12 SCs with inter-SC spacing of 15 kHz. As another example, a slot may have a duration of 0.25 milliseconds and include 14 symbols and an RB may have a BW of 720 kHz and include 12 SCs with SC spacing of 60 kHz. An RB in one symbol of a slot is referred to as physical RB (PRB) and may include a number of resource elements (rEs). A slot may be either a full DL slot, a full UL slot, or a hybrid slot similar to a special subframe in time division duplex (TDD) systems (see also TS 38.211). In addition, a slot may have symbols for SL communications. A UE may be configured for one or more bandwidth parts (BWPs) of a system BW for transmissions or receptions of signals or channels.

The time-continuous signal sₗ^{(p,μ)}(t) on antenna port p and with sub-carrier spacing configuration μ for OFDM symbol l in a subframe for any physical channel or signal, except PRACH is given by:

$${s}_{l}^{( p , μ )} ( t ) = \{ \begin{matrix}{\overline{s}}_{l}^{( p , μ )} & ( t ) {t}_{s t a r t , l}^{μ} \leq t < {t}_{s t a r t , l}^{μ} + {T}_{s y m b , l}^{μ} \\ 0 & otherwise\end{matrix}$$

### Where,

l∈{0,1, . . . ,Nₛₗₒₜ^{subframe,μ}·N_{symb}^{slot}−1},
Nₛₗₒₜ^{subframe,μ} is the number of slots in a subframe with sub-carrier spacing configuration μ,
N_{symb}^{slot} is the number of symbols in a slot, for example 14 symbols in a slot.
t_{start,l}^{μ} is the start of symbol l,
T_{symb,l}^{μ}=(Nᵤ^{μ}+N_{CP,l}^{μ})T_{c} is the duration of symbol l, Nᵤ^{μ}=2048κ·2^{-μ} and N_{CP,l}^{μ} is the CP length for symbol l, N_{CP,l}^{μ} is given by:

$${N}_{CP , l}^{μ} = \{ \begin{matrix}512 κ \cdot {2}^{- μ} & extended cyclic prefix \\ 144 κ \cdot {2}^{- μ} + 16 κ & normal cyclic prefix , l = 0 or l = 7 \cdot {2}^{- μ} \\ 144 κ \cdot {2}^{- μ} & normal cyclic prefix , l \neq 0 and l \neq 7 \cdot {2}^{- μ}\end{matrix} ,$$

κ=64 which is the ratio between Tₛ and T_{c}. Tₛ=1/(Δf_{ref}·N_{f,ref}), with Δf_{ref}=15 kHz and N_{f,ref}=2048. T_{c}=1/(Δfₘₐₓ·N_{f}), with Δfₘₐₓ=480 kHz and N_{f}=4096.

$${\overline{s}}_{l}^{( p μ )} ( t ) = {Σ}_{k = 0}^{{N}_{grid , x}^{size , μ} \cdot {N}_{sc}^{R B} - 1} {a}_{k , l}^{( p , μ )} {e}^{j 2 π ( k + {k}_{0}^{μ} \frac{{N}_{grid , x}^{s ize , μ} {N}_{sc}^{R B}}{2} ) Δ f ( t - {N}_{CP , l}^{μ} {T}_{c} - {t}_{s t art , l}^{μ} )} ,$$

N_{grid,x}^{size,μ} is a resource grid size in resource blocks for a carrier with sub-carrier spacing μ, x provides the transmission direction and can be UL or DL or SL, N_{grid,x}^{size,μ} is indicated by higher layer signaling, where a resource block has N_{sc}^{RB} sub-carriers, in one example, N_{sc}^{RB} can be 12 sub-carriers,
N_{grid,x}^{start,μ} is the starting position of the resource grid of a carrier with sub-carrier spacing μ provided by higher layer parameter offsetToCarrier in the SCS-SpecificCarrier IE, which is defined as an offset in frequency domain between Point A (lowest subcarrier of common RB 0) and the lowest usable subcarrier on this carrier in number of PRBs (using the subcarrierSpacing defined for this carrier),
Δf is the sub-carrier spacing corresponding to the sub-carrier spacing configuration, Δf=15·2^{μ} kHz, where μ=0, 1, 2, 3, and 4 for sub-carrier spacing; 15, 30, 60, 120 and 240 kHz respectively, the frequency location of a subcarrier refers to the center frequency of that subcarrier,
a_{k,l}^{(p,μ)} is the resource element value for sub-carrier k and symbol l, on antenna port p and with sub-carrier configuration μ, and

$${k}_{0}^{μ} = \frac{{N}_{grid , x}^{s t a r t μ} + {N}_{grid , x}^{s ize , μ}}{2} {N}_{sc}^{R B} - \frac{{N}_{grid , x}^{s t art , {μ}_{0}} + {N}_{grid , x}^{s ize , {μ}_{0}}}{2} {N}_{sc}^{R B} \cdot {2}^{{μ}_{0} - μ} ,$$

with μ₀ being the largest sub-carrier spacing configuration configured by the higher layer parameters scs-SpecificCarrierList.

The generated OFDM symbol, sₗ^{(p,μ)}(t), is then up converted to the carrier frequency f_{c} using the following equation:

$${s}_{l}^{( p , μ )} ( t ) = Re \{ {s}_{l}^{( p , μ )} ( t ) \cdot {e}^{j 2 π {f}_{0} ( t - {t}_{start , l}^{μ} - {N}_{CP , l}^{μ} {T}_{C}} \}$$

In downlink, the UE receives DL positioning reference signal (PRS), where a positioning frequency layer consists of one or more DL PRS resources sets. Each DL PRS resource set consists of one or more DL PRS resources.

The reference signal sequence is defined by:

$$r ( m ) = \frac{1}{\sqrt{2}} ( ( 1 - 2 c ( 2 m ) ) + j ( 1 - 2 c ( 2 m + 1 ) ) )$$

The pseudo-random sequence c(n) is a length-31 Gold sequence defined as

c(n)=(x₁(n+N_{c})+x₂(n+N_{c}))mod 2

### Where,

N_{c}=1600

x₁(n+31)=(x₁(n+3)+x₁(n))mod 2

x₂(n+31)=(x₂(n+3)+x₂(n+2)+x₂(n+1)+x₂(n))mod 2
The first m-sequence is initialized with x₁(0)=1, and x₁(n)=0, for n=1 . . . 30.
The second m-sequence is initialized with cᵢₙᵢₜ, where cᵢₙᵢₜ

$${c}_{init} = ( {2}^{22} ⌊ \frac{{n}_{ID , seq}^{PRS}}{1024} ⌋ + {2}^{10} ( {N}_{symb}^{slot} {n}_{s , f}^{μ} + l + 1 ) ( 2 ( {n}_{ID , seq}^{PRS} mod 1024 ) + 1 ) + ( ( {n}_{ID , seq}^{PRS} mod 1024 ) ) ) mod {2}^{31}$$

Where, N_{symb}^{slot} is the number of symbols per slot, n_{s,f}^{μ} is the slot number, l is the symbol number within a slot and n_{ID,seq}^{PRS} is a higher layer provided parameter (dl-PRS-SequenceID-r16), with n_{ID,seq}^{PRS}∈{0, 1, . . . , 4095}.

The DL PRS sequence is mapped to resource elements a_{k,l}^{(p,μ)} within a slot, where k is the sub-carrier frequency, l is the symbol number within the slot, p is the antenna port, which for DL PRS is p=5000 and μ is the sub-carrier spacing configuration, by

a_{k,l}^{(p,μ)}=β_{PRS}r(m)

### Where,

β_{PRS} is a scaling factor, m=0, 1, . . .
k=m K_{comb}^{PRS}+((k_{offset}^{PRS}+k′) mod K_{comb}^{PRS}), K_{comb}^{PRS} is the comb size, which is given by higher layer parameter dl-PRS-CombSizeN, with K_{comb}^{PRS}∈{2,4,6,12}, k_{offset}^{PRS} is the sub-carrier offset, which is given by higher layer parameter dl-PRS-ReOffset, with k_{offset}^{PRS}∈{0, 1, . . . , K_{comb}^{PRS}−1}, k′ is a sub-carrier offset that is a function of the symbol number within a slot a given by Table 1.
l=lₛₜₐᵣₜ^{PRS}, lₛₜₐᵣₜ^{PRS}++1, . . . , lₛₜₐᵣₜ^{PRS}+L_{PRS}−1, lₛₜₐᵣₜ^{PRS} is the first DL PRS symbol in a slot, which is given by higher layer parameter dl-RS-ResourceSymbolOffset, L_{PRS} is the number of DL PRS symbols in a slot, with L_{PRS}∈{2,4,6,12}.

TABLE 1

| | Symbol number within PRS resource l − lₛₜₐᵣₜ^{PRS} | | | | | | | | | | | |
|---|---|---|---|---|---|---|---|---|---|---|---|---|
| K_{comb}^{PRS} | 0 | 1 | 2 | 3 | 4 | 5 | 6 | 7 | 8 | 9 | 10 | 11 |
| 2 | 0 | 1 | 0 | 1 | 0 | 1 | 0 | 1 | 0 | 1 | 0 | 1 |
| 4 | 0 | 2 | 1 | 3 | 0 | 2 | 1 | 3 | 0 | 2 | 1 | 3 |
| 6 | 0 | 3 | 1 | 4 | 2 | 5 | 0 | 3 | 1 | 4 | 2 | 5 |
| 12 | 0 | 6 | 3 | 9 | 1 | 7 | 4 | 10 | 2 | 8 | 5 | 11 |

The allowed combination of {L_{PRS},K_{comb}^{PRS}} is one of {{2,2}, {4,2}, {6,2}, {12,2}, {4,4}, {12,4}, {6,6}, {12,6}, {12,12}}.

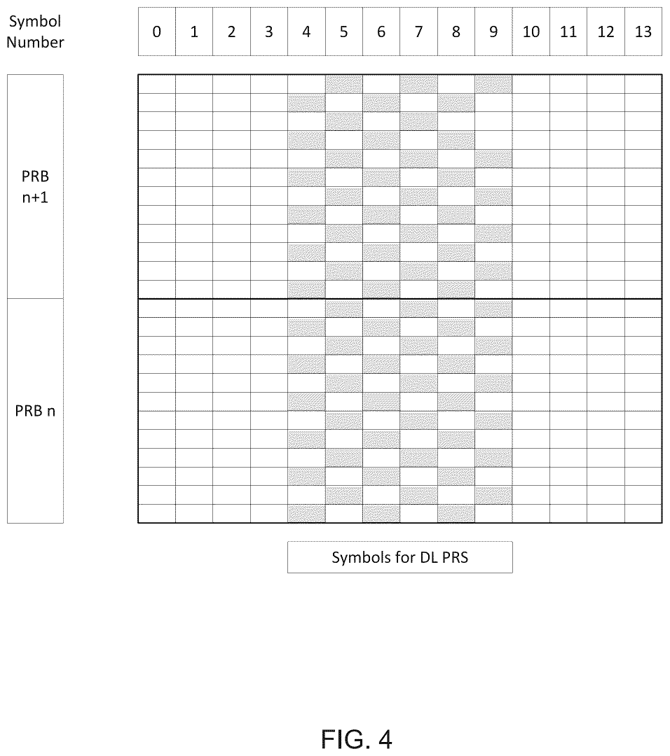

FIG. 4 illustrates an example of DL PRS resources within a slot according to embodiments of the present disclosure. The embodiment of the DL PRS resources illustrated in FIG. 4 is for illustration only. Other embodiments of DL PRS resources could be used without departing from the scope of this disclosure.

In the example of FIG. 4, K_{comb}^{PRS}=2, k_{offset}^{PRS}=0, L_{PRS}=6, and lₛₜₐᵣₜ^{PRS}=4.

Although FIG. 4 illustrates one example of DL PRS resources, various changes may be made to FIG. 4. For example, parameters may differ, etc.

In uplink, a UE may transmit positioning sounding reference signal (SRS). A positioning SRS may be configured by higher layer IE SRS-PosResource. The positioning SRS sequence may a low PAPR sequence of length N_{ZC}=M_{sc,b}^{SRS} given by:

r^{(p)}(n,l′)=r_{u,v}^{(α,δ)}(n)=e^{jαn}r̅_{u,v}(n),0≤n<M_{ZC}

where M_{ZC}=mN_{sc}^{RB}/2^{δ}, δ=log(K_{TC}), with K_{TC} being the transmission comb number that is provided in higher layer IR transmissionComb, K_{TC}∈{2,4,8}. l′ is the positioning SRS symbol within a positioning SRS resource of a slot, l′∈{0, 1, . . . , N_{symb}^{SRS}−1}, N_{symb}^{SRS} is the number of SRS symbols in a slot. For positioning SRS, there may be one antenna port, the cyclic shift α may be given by

$$α = 2 π \frac{{n}_{SRS}^{cs}}{{n}_{SRS}^{cs , max}} ,$$

with n_{SRS}^{cs} being provided by a higher layer in IE transmissionComb, n_{SRS}^{cs,max} depends on K_{TC} as illustrated in Table 2.

TABLE 2

| K_{TC} | n_{SRS}^{cs,max} |
|---|---|
| 2 | 8 |
| 4 | 12 |
| 8 | 6 |

u is the group number u∈{0, 1, . . . , 29}, v is the base sequence number, with v∈{0, 1}, if 6≤N_{ZC}≤60 and v∈{0}, if 60<N_{ZC}. The base sequence, r̅_{u,v}(n), is generated as follows:
1. For N_{ZC}∈{6,12,18,24}, r̅_{u,v}(n)=e^{jϕ(n)π/4}, with 0≤n<M_{ZC}−1. ϕ(n) is given by Tables 5.2.2.2-1 to 5.2.2.2-4 of TS 38.211.

$$For {N}_{ZC} = 30 , {\overline{r}}_{u , v} ( n ) = {e}^{- j \frac{π ( u + 1 ) ( n + 1 ) ( n + 2 )}{31}}$$

with 0≤n<M_{ZC}−1.

$$For {N}_{ZC} \geq 30 , {\overline{r}}_{u , v} ( n ) = {x}_{q} ( n mod {N}_{ZC} ) , {x}_{q} ( n ) = {e}^{- j \frac{π qm ( m + 1 )}{{N}_{ZC}}} . \qquad 2$$

is the largest prime number less

$${M}_{ZC \cdot } q = ⌊ \overline{q} + 1 / 2 ⌋ + v \cdot {( - 1 )}^{⌊ 2 \overline{q} ⌋} \cdot \overline{q} = {N}_{ZC} \frac{u + 1}{31} . \qquad 3$$

The sequence group u is given by: u=(f_{gh}((n_{s,f}^{μ}, l′)+n_{ID}^{SRS}). Where, n_{ID}^{SRS} is provided by higher layer parameter sequenceID, with n_{ID}^{SRS}∈{0, 1, . . . , 65535}. Higher layer parameter groupOrSeqeunceHopping determines the values of u and v:
if groupOrSequenceHopping equals ‘neither’, neither group, nor sequence hopping shall be used and f_{gh}(n_{s,f}^{μ}, l′)=0, and v=0.
if groupOrSequenceHopping equals ‘groupHopping’, group hopping but not sequence hopping is used and v=0, and f_{gh}(n_{s,f}^{μ}, l′)=(Σₘ₌₀⁷ c(8(n_{s,f}^{μ}N_{symb}^{slot}+l₀+l′)+m)·2^{m})mod 30, N_{symb}^{slot} is the number of symbols in a slot, l₀ is the first positioning SRS symbols in the slot, and c(n) a length-31 Gold sequence defined as c(n)=(x₁(n+N_{c})+x₂(n+N_{c})) mod 2, with N_{c}=1600, x₁(n+31)=(x₁(n+3)+x₁(n))mod 2, x₂(n+31)=(x₂(n+3)+x₂(n+2)+x₂(n+1)+x₂(n)) mod 2, the first m-sequence is initialized with x₁(0)=1, and x₁(n)=0, for n=1 . . . 30. The second m-sequence is initialized with cᵢₙᵢₜ, where cᵢₙᵢₜ=n_{ID}^{SRS}
if groupOrSequenceHopping equals ‘sequenceHopping’, sequence hopping but not group hopping is used and f_{gh}(n_{s,f}^{μ}, l′)=0 and

$$v = \{ \begin{matrix}c ( {n}_{s , f}^{μ} {N}_{symb}^{slot} + {l}_{0} + {l}^{′} ) & {M}_{sc , b}^{SRS} \geq 6 {N}_{sc}^{RB} \\ 0 & otherwise\end{matrix}$$

N_{symb}^{slot} is the number of symbols in a slots, l₀ is the first positioning SRS symbols in the slot, and c(n) a length-31 Gold sequence as previously defined.

The positioning SRS sequence, r^{(p)}(n, l′), may be mapped to resource elements a_{k,l}^{(p)} within a slot, where k is the sub-carrier frequency, l is the symbol number within the slot and p is the antenna port, where for positioning SRS there is one antenna port, by

a_{k,l}^{(p)}=β_{SRS}r^{(p)}(k′,l′)

l=l′+l₀

### Where,

β_{SRS} is a scaling factor, k′=0, 1, . . . , M_{sc,b}^{SRS}−1, M_{sc,b}^{SRS}=m_{SRS,b} N_{sc}^{RB}/K_{TC}, m_{SRS,b} is provided by Table 6.4.14.3-1 of TS 38.211, and l′=0, 1, . . . , N_{symb}^{SRS}−1.
l=l′+l₀, with l₀ the first positioning SRS symbols in the slot, where l₀∈{0, 1, . . . , 13}.
k=K_{TC}k′+k₀^{(p)}, K_{TC} is the transmission comb number as previously described, k₀^{(p)}=k̅₀^{(p)}+Σ_{b=0}^{B}^{_{SRS}}K_{TC}M_{sc,b}^{SRS}n_{b}, k̅₀^{(p)}=n_{shift}N_{sc}^{RB}+(k_{TC}^{(p)}+k_{offset}^{l′})mod K_{TC}, k=k_{TC}^{(p)}=k̅_{TC} for positioning SRS, k̅_{TC} is the transmission comb offset included within higher layer IE transmissionComb, with k̅_{TC}∈{0, 1, . . . , K_{TC}−1}, k_{offset}^{l′} is a symbol dependent sub-carrier offset given by Table 3, n_{shift} is given by higher layer parameter freqDomainShift and it adjusts the frequency allocation with respect to a reference point. If N_{BWP}^{start}≤_{shift} the reference point for k₀^{(p)} is sub-carrier 0 in common resource block 0, otherwise the reference point is the lowest subcarrier of the BWP. n_{b} is a frequency positioning index. For positioning SRS, B_{SRS}=0, bₕₒₚ=0, and frequency hopping is disable. n_{b} is given by:

$${n}_{b} = ⌊ \frac{4 {n}_{RRC}}{{m}_{SRS , b}} ⌋ mod {N}_{b}$$

n_{RRC} is given by higher layer parameter freqDomainPosition, and m_{SRS,b} and N_{b} are determined by Table 6.4.14.3-1 of TS 38.211 with b=B_{SRS} and the configured value of C_{SRS}.

TABLE 3

| | ${k}_{offset}^{0} , {k}_{offset}^{1} , … , {k}_{offset}^{{N}_{symb}^{SRS} - 1}$ | | | | |
|---|---|---|---|---|---|
| | N_{symb}^{SRS} = | N_{symb}^{SRS} = | N_{symb}^{SRS} = | N_{symb}^{SRS} = | N_{symb}^{SRS} = |
| K_{TC} | 1 | 2 | 4 | 8 | 12 |
| 2 | 0 | 0, 1 | 0, 1, 0, 1 | — | — |
| 4 | — | 0, 2 | 0, 2, 1, 3 | 0, 2, 1, 3, | 0, 2, 1, 3, |
| | | | | 0, 2, 1, 3 | 0, 2, 1, 3, |
| | | | | | 0, 2, 1, 3 |
| 8 | — | — | 0, 4, 2, 6 | 0, 4, 2, 6, | 0, 4, 2, 6, |
| | | | | 1, 5, 3, 7 | 1, 5, 3, 7, |
| | | | | | 0, 4, 2, 6 |

NR supports positioning on the Uu interface. In the DL, positioning reference signal (PRS) can be transmitted by a gNB to a UE to enable the UE to perform positioning measurements. In the UL, a UE can transmit positioning sounding reference signal (SRS) to enable a gNB to perform positioning measurements. UE measurements for positioning include; DL PRS reference signal received power (DL PRS RSRP), DL PRS reference signal received path power (DL PRS RSRPP), DL reference signal time difference (DL RSTD), UE Rx−Tx time difference, NR enhanced cell ID (E-CID) DL SSB radio resource management (RRM) measurement, and NR E-CID DL CSI-RS RRM measurement. NG-RAN measurements for positioning include; UL relative time of arrival (UL-RTOA), UL angle of arrival (UL AoA), UL SRS reference signal received power (UL SRS-RSRP), UL SRS reference signal received path power (UL SRS-RSRPP) and gNB Rx−Tx time difference. NR introduced several radio access technology (RAT) dependent positioning methods; time difference of arrival based methods such DL time difference of arrival (DL-TDOA) and UL time difference of arrival (UL TDOA), angle based methods such as UL angle of arrival (UL AoA) and DL angle of departure (DL AoD), multi-round trip time (RTT) based methods and E-CID based methods.

Positioning schemes may be UE-based, i.e., the UE determines the location or UE-assisted (e.g., location management function (LMF) based), i.e., UE provides measurements for a network entity (e.g., LMF) to determine the location, or NG-RAN node assisted (i.e., NG-RAN node such as gNB provides measurement to LMF). LTE positioning protocol (LPP) [as illustrated in TS 37.355], first introduced for LTE and then extended to NR may be used for communication between the UE and LMF. NR positioning protocol annex (NRPPa) [as illustrated in TS 38.455] may be used for communication between the gNB and the LMF.

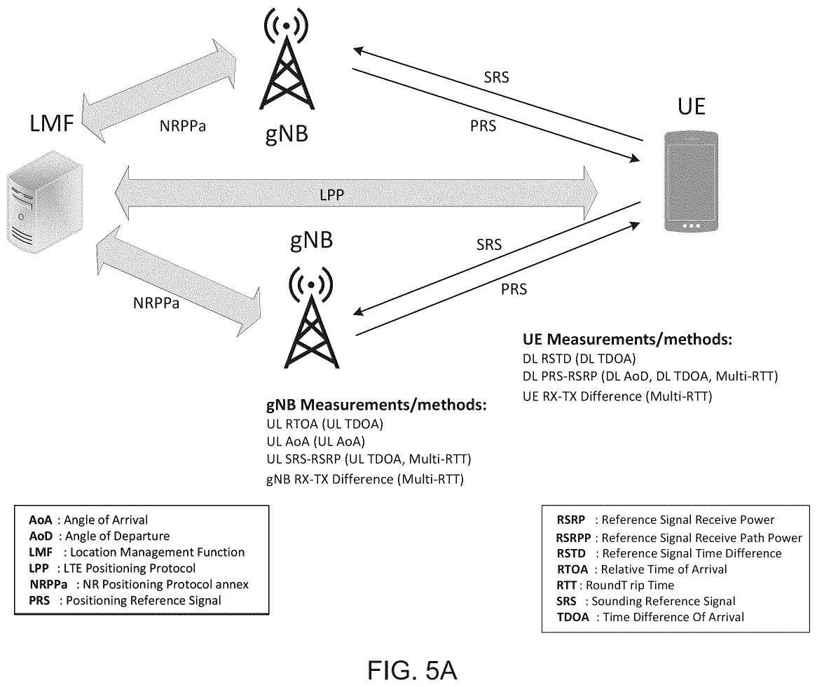

FIG. 5A illustrates an example of overall positioning architecture along with positioning measurements and methods according to embodiments of the present disclosure. The embodiment of the positioning architecture illustrated in FIG. 5A is for illustration only. Other embodiments of positioning architecture could be used without departing from the scope of this disclosure.

Although FIG. 5A illustrates one example of DL PRS resources and positioning SRS resources, various changes may be made to FIG. 5A. For example, the measurements may change, the methods may change, etc.

FIG. 5B illustrates an example location management function (LMF) according to embodiments of the present disclosure. The embodiment of the LMF illustrated in FIG. 5B is for illustration only. Other embodiments of an LMF could be used without departing from the scope of this disclosure.

In the example of FIG. 5B, the LMF includes a controller/processor, a memory, and a backhaul or network interface. The controller/processor may include one or more processors or other processing devices that control the overall operation of the LMF. For example, the controller/processor may support functions related to positioning and location services. Any of a wide variety of other functions may be supported in the LMF by the controller/processor. In some embodiments, the controller/processor may include at least one microprocessor or microcontroller.

The controller/processor may also execute programs and other processes resident in the memory, such as a basic OS. In some embodiments, the controller/processor may support communications between entities, such as gNB and UE and may support protocols such as LPP and NRPPa. The controller/processor may move data into or out of the memory as required by an executing process.

The controller/processor may also be coupled to the backhaul or network interface. The backhaul or network interface may allow the LMF to communicate with other devices or systems over a backhaul connection or over a network. The interface may support communications over any suitable wired or wireless connection(s). For example, when the LMF is implemented as part of a cellular communication system or wired or wireless local area network (such as one supporting 5G, LTE, or LTE-A), the interface may allow the LMF to communicate with gNBs or eNBs or other network elements over a wired or wireless backhaul connection. The interface may include any suitable structure supporting communications over a wired or wireless connection, such as an Ethernet or RF transceiver.

The memory may be coupled to the controller/processor. Part of the memory may include a RAM, and another part of the memory may include a Flash memory or other ROM. In certain embodiments, a plurality of instructions, such as a location and positioning algorithm may be stored in memory. The plurality of instructions may be configured to cause the controller/processor to perform the location management process and to perform positioning or location services algorithms.

Although FIG. 5B illustrates one example of an LMF, various changes may be made to FIG. 5B. For example, the LMF could include any number of each component shown in FIG. 5B. Also, various components in FIG. 5B could be combined, further subdivided, or omitted and additional components could be added according to particular needs.

The positioning solutions proposed for release 16 target the following commercial requirements for commercial applications:

| Requirement characteristic | Requirement target |
|---|---|
| Horizontal Positioning Error | Indoor: 3 m for 80% of the UEs |
| | Outdoor: 10 m for 80% of the UEs |
| Vertical Positioning Error | Indoor: 3 m for 80% of the UEs |
| | Outdoor: 3 m for 80% of the UEs |
| End to end latency | Less than 1 second |

To meet these requirements, radio access technology (RAT)-dependent, RAT independent, and a combination of RAT-dependent and RAT independent positioning schemes have been considered. For the RAT-dependent positioning schemes, timing based positioning schemes as well as angle-based positioning schemes have been considered. For timing based positioning schemes, NR supports DL Time Difference of Arrival (DL-TDOA), using positioning reference signals (PRS) for time of arrival measurements. NR also supports UL Time Difference of Arrival (UL-TDOA), using sounding reference signals (SRS) for time of arrival measurements.

NR also supports round-trip time (RTT) with one or more neighboring gNBs or transmission/reception points (TRPs). For angle based positioning schemes, NR exploits the beam-based air interface, supporting downlink angle of departure (DL-AoD), as well as uplink angle of arrival (UL-AoA). Furthermore, NR supports enhanced cell-ID (E-CID) based positioning schemes. RAT independent positioning schemes can be based on global navigation satellite systems (GNSS), WLAN (e.g., WiFi), Bluetooth, Terrestrial Beacon System (TBS), as well as sensors within the UE such as accelerometers, gyroscopes, magnetometers, etc. Some of the UE sensors are also known as Inertial Measurement Unit (IMU).

As NR expands into new verticals, there is a need to provide improved and enhanced location capabilities to meet various regulatory and commercial positioning requirements. 3GPP SA1 considered the service requirements for high accuracy positioning in TS 22.261 and identified seven service levels for positioning, with varying levels of accuracy (horizontal accuracy and vertical accuracy), positioning availability, latency requirement, as well as positioning type (absolute or relative).

One of the positioning service levels is relative positioning (see table 7.3.2.2-1 of TS 22.261), with a horizontal and vertical accuracy of 0.2 m, availability of 99%, latency of 1 sec, and targeting indoor and outdoor environments with speed up to 30 km/hr and distance between UEs or a UE and a 5G positioning node of 10 m.

Rel-17 further enhanced the accuracy, latency, reliability and efficiency of positioning schemes for commercial and IIoT applications. Targeting to achieve sub-meter accuracy with a target latency less than 100 ms for commercial applications, and accuracy better than 20 cm with a target latency in the order of 10 ms for IIoT applications.

In Rel-17, RAN undertook a study item for in-coverage, partial coverage and out-of-coverage NR positioning use cases [RP-201518]. The study focused on identifying positioning use cases and requirements for V2X and public safety as well as identifying potential deployment and operation scenarios. The outcome of the study item is included in TR 38.845. V2X positioning requirements depend on the service the UE operates, and are applicable to absolute and relative positioning. Use cases include indoor, outdoor and tunnel areas, within network coverage or out of network coverage; as well as positioning with GNSS-based positioning available, or not available, or not accurate enough; and positioning with UE speeds up to 250 km/h. There are three sets of requirements for V2X use cases; the first with horizontal accuracy in the 10 to 50 m range, the second with horizontal accuracy in the 1 to 3 m range, and the third with horizontal accuracy in the 0.1 to 0.5 m range. The 5G system can also support determining the velocity of a UE with a speed accuracy better that 0.5 m/s and a 3-Dimension direction accuracy better than 5 degrees. Public safety positioning is to be supported indoor and outdoor, with in network coverage or out of network coverage; as well as positioning with GNSS-based positioning available, or not available, or not accurate enough. Public safety positioning use case target a 1-meter horizontal accuracy and a vertical accuracy of 2 m (absolute) or 0.3 m (relative).

In terms of deployment and operation scenarios, TR 38.845 has identified the following:
For network coverage: In-network coverage, partial network coverage as well as out-of-network coverage. In addition to scenarios with no GNSS and no network coverage.
Radio link: Uu interface (UL/DL interface) based solutions, PC5 interface (SL interface) based solutions and their combinations (hybrid solutions). As well as RAT-independent solutions such as GNSS and sensors.
Positioning calculation entity: Network-based positioning when the positioning estimation is performed by the network and UE-based positioning when the positioning estimation is performed by the UE.
UE Type: For V2X UEs, this may be a UE installed in a vehicle, a roadside unit (RSU), or a vulnerable road user (VRU). Some UEs may have distributed antennas, e.g., multiple antenna patterns that can be leveraged for positioning. UEs may have different power supply limitations, for example VRUs or handheld UEs may have limited energy supply compared to other UEs.
Spectrum: This may include licensed spectrum and unlicensed spectrum for the Uu interface and the PC5 interface; as well as ITS-dedicated spectrum for the PC5 interface.

Carrier phase method may be used for positioning to provide a more accurate positioning estimate. Carrier phase (CP) positioning relies on measuring a carrier phase at the RF frequency of a signal transmitted from one device (e.g., device A) and received by another device (e.g., device B). The carrier phase measured at device B may be a function of the propagation time, and consequently the propagation distance, from transmitter of device A to the receiver of device B. Device A and device B may be a gNB and a UE respectively or vice versa. In case of PC5 (sidelink) air interface device A may be a first UE and device B can be a second UE.

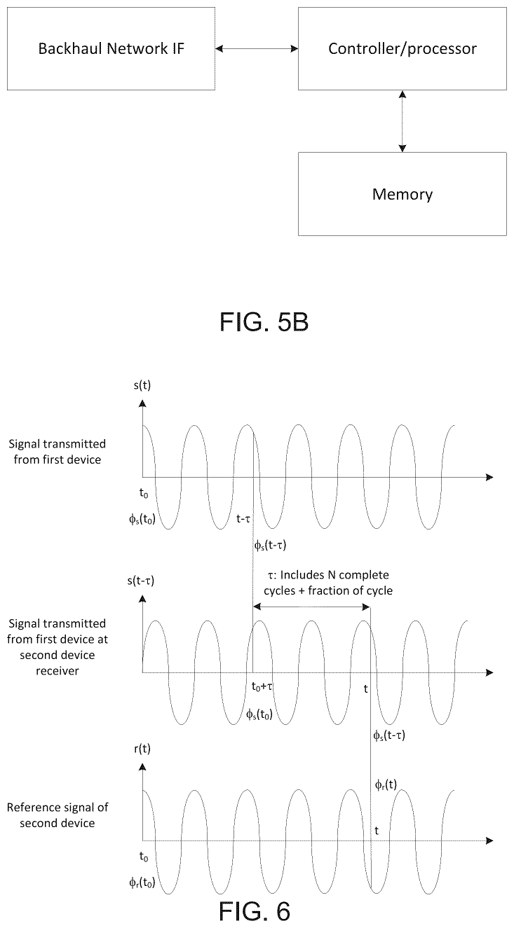

FIG. 6 illustrates an example carrier phase method according to embodiments of the present disclosure. The embodiment of the carrier phase method in FIG. 6 is for illustration only. Other embodiments of a carrier phase method could be used without departing from the scope of this disclosure.

As illustrated in FIG. 6, signal s(t−τ) is transmitted from a first device at time t−τ and arrives at a second device at time t. A reference signal at the second device is r(t). Consider a signal s(t)=cos ϕₛ(t), where ϕₛ(t) is the phase of the signal at time t. The phase at time t₀ is given by ϕₛ(t₀). ϕₛ(t₀) and ϕₛ(t) are related as follows:

ϕₛ(t)=ϕₛ(t₀)+2π∫ₜ_{₀}^{t}f(s)ds (1)

Where, f(s) is the frequency of signal s(t) at time s. If the frequency is constant over time and equals fₛ, equation (1) becomes

ϕₛ(t)=ϕₛ(t₀)+2πfₛ(t−t₀) (2)

Let s(t) be the signal transmitted from a transmitter of a first device. The signal is received by a second device at time t. The propagation time from the first device to the second device is τ. Therefore, to be received at time t, the signal is transmitted by the first device at time t−τ. Therefore, s(t−τ)=cos ϕₛ(t−τ) is the signal transmitted by the first device to arrive at the second device at time t.

The second device generates a reference signal r(t)=cos ϕᵣ(t). Where, assuming that the frequency of the reference signal is constant over time and equals fᵣ:

ϕᵣ(t)=ϕᵣ(t₀)+2πfᵣ(t−t₀) (3)

The receiver measures the phase difference, Δϕ(t), between the reference signal ϕᵣ(t) and the signal from the transmitter s(t−τ):

Δϕ(t)=ϕᵣ(t)−ϕₛ(t−τ)−2πN (4)

Where, N is an integer, N=0, ±1, ±2, . . . , to account for the fact that at the receiver of the second device the phase of the transmitted signal from the first device can only be measured as a fraction of a cycle and there is an integer number of cycles between the transmitted signal from the first device and the reference of the second device as illustrated in FIG. 5. N is known as the integer ambiguity. Above equation gives the phase of the signal received by the second device from the first device. Note that, ϕᵣ(t) is the reference of the second device when measuring the phase of the signal of the first device. ϕᵣ(t) may not be physically generated in the second device, it can just be a reference for measuring the phase.

In this example, assume perfect synchronization between the first device and the second device, i.e.:
Frequency synchronization, i.e., f_{sc}=fᵣ=f
Timing synchronization, i.e., same time reference for both first device and second device. Therefore, from equations (2), (3) and (4) you arrive at:

Δϕ(t)=ϕᵣ(t₀)−ϕₛ(t₀)−2πN+2πfτ (5)

Assuming that the first device and the second device are also phase synchronized, i.e., ϕᵣ(t₀)=ϕₛ(t₀), you arrive at:

Δϕ(t)=2πfτ−2πN (6)

By taking the derivative of equation (5) or equation (6) with respect to frequency we get the following equations which eliminate the integer ambiguity and the initial phases

$$\frac{d}{df} ( Δ ϕ ( t ) ) = 2 πτ \qquad ( 5 a )$$

$$\frac{d}{df} ( Δ ϕ ( t ) ) = 2 π τ \qquad ( 6 a )$$

The propagation delay, τ, can be expressed as a sum of an integer number of cycles at the carrier frequency, N T_{c}, where T_{c} is the carrier frequency period, and a fraction part of a cycle T_{f}, where T_{f}<T_{c}, i.e., τ=N T_{c}+T_{f}. Let r(t−τ, t) be the distance between the first device at time t−τ and the second device at time t. Therefore,

$$\frac{Δ ϕ ( t )}{2 π} = r ( t - τ , t ) \frac{f}{c} - N = \frac{r ( t - τ , t )}{λ} - N \qquad ( 7 )$$

Where, c is the speed of light and λ is the wavelength corresponding to frequency f. Taking the derivative with respect to frequency we get, also eliminating the integer ambiguity:

$$\frac{d}{df} ( \frac{Δ ϕ ( t )}{2 π} ) = \frac{r ( t - τ , t )}{c} \qquad ( 7 a )$$

The transmitter and receiver clocks are generally not synchronized or are loosely or partially synchronized, and each keeps time independently. Let, t be a time given by a common (global) reference time. The time measured by first device is given by tₛ(t). This time can be given by: tₛ(t)=t+δtₛ(t), where δtₛ(t) is a clock bias (i.e., an offset) between the common (global) reference time and the time of the first device, this clock bias (i.e., offset), in general, can change overtime for example due to instability of the clock. The time measured by the second device is given by tᵣ(t). This time can be given by: tᵣ(t)=t+δtᵣ(t), where δtᵣ(t) is a clock bias (i.e., an offset) between the common (global) reference time and the time of the second device, this clock bias (i.e., offset), in general, can change overtime for example due to instability of the clock. In one example, difference between the common (global) reference time and the time according to the first device is constant (doesn't depend on time). Therefore, tₛ(t)=t+δtₛ. In one example, difference between the common (global) reference time and the time according to the second device is constant (doesn't depend on time). Therefore, tᵣ(t)=t+δtᵣ.

If a signal is transmitted from the first device at time t₁, where t₁ is in the common (global) time reference, according to the time reference of the first device, this is at time tₛ(t₁)=t₁+t(t₁). The signal arrives at the second device at time t₂, where t₂ is in the common (global) time reference, according to the time reference of the second device, this is at time tᵣ(t₂)=t₂+δtᵣ(t₂). The transient time from the first device to the second device is τ=t₂−t₁. The apparent transient time by considering the time according to the first device and the second device and is given by: tᵣ(t₂)−tₛ(t₁)=τ+δtᵣ(t₂)−δtₛ(t₁).

A signal is transmitted from the first device at time t₁ according to the common (global) reference time, which is time tₛ(t₁)=t₁+δtₛ(t₁) in the time reference of the first device. Therefore, using equation (2), with f_{sc}=f and t is the transmit time according to the time reference of the first device, i.e., t=tₛ(t₁):

ϕₛ(tₛ(t₁))=ϕₛ(t₀)+2πf(t₁+δtₛ(t₁)−t₀) (8)

The signal arrives at the second device at time t₂ according to the common (global) reference time, which is time tᵣ(t₂)=t₂+δtᵣ(t₂) in the time reference of the second device. Therefore, using equation (3), with fᵣ=f and t is the receive time according to the time reference of the second device, i.e., t=tᵣ (t₂):

ϕᵣ(tᵣ(t₂))=ϕᵣ(t₀)+2πf(t₂+δtᵣ(t₂)−t₀) (9)

Therefore, the equation for phase difference (equation (6))—Δϕ(t)=ϕᵣ(tᵣ(t₂))−ϕₛ(tₛ(t₁)), taking into account the clock biases of the first (transmit) device and second (receive) device, with τ=t₂−t₁, becomes:

Δϕ(t₁,t₂)=2πfτ+2πf(δtᵣ(t₂)−δtₛ(t₁))−2πN (10)

By taking the derivative of equation (10) with respect to frequency we get the following equation which eliminates the integer ambiguity

$$\frac{d}{df} ( Δ ϕ ( {t}_{1} , {t}_{2} ) ) = 2 π τ + 2 π ( δ {t}_{r} ( {t}_{2} ) - δ {t}_{S} ( {t}_{1} ) ) \qquad ( 10 a )$$

Hence, equation (7) and (7a), with clock biases becomes:

$$\frac{Δ ϕ ( t )}{2 π} = \frac{r ( t - τ , t )}{λ} + f ( δ {t}_{r} ( {t}_{2} ) - δ {t}_{S} ( {t}_{1} ) ) - N \qquad ( 11 )$$

$$\frac{d}{df} ( \frac{Δ ϕ ( t )}{2 π} ) = \frac{r ( t - τ , t )}{c} + ( δ {t}_{r} ( {t}_{2} ) - δ {t}_{S} ( {t}_{1} ) ) \qquad ( 11 a )$$

To derive equation (7) and by extension equation (11), in this example assume that ϕᵣ(t₀)=ϕₛ(t₀). If ϕᵣ(t₀)≠ϕₛ(t₀), the phase difference at a reference time t₀, becomes an additional component in the phase difference measurement, hence equation (11) becomes:

$$\frac{Δ ϕ ( t )}{2 π} = \frac{r ( t - τ , t )}{λ} + f ( δ {t}_{r} ( {t}_{2} ) - δ {t}_{S} ( {t}_{1} ) ) + ( {ϕ}_{r} ( {t}_{0} ) - {ϕ}_{S} ( {t}_{0} ) ) - N \qquad ( 12 )$$

If we take the derivative with respect to frequency, the phase difference cancels out

$$\frac{d}{df} ( \frac{Δ ϕ ( t )}{2 π} ) = \frac{r ( t - τ , t )}{c} + ( δ {t}_{r} ( {t}_{2} ) - δ {t}_{S} ( {t}_{1} ) ) \qquad ( 12 a ) )$$

Although FIG. 6 illustrates one example of carrier phase method, various changes may be made to FIG. 6. For example, the phase relationships may change, the cycle times may change, etc.

Two issues are apparent in equation (12) when measuring the carrier phase. The first is the clock biases of the devices involved in the transmission and reception of the signals used to measure the carrier phase. The second is the integer ambiguity represented by N. Methods to solve the first issue include:
Round-trip carrier phase measurement.
Single difference and double difference carrier phase measurement.

To solve the integer ambiguity issue, the following methods can be considered:
Getting an estimate of the number of full cycles using legacy positioning techniques which could be less accurate than the carrier phase method. To assist in getting a reliable estimate of the number of cycles, a virtual frequency can be considered which is smaller than the carrier frequency is used for the phase measurement.
Slope of the carrier phase with respect to frequency which eliminates N.
Using the phase of a virtual carrier with frequency smaller than the sub-carrier or carrier frequencies used for the RF signal. Using legacy positioning techniques which could be less accurate than the carrier phase method provides an estimate of the number of full cycles for the carrier phase measurement. To assist in getting a reliable estimate of the number of cycles, a virtual frequency can be considered which is smaller than the carrier frequency is used for the phase measurement.

In this disclosure we consider the slope of the carrier phase measurement to eliminate the integer ambiguity.

According to equation (12), there are five unknowns:
The integers ambiguity, N.
The clock bias of the first (transmitter) device, δtₛ(t).
The clock bias of the second (receiver) device, δtᵣ(t).
The carrier phase of the first (transmitter) device at a reference time t₀, i.e., ϕₛ(t₀).
The carrier phase of the second (receiver) device at a reference time t₀, i.e., ϕᵣ(t₀)

According to equation (12a), there are two unknowns:
The clock bias of the first (transmitter) device, δtₛ(t).
The clock bias of the second (receiver) device, δtᵣ(t).

The following unknowns have been eliminated in equation (12a), by taking the derivative with respect to frequency:
The integers ambiguity, N.
The carrier phase of the first (transmitter) device at a reference time t₀, i.e., ϕₛ(t₀).
The carrier phase of the second (receiver) device at a reference time t₀, i.e., ϕᵣ(t₀).

The accuracy of the carrier phase measurement may be in the range of 0.01 to 0.05 cycles. For a carrier frequency of 3 GHz, the wavelength is 10 cm, this corresponds to 1 mm to 5 mm, which is well within the cm-level accuracy.

In this disclosure, we consider the use of the carrier phase method to estimate the position of a UE:
Method and apparatus for measuring the round-trip carrier phase (the sum of the DL carrier phase and the UL carrier phase). This eliminates clock biases at the gNB and UE and unknown phase at the gNB and UE
Measuring the frequency derivative round trip carrier phase to eliminate integer ambiguity.
Configurations and reporting of carrier phase measurements from the UE and the gNB.
Measurement of the derivative of carrier phase for DL positioning reference signal and UL positioning reference signal (e.g., positioning sounding reference signal) at the UE and the gNB.

In this disclosure, we consider the use of the virtual frequency carrier phase method to estimate the position of a UE, where the virtual frequency is smaller than the carrier (sub-carrier) frequencies at which the carrier phase is measured:
Method and apparatus for determining the carrier phase of virtual frequency from the measured carrier phases of multiple frequencies, where the virtual frequency is smaller than the carrier frequencies used for phase measurement to alleviate the integer ambiguity issue.
Application to double difference carrier phase and round-trip carrier phase.
Corresponding configurations and reporting from the UE and the gNB.
Measurement of the carrier phase at the gNB and the UE.

In one example, the DL positioning reference signal (e.g., DL PRS) in this disclosure is a reference signal designed for the carrier-phase method.

In one example, the DL positioning reference signal (e.g., DL PRS) in this disclosure is a reference signal introduced in the Rel-16 and Rel-17 3GPP specifications for positioning.

In one example, the UL positioning reference signal (e.g., Positioning Sounding Reference Signal—Pos-SRS) in this disclosure is a reference signal designed for the carrier-phase method.

In one example, the UL positioning reference signal (e.g., Positioning Sounding Reference Signal—Pos-SRS) in this disclosure is a reference signal introduced in the Rel-16 and Rel-17 3GPP specifications for positioning.

In one example, if there is a change in time advance (TA) between two instances of reference signals used for carrier phase measurements the phase continuity might not be maintained across these carrier phase measurements.

In another example, if there is a change in time advance (TA) between two instances of reference signals used for carrier phase measurements, the impact of the TA on reference time of the UE or gNB is taken into account.

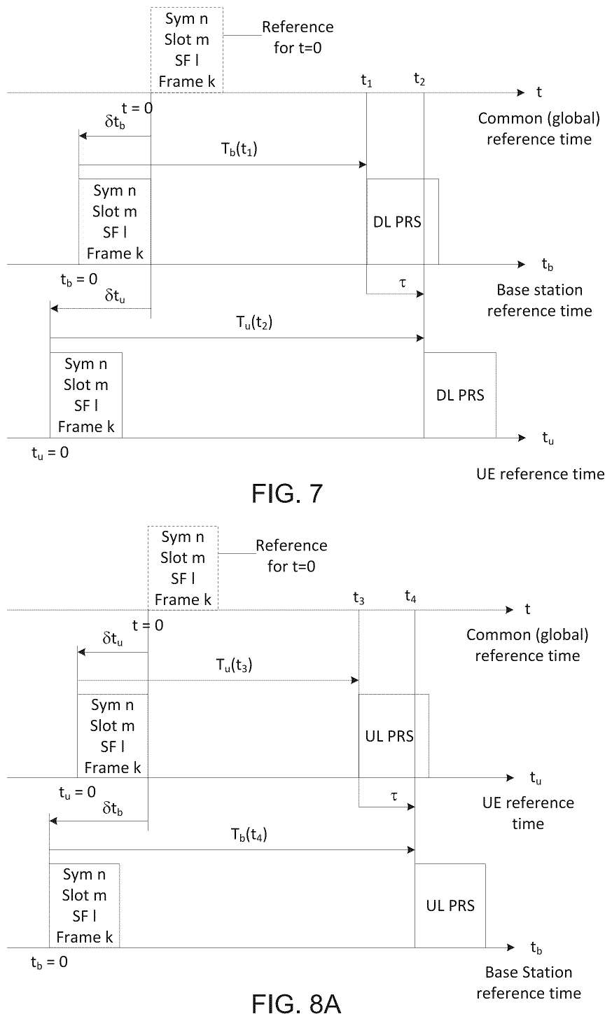

FIG. 7 illustrates an example round trip carrier-phase method according to embodiments of the present disclosure. The embodiment of the round trip carrier-phase method in FIG. 7 is for illustration only. Other embodiments of a round trip carrier phase method could be used without departing from the scope of this disclosure.

FIG. 7 illustrates an example of a gNB transmitting a DL positioning reference signal to a UE with different clock biases at the gNB and the UE.

In one example, the gNB transmits a DL positioning reference signal. Let t₁ be the start of a DL positioning reference signal. t₁ is in accordance with a common (global) reference time. The time according to base station reference time is t_{b}(t₁)=t₁+δt_{b}(t₁), where δt_{b}(t₁) is a clock bias (i.e., offset) of the base station clock. In one example, the clock bias δt_{b}(t₁) may be a function of time, i.e., it changes with time. In another example, the clock bias may be fixed, i.e., δt_{b}(t₁)=δt_{b}.

In one example, t_{b}(t₁) may be the time of the start of the DL positioning reference signal from the start of a DL or UL symbol, for example (1) symbol n in slot m in frame k, or (2) symbol n in slot m in any frame, or (3) symbol n in any slot, or (4) symbol n in slot m in subframe l in frame k, or (5) symbol n in slot m in subframe l in any frame, or (6) symbol n in slot m in any subframe, or (7) symbol n in subframe l in frame k, or (8) symbol n in subframe l in any frame, or (9) symbol n in any subframe. For example, symbol n may be the symbol of the DL positioning reference signal, e.g., t_{b}(t₁)=0.

In one example, t_{b}(t₁) may be the time of the start of the DL positioning reference signal from the start of a DL or UL slot, for example (1) slot m in frame k, or (2) slot m in any frame, or (3) slot m in subframe l in frame k, or (4) slot m in subframe l in any frame. For example, slot m may be the slot of the DL positioning reference signal, e.g., t_{b}(t₁) may be the time between the start of the slot of the DL positioning reference symbol at the gNB and the start of the transmitted DL positioning reference symbol.

In one example, t_{b}(t₁) may be the time of the start of the DL positioning reference signal from the start of a DL or UL subframe, for example (1) subframe l in frame k, or (2) subframe l in any frame. For example, subframe l may be the subframe of the DL positioning reference signal, e.g., t_{b}(t₁) is the time between the start of the subframe of the DL positioning reference symbol at the gNB and the start of the transmitted DL positioning reference symbol.

In one example, t_{b}(t₁) may be the time of the start of the DL positioning reference signal from the start of a DL or UL frame, for example frame k. For example, frame k may be the frame of the DL positioning reference signal, e.g., t_{b}(t₁) may be the time between the start of the frame of the DL positioning reference symbol at the gNB and the start of the transmitted DL positioning reference symbol.

In one example, t_{b}(t₁) may be the time of the start of the DL positioning reference signal from the DL or UL SFN roll-over (e.g., SFN=0).

In one example, t_{b}(t₁) is time of the start of the DL positioning reference signal from a reference time in the gNB.

In one example, the common (global) reference time may be the time of the gNB. i.e., t_{b}(t₁)=t₁ and δt_{b}(t₁)=0.

In one example, phase of the carrier at the reference time (e.g., t_{b}=0) may be ϕ_{b01}. Phase continuity may be assumed between time t_{b}=0 and t_{b}(t₁) both times are according to the base station reference time. Alternatively, the corresponding times according to the common (global) reference time may be used. The phase of the carrier at time t_{b}(t₁) may be given by:

ϕ_{b}(t_{b}(t₁))=θ_{b01}+2πft_{b}(t₁)=ϕ_{b01}+2πf(t₁+δt_{b}(t₁)) (13)

In one example, the phase of the carrier may be zero at the start of or after CP of each symbol transmitted by the gNB.

In one example, the phase of the carrier may be zero at the start of or after CP of a first PRS symbol (or first symbol) in a slot transmitted by the gNB, phase continuity is assumed for the remaining PRS symbols of the slot.

In one example, the phase of the carrier may be zero at the start of or after CP of a first PRS symbol (or first symbol) in a subframe transmitted by the gNB, phase continuity is assumed for the remaining PRS symbols of the subframe.

In one example, the phase of the carrier may be zero at the start of or after CP of a first PRS symbol (or first symbol) in a frame transmitted by the gNB, phase continuity is assumed for the remaining PRS symbols of the frame.

In one example, the phase of the carrier may be zero at the start of or after CP of a first PRS symbol (or first symbol) in a frame with SFN=0 transmitted by the gNB, phase continuity is assumed for the remaining PRS symbols until the next SFN=0.

In one example, the DL positioning reference signal transmitted by the gNB may arrive at a UE at time t₂=t₁+τ(t₁, t₂), where τ(t₁, t₂) is the propagation delay from the gNB at time t₁ to the UE at time t₂. If the distance between the gNB and UE doesn't change with time, e.g., the UE and the gNB are stationary, τ is independent of t₁ and t₂, i.e., τ=τ(t₁, t₂). t₂ is the start of the DL positioning reference signal received at the UE. t₂ is in accordance with a common (global) reference time. The time according to UE reference time may be tᵤ(t₂)=t₂+δtᵤ(t₂), where δtᵤ(t₂) is a clock bias (i.e., offset) of the UE clock. In one example, the clock bias δtᵤ(t₂) may be a function of time, i.e., it changes with time. In another example, the clock bias is fixed, i.e., δtᵤ(t₂)=δtᵤ.

In one example, tᵤ(t₂) may be time of the start of the received DL positioning reference signal from the start of a DL or UL symbol, for example (1) symbol n in slot m in frame k, or (2) symbol n in slot m in any frame, or (3) symbol n in any slot, or (4) symbol n in slot m in subframe l in frame k, or (5) symbol n in slot m in subframe l in any frame, or (6) symbol n in slot m in any subframe, or (7) symbol n in subframe l in frame k, or (8) symbol n in subframe l in any frame, or (9) symbol n in any subframe. For example, symbol n may be the symbol of the DL positioning reference signal, e.g., t₁(t₂) may be the time between the start of the DL or UL positioning reference symbol at the UE and the start of the received DL positioning reference symbol.

In one example, tᵤ(t₂) may be the time of the start of the received DL positioning reference signal from the start of a DL or UL slot, for example (1) slot m in frame k, or (2) slot m in any frame, or (3) slot m in subframe l in frame k, or (4) slot m in subframe l in any frame. For example, slot m may be the slot of the DL positioning reference signal, e.g., tᵤ(t₂) may be the time between the start of the slot of the DL or UL positioning reference symbol at the UE and the start of the received DL positioning reference symbol.

In one example, tᵤ(t₂) may be the time of the start of the received DL positioning reference signal from the start of a DL or UL subframe, for example (1) subframe l in frame k, or (2) subframe l in any frame. For example, subframe l may be the subframe of the DL positioning reference signal, e.g., t₁(t₂) may be the time between the start of the subframe of the DL or UL positioning reference symbol at the UE and the start of the received DL positioning reference symbol.

In one example, tᵤ(t₂) may be the time of the start of the received DL positioning reference signal from the start of a DL or UL frame, for example frame k. For example, frame k may be the frame of the DL positioning reference signal, e.g., tᵤ(t₂) may be the time between the start of the frame of the DL or UL positioning reference symbol at the UE and the start of the received DL positioning reference symbol.

In one example, tᵤ(t₂) may be the time of the start of the received DL positioning reference signal from the DL or UL SFN roll-over (e.g., SFN=0).

In one example, tᵤ(t₂) may be the time of the start of the received DL positioning reference signal from a reference time in the UE.

In one example, the common (global) reference time may be the time of the UE. i.e., tᵤ(t₂)=t₂ and δtᵤ(t₂)=0.

In one example, n, m, l and/or k for the reference time of the gNB and n, m, l and/or k for the reference time of the UE may be the same. This is the example shown in FIG. 7.

In one example, n, m, l and/or k for the reference time of the gNB and n, m, l and/or k for the reference time of the UE may be different.

In one example, phase of the UE's reference signal (or reference phase) at the reference time (e.g., tᵤ=0) is ϕᵤ₀₁. Phase continuity may be assumed between time tᵤ=0 and tᵤ(t₂) both times are according to the UE reference time. For example, there is no slip in the phase locked loop providing the reference signal (or reference phase) of the UE. Alternatively, the corresponding times according to the common (global) reference time may be used. The phase of the UE's reference signal (or reference phase) at time tᵤ(t₂) may be given by:

ϕᵤ(tᵤ(t₂))=ϕᵤ₀₁+2πftᵤ(t₂)=ϕᵤ₀₁+2πf(t₂+δtᵤ(t₂)) (14)

Where, t₂ is the time of arrival of the DL positioning reference signal at the UE. Where, t₂=t₁+τ(t₁, t₂). If the UE and the gNB are stationary (e.g., fixed positions) t₂=t₁+τ, i.e., τ doesn't depend on t₁ and t₂.

Therefore, the phase difference between the UE's reference signal (or reference phase) and the carrier of the DL positioning reference signal received at the UE may be given by:

$$\frac{Δ ϕ ( {t}_{1} , {t}_{2} )}{2 π} = \frac{{ϕ}_{u} ( {t}_{u} ( {t}_{2} ) ) - {ϕ}_{b} ( {t}_{b} ( {t}_{1} ) )}{2 π} - {N}_{1} \qquad ( 15 )$$

$$\frac{Δ ϕ ( {t}_{1} , {t}_{2} )}{2 π} = \frac{{ϕ}_{u 01} - {ϕ}_{b 01}}{2 π} + f ( τ ( {t}_{1} , {t}_{2} ) + δ {t}_{u} ( {t}_{2} ) - δ {t}_{b} ( {t}_{1} ) ) - {N}_{1} \qquad ( 16 )$$

$$\frac{Δ ϕ ( {t}_{1} , {t}_{2} )}{2 π} = \frac{{ϕ}_{u 01} - {ϕ}_{b 01}}{2 π} + \frac{r ( {t}_{1} , {t}_{2} )}{λ} + f ( δ {t}_{u} ( {t}_{2} ) - δ {t}_{b} ( {t}_{1} ) ) - {N}_{1} \qquad ( 17 )$$

Taking the derivative of equation (16) and (17) with respect to frequency we get:

$$\frac{d}{d f} ( \frac{Δ ϕ ( {t}_{1} , {t}_{2} )}{2 π} ) = ( τ ( {t}_{1} , {t}_{2} ) + δ {t}_{u} ( {t}_{2} ) - δ {t}_{b} ( {t}_{1} ) ) \qquad ( 16 a )$$

$$\frac{d}{d f} ( \frac{Δ ϕ ( {t}_{1} , {t}_{2} )}{2 π} ) = \frac{r ( {t}_{1} , {t}_{2} )}{c} + ( δ {t}_{u} ( {t}_{2} ) - δ {t}_{b} ( {t}_{1} ) ) \qquad ( 16 b )$$

Equation (16a) and (17a) have eliminated the integer ambiguity and the initial phases.

In one example, the UE may measure the carrier phase or slope of carrier phase or difference between carrier phase of two sub-carriers or carriers of the DL positioning reference signal transmitted by the gNB. For example, the carrier phase measured by the UE may be for ϕ_{b}(t_{b}(t₁)). This is the carrier phase of the signal transmitted from the gNB at time t_{b}(t₁) and arriving at the UE at time tᵤ(t₂).

In one example, the UE may measure the carrier phase of the DL positioning reference signal transmitted by the gNB relative to UE's reference phase, i.e., the UE measures ϕᵤ(tᵤ(t₂))−ϕ_{b}(t_{b}(t₁)) or measures ϕ_{b}(t_{b}(t₁)−ϕᵤ(tᵤ(t₂)), wherein the signal is transmitted by the gNB at time t_{b}(t₁) and arrives at the UE at time tᵤ(t₂).

In one example, the UE may report the measured carrier phase, as aforementioned, to the network e.g., gNB or LMF for location determination.

In one example, the UE may use the measured carrier phase, as aforementioned, for location determination.

Although FIG. 7 illustrates one example of a round trip carrier-phase method, various changes may be made to FIG. 7. For example, the reference times may change, the frames may change, etc.

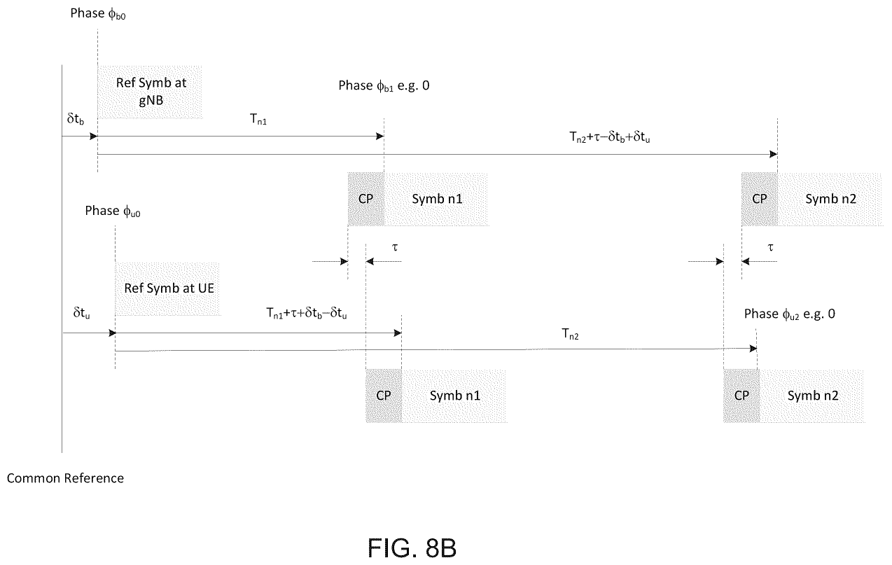

FIG. 8A illustrates an example round trip carrier-phase method according to embodiments of the present disclosure. The embodiment of the round trip carrier-phase method in FIG. 8A is for illustration only. Other embodiments of a round trip carrier phase method could be used without departing from the scope of this disclosure.

FIG. 8A illustrates an example of a UE transmitting an UL positioning reference signal (e.g., positioning sounding reference signal—positioning SRS) to a gNB with different clock biases at the gNB and the UE.

In one example, the UE may transmit an UL positioning reference signal (e.g., positioning sounding reference signal—positioning SRS). Let t₃ be the start of an UL positioning reference signal (e.g., positioning sounding reference signal—positioning SRS). t₃ is according to a common (global) reference time. The time according to UE's reference time may be tᵤ(t₃)=t₃+δtᵤ(t₃), where δtᵤ(t₃) is a clock bias (i.e., offset) of the UE clock. In one example, the clock bias δtᵤ(t₃) may be a function of time, i.e., it changes with time. In another example, the clock bias is fixed, i.e., δtᵤ(t₃)=δtᵤ. In one example, the same sub-carrier frequencies may be configured for the UL positioning reference signal (e.g., positioning sounding reference signal—positioning SRS) as configured for DL positioning reference signal. In a variant example, the sub-carrier frequencies configured for the UL positioning reference signal (e.g., positioning sounding reference signal—positioning SRS) may be different from the sub-carrier frequencies configured for DL positioning reference signal.

In one example, tᵤ(t₃) may be the time of the start of the UL positioning reference signal (e.g., positioning sounding reference signal—positioning SRS) from the start of an UL or DL symbol, for example (1) symbol n in slot m in frame k, or (2) symbol n in slot m in any frame, or (3) symbol n in any slot, or (4) symbol n in slot m in subframe l in frame k, or (5) symbol n in slot m in subframe l in any frame, or (6) symbol n in slot m in any subframe, or (7) symbol n in subframe l in frame k, or (8) symbol n in subframe l in any frame, or (9) symbol n in any subframe. For example, symbol n may be the symbol of the UL positioning reference signal (e.g., positioning sounding reference signal—positioning SRS), e.g., tᵤ(t₃)=0.

In one example, tᵤ(t₃) may be the time of the start of the UL positioning reference signal (e.g., positioning sounding reference signal—positioning SRS) from the start of an UL or DL slot, for example (1) slot m in frame k, or (2) slot m in any frame, or (3) slot m in subframe l in frame k, or (4) slot m in subframe l in any frame. For example, slot m may be the slot of the UL positioning reference signal (e.g., positioning sounding reference signal—positioning SRS), e.g., tᵤ(t₃) is the time between the start of the slot of the UL positioning reference symbol at the UE and the start of the transmitted UL positioning reference symbol.

In one example, tᵤ(t₃) may be the time of the start of the UL positioning reference signal (e.g., positioning sounding reference signal—positioning SRS) from the start of an UL or DL subframe, for example (1) subframe l in frame k, or (2) subframe l in any frame. For example, subframe l may be the subframe of the UL positioning reference signal (e.g., positioning sounding reference signal—positioning SRS), e.g., tᵤ(t₃) may be the time between the start of the subframe of the UL positioning reference symbol at the UE and the start of the transmitted UL positioning reference symbol.

In one example, tᵤ(t₃) may be the time of the start of the UL positioning reference signal (e.g., positioning sounding reference signal—positioning SRS) from the start of an UL or DL frame, for example frame k. For example, frame k may be the frame of the UL positioning reference signal (e.g., positioning sounding reference signal—positioning SRS), e.g., to(t₃) may be the time between the start of the frame of the UL positioning reference symbol at the UE and the start of the transmitted UL positioning reference symbol. In one example, t₁(t₃) is time of the start of the UL positioning reference signal (e.g., positioning sounding reference signal—positioning SRS) from the UL or DL SFN roll-over (e.g., SFN=0).

In one example, tᵤ(t₃) may be the time of the start of the UL positioning reference signal (e.g., positioning sounding reference signal—positioning SRS) from a reference time in the gNB.

In one example, the common (global) reference time may be the time of the UE. i.e., tᵤ(t₃)=t₃ and δtᵤ(t₃)=0.

In one example, phase of the carrier at the reference time (e.g., tᵤ=0) may be ϕᵤ₀₂. Phase continuity may be assumed between time tᵤ=0 and tᵤ(t₃) both times are according to the UE reference time. Alternatively, the corresponding times according to the common (global) reference time may be used. The phase of the carrier at time tᵤ(t₃) is given by:

ϕᵤ(tᵤ(t₃))=ϕᵤ₀₂+2πftᵤ(t₃)=ϕᵤ₀₂+2πf(t₃+δtᵤ(t₃)) (18)

In one example, the phase of the carrier may be zero at the start of or after CP of each symbol transmitted by the UE.

In one example, the phase of the carrier may be zero at the start of or after CP of a first PRS (or positioning SRS) symbol (or first symbol) in a slot transmitted by the UE, phase continuity is assumed for the remaining PRS (or positioning SRS) symbols of the slot.

In one example, the phase of the carrier may be zero at the start of or after CP of a first PRS (or positioning SRS) symbol (or first symbol) in a subframe transmitted by the UE, phase continuity is assumed for the remaining PRS (or positioning SRS) symbols of the subframe.

In one example, the phase of the carrier may be zero at the start of or after CP of a first PRS (or positioning SRS) symbol (or first symbol) in a frame transmitted by the UE, phase continuity is assumed for the remaining PRS (or positioning SRS) symbols of the frame.

In one example, the phase of the carrier may be zero at the start of or after CP of a first PRS (or positioning SRS) symbol (or first symbol) in a frame with SFN=0 transmitted by the UE, phase continuity is assumed for the remaining PRS (or positioning SRS) symbols until the next SFN=0.

In one example, the UL positioning reference signal (e.g., positioning sounding reference signal—positioning SRS) transmitted by the UE may arrive at a gNB at time t₄=t₃+τ(t₃, t₄), where τ(t₃, t₄) is the propagation delay from the UE at time t₃ to the gNB at time t₄. If the distance between the gNB and UE doesn't change with time, e.g., the UE and the gNB are stationary, τ is independent of t₃ and t₄, i.e., τ=τ(t₃, t₄). t₄ is the start of the UL positioning reference signal (e.g., positioning sounding reference signal—positioning SRS) received at the gNB. t₄ is according to a common (global) reference time. The time according to base station reference time may be t_{b}(t₄)=t₄+δt_{b}(t₄), where δt_{b}(t₄) is a clock bias (i.e., offset) of the base station clock. In one example, the clock bias δt_{b}(t₄) is a function if time, i.e., it changes with time. In another example, the clock bias is fixed, i.e., δt_{b}(t₄)=δt_{b}.

In one example, t_{b}(t₄) may be the time of the start of the received UL positioning reference signal (e.g., positioning sounding reference signal—positioning SRS) from the start of an UL or DL symbol, for example (1) symbol n in slot m in frame k, or (2) symbol n in slot m in any frame, or (3) symbol n in any slot, or (4) symbol n in slot m in subframe l in frame k, or (5) symbol n in slot m in subframe l in any frame, or (6) symbol n in slot m in any subframe, or (7) symbol n in subframe l in frame k, or (8) symbol n in subframe l in any frame, or (9) symbol n in any subframe. For example, symbol n may be the symbol of the UL positioning reference signal (e.g., positioning sounding reference signal—positioning SRS), e.g., t_{b}(t₄) may be the time between the start of the UL or DL positioning reference symbol at the gNB and the start of the received UL positioning reference symbol.

In one example, t_{b}(t₄) may be the time of the start of the received UL positioning reference signal (e.g., positioning sounding reference signal—positioning SRS) from the start of an UL or DL slot, for example (1) slot m in frame k, or (2) slot m in any frame, or (3) slot m in subframe l in frame k, or (4) slot m in subframe l in any frame. For example, slot m may be the slot of the UL positioning reference signal (e.g., positioning sounding reference signal—positioning SRS), e.g., t_{b}(t₄) may be the time between the start of the slot of the UL or DL positioning reference symbol at the gNB and the start of the received UL positioning reference symbol.

In one example, t_{b}(t₄) may be the time of the start of the received UL positioning reference signal (e.g., positioning sounding reference signal—positioning SRS) from the start of an UL or DL subframe, for example (1) subframe l in frame k, or (2) subframe l in any frame. For example, subframe l may be the subframe of the UL positioning reference signal (e.g., positioning sounding reference signal—positioning SRS), e.g., t_{b}(t₄) may be the time between the start of the subframe of the UL or DL positioning reference symbol at the gNB and the start of the received UL positioning reference symbol.

In one example, t_{b}(t₄) may be the time of the start of the received UL positioning reference signal (e.g., positioning sounding reference signal—positioning SRS) from the start of an UL or DL frame, for example frame k. For example, frame k may be the frame of the UL positioning reference signal (e.g., positioning sounding reference signal—positioning SRS), e.g., t_{b}(t₄) may be the time between the start of the frame of the UL or DL positioning reference symbol at the gNB and the start of the received UL positioning reference symbol.

In one example, t_{b}(t₄) may be the time of the start of the received UL positioning reference signal (e.g., positioning sounding reference signal—positioning SRS) from the UL or DL SFN roll-over (e.g., SFN=0).

In one example, t_{b}(t₄) may be the time of the start of the received UL positioning reference signal (e.g., positioning sounding reference signal—positioning SRS) from a reference time in the gNB.

In one example, the common (global) reference time may be the time of the gNB. i.e., t_{b}(t₄)=t₄ and δt_{b}(t₄)=0.

In one example, n, m, l and/or k for the reference time of the UE and n, m, l and/or k for the reference time of the gNB may be the same. This is the example shown in FIG. 8A.

In one example, n, m, l and/or k for the reference time of the UE and n, m, l and/or k for the reference time of the gNB may be different.

In one example, phase of the gNB's reference signal (or reference phase) at the reference time (e.g., t_{b}=0) may be ϕ_{b02}. Phase continuity may be assumed between time t_{b}=0 and t_{b}(t₄) both times are according to the gNB reference time. For example, there is no slip in the phase locked loop providing the reference signal (or reference phase) of the gNB. Alternatively, the corresponding times according to the common (global) reference time can be used. The phase of the gNB's reference signal (or reference phase) at time t_{b}(t₄) may be given by:

ϕ_{b}(t_{b}(t₄))=ϕ_{b02}+2πft_{b}(t₄)=ϕ_{b02}+2πf(t₄+δt₄(t₄)) (19)

Where, t₄ is the time of arrival of the UL positioning reference signal (e.g., positioning sounding reference signal—positioning SRS) at the gNB. Where, t₄=t₃+τ(t₃, t₄). If the UE and the gNB are stationary (e.g., fixed positions) t₄=t₃+τ, i.e., τ doesn't depend on t₃ and t₄.

Therefore, the phase difference between the gNB's reference signal (or reference phase) and the carrier of the UL positioning reference signal (e.g., positioning sounding reference signal—positioning SRS) received at the gNB may be given by:

$$\frac{Δ ϕ ( {t}_{3} , {t}_{4} )}{2 π} = \frac{{ϕ}_{b} ( {t}_{b} ( {t}_{4} ) ) - {ϕ}_{u} ( {t}_{u} ( {t}_{3} ) )}{2 π} - {N}_{2} \qquad ( 20 )$$

$$\frac{Δ ϕ ( {t}_{3} , {t}_{4} )}{2 π} = \frac{{ϕ}_{b 02} - {ϕ}_{u 02}}{2 π} + f ( τ ( {t}_{3} , {t}_{4} ) + δ {t}_{b} ( {t}_{4} ) - δ {t}_{u} ( {t}_{3} ) ) - {N}_{2} \qquad ( 21 )$$

$$\frac{Δ ϕ ( {t}_{3} , {t}_{4} )}{2 π} = \frac{{ϕ}_{b 02} - {ϕ}_{u 02}}{2 π} + \frac{r ( {t}_{3} , {t}_{4} )}{λ} + f ( δ {t}_{b} ( {t}_{4} ) - δ {t}_{u} ( {t}_{3} ) ) - {N}_{2} \qquad ( 22 )$$

Taking the derivative of equation (21) and (22) with respect to frequency arrives at:

$$\frac{d}{d f} ( \frac{Δ ϕ ( {t}_{3} , {t}_{4} )}{2 π} ) = τ ( {t}_{3} , {t}_{4} ) + δ {t}_{b} ( {t}_{4} ) - δ {t}_{u} ( {t}_{3} ) \qquad ( 21 a )$$

$$\frac{d}{d f} ( \frac{Δ ϕ ( {t}_{3} , {t}_{4} )}{2 π} ) = \frac{r ( {t}_{3} , {t}_{4} )}{c} + δ {t}_{b} ( {t}_{4} ) - δ {t}_{u} ( {t}_{3} ) \qquad ( 22 a )$$

Equation (21a) and (22a) have eliminated the integer ambiguity and the initial phases.

In one example, the gNB may measure the carrier phase or slope of carrier phase or difference between carrier phase of two sub-carriers or carriers of the UL positioning reference signal (e.g., positioning SRS) transmitted by the UE. For example, the carrier phase measured by the gNB may be for ϕᵤ(tᵤ(t₃)). This is the carrier phase of the signal transmitted from the UE at time tᵤ(t₃) and arriving at the gNB at time t_{b}(t₄).

In one example, the gNB may measure the carrier phase of the UL positioning reference signal (e.g., positioning SRS) transmitted by the UE relative to gNB's reference phase, i.e., the gNB measures ϕ_{b}(t_{b}(t₄))−ϕᵤ(tᵤ(t₃)) or measures ϕᵤ(tᵤ(t₃)−ϕ_{b}(t_{b}(t₄)), wherein the signal is transmitted by the UE at time tᵤ(t₃) and arrives at the gNB at time t_{b}(t₃).

In one example, the gNB may report the measured carrier phase, as aforementioned, to other network entities e.g., LMF for location determination.

In one example, the gNB may use the measured carrier phase, as aforementioned, for location determination.

In one example, the gNB may report the measured carrier phase, as aforementioned, to the UE for location determination.

In one example, the clock bias at the gNB and the clock bias at the UE may be time independent. The clock bias at the gNB at time t₁ and t₄ may be the same, i.e., δt_{b}(t₁)=δt_{b}(t₄)=δt_{b}, and the clock bias at the UE at time t₂ and t₃ may be the same δtᵤ(t₂)=δtᵤ(t₃)=δtᵤ. In one example, there may be no time advance (TA) command transmitted by the gNB that can be effective or received at the UE between t₂ and t₃. Adding equations (16) and (21), and assuming constant clock arrives at:

$$\frac{Δ ϕ ( {t}_{1} , {t}_{2} )}{2 π} + \frac{Δ ϕ ( {t}_{3} , {t}_{4} )}{2 π} = \frac{{ϕ}_{u 01} - {ϕ}_{b 01}}{2 π} + \frac{{ϕ}_{b 02} - {ϕ}_{u 02}}{2 π} + f ( τ ( {t}_{1} , {t}_{2} ) + τ ( {t}_{3} , {t}_{4} ) ) - N \qquad ( 23 )$$

Where N is an integer that replaces N₁+N₂

In one example, the clock bias at the gNB and the clock bias at the UE may be time independent. i.e., δt_{b}(t₁)=δt_{b}(t₄)=δt_{b}, and δtᵤ(t₂)=δtᵤ(t₃)=δtᵤ. Adding equations (16a) and (21a), and assuming constant clock bias arrives at:

$$\frac{d}{d f} ( \frac{Δ ϕ ( {t}_{1} , {t}_{2} )}{2 π} ) + \frac{d}{d f} ( \frac{Δ ϕ ( {t}_{3} , {t}_{4} )}{2 π} ) = τ ( {t}_{1} , {t}_{2} ) + τ ( {t}_{3} , {t}_{4} ) \qquad ( 23 a )$$

In one example, the UE and the gNB may be stationary (e.g., fixed positions), i.e., τ(t₁, t₂)=τ(t₃, t₄)=τ. Therefore,

$$\frac{Δ ϕ ( {t}_{1} , {t}_{2} )}{2 π} + \frac{Δ ϕ ( {t}_{3} , {t}_{4} )}{2 π} = \frac{{ϕ}_{u 01} - {ϕ}_{b 01}}{2 π} + \frac{{ϕ}_{b 02} - {ϕ}_{u 02}}{2 π} + 2 f τ - N \qquad ( 24 )$$

In one example, the UE and the gNB may be stationary (e.g., fixed positions), i.e., τ(t₁, t₂)=τ(t₃, t₄)=τ. Therefore,

$$\frac{d}{d f} ( \frac{Δ ϕ ( {t}_{1} , {t}_{2} )}{2 π} ) + \frac{d}{d f} ( \frac{Δ ϕ ( {t}_{3} , {t}_{4} )}{2 π} ) = 2 f τ \qquad ( 24 a )$$

In one example, the reference point for phase measurement for DL positioning reference signal and UL positioning reference signal (e.g., positioning sounding reference signal—positioning SRS) may be the same at the gNB and at the UE, i.e.,
ϕ_{b01}=ϕ_{b02}=ϕ_{b0}, e.g., the gNB may maintain phase continuity between time of transmitting a DL PRS used for carrier phase measurement at the UE and the time of receiving UL positioning reference signal (e.g., positioning SRS) and measuring the carrier phase and
ϕᵤ₀₁=ϕᵤ₀₂=ϕᵤ₀, e.g., the UE may maintain phase continuity between time of transmitting UL positioning reference signal (e.g., positioning SRS) used for carrier phase measurement at the gNB and the time of receiving DL PRS and measuring the carrier phase.

Therefore,

$$\frac{Δ ϕ ( {t}_{1} , {t}_{2} )}{2 π} + \frac{Δ ϕ ( {t}_{3} , {t}_{4} )}{2 π} = f ( τ ( {t}_{1} , {t}_{2} ) + τ ( {t}_{3} , {t}_{4} ) ) - N \qquad ( 25 )$$

In one example, the reference point for phase measurement for DL positioning reference signal and UL positioning reference signal (e.g., positioning sounding reference signal—positioning SRS) may be the same at the gNB and at the UE, i.e., ϕ_{b01}=ϕ_{b02}=ϕ_{b0} and ϕᵤ₀₁=ϕᵤ₀₂=ϕᵤ₀. Therefore,

$$\frac{d}{d f} ( \frac{Δ ϕ ( {t}_{1} , {t}_{2} )}{2 π} ) + \frac{d}{d f} ( \frac{Δ ϕ ( {t}_{3} , {t}_{4} )}{2 π} ) = ( {t}_{1} , {t}_{2} ) + τ ( {t}_{3} , {t}_{4} ) \qquad ( 25 a )$$

In one example, the UE and the gNB may be stationary (e.g., fixed positions), i.e., τ(t₁, t₂)=τ(t₃, t₄)=τ. Furthermore, the reference point for phase measurement for DL positioning reference signal and UL positioning reference signal (e.g., positioning sounding reference signal—positioning SRS) may be the same at the gNB and at the UE, i.e., ϕ_{b01}=ϕ_{b02}=ϕ_{b0} and ϕᵤ₀₁=#ϕᵤ₀₂=ϕᵤ₀. Therefore,

$$\frac{Δ ϕ ( {t}_{1} , {t}_{2} )}{2 π} + \frac{Δ ϕ ( {t}_{3} , {t}_{4} )}{2 π} = 2 f τ - N \qquad ( 26 )$$

In one example, the UE and the gNB may be stationary (e.g., fixed positions), i.e., τ(t₁, t₂)=τ(t₃, t₄)=τ. Furthermore, the reference point for phase measurement for DL positioning reference signal and UL positioning reference signal (e.g., positioning sounding reference signal—positioning SRS) may be the same at the gNB and at the UE, i.e., ϕ_{b01}=ϕ_{b02}=ϕ_{b0} and ϕᵤ₀₁=ϕᵤ₀₂=ϕᵤ₀. Therefore,

$$\frac{d}{d f} ( \frac{Δ ϕ ( {t}_{1} , {t}_{2} )}{2 π} ) + \frac{d}{d f} ( \frac{Δ ϕ ( {t}_{3} , {t}_{4} )}{2 π} ) = 2 τ \qquad ( 26 a )$$

Therefore, the propagation delay τ may be given by

$$τ = \frac{Δ ϕ ( {t}_{1} , {t}_{2} ) + Δ ϕ ( {t}_{3} , {t}_{4} )}{4 π f} - \frac{N}{2} \qquad ( 27 )$$

N may be positive or negative and is to be determined. Therefore, the polarity of N is changed from equation (26) to equation (27).

Using equation (26a) arrive at:

$$τ = \frac{1}{2} ( \frac{d}{d f} ( \frac{Δ ϕ ( {t}_{1} , {t}_{2} )}{2 π} ) + \frac{d}{d f} ( \frac{Δ ϕ ( {t}_{3} , {t}_{4} )}{2 π} ) ) \qquad ( 27 a )$$

The impact of integer ambiguity is eliminated.

Similarly, by adding equations (17) and (22), and assuming constant clock bias arrives at:

$$\frac{Δ ϕ ( {t}_{1} , {t}_{2} )}{2 π} + \frac{Δ ϕ ( {t}_{3} , {t}_{4} )}{2 π} = \frac{{ϕ}_{u 01} - {ϕ}_{b 01}}{2 π} + \frac{{ϕ}_{b 02} - {ϕ}_{u 02}}{2 π} + \frac{r ( {t}_{1} , {t}_{2} ) + r ( {t}_{3} , {t}_{4} )}{λ} - N \qquad ( 28 )$$

Similarly, by adding equations (17a) and (22a), and assuming constant clock bias arrives at:

$$\frac{d}{df} ( \frac{Δ ϕ ( {t}_{1} , {t}_{2} )}{2 π} ) + \frac{d}{df} ( \frac{Δ ϕ ( {t}_{3} , {t}_{4} )}{2 π} ) = \frac{r ( {t}_{1} , {t}_{2} ) + r ( {t}_{3} , {t}_{4} )}{c} \qquad ( 28 a )$$

In one example, the UE and the gNB may be stationary (e.g., fixed positions), i.e., r(t₁, t₂)=r(t₃, t₄)=r. Therefore,

$$\frac{Δ ϕ ( {t}_{1} , {t}_{2} )}{2 π} + \frac{Δϕ ( {t}_{3} , {t}_{4} )}{2 π} = \frac{{ϕ}_{u 01} - {ϕ}_{b o 1}}{2 π} + \frac{{ϕ}_{b 02} - {ϕ}_{u 02}}{2 π} + \frac{2 r}{λ} - N \qquad ( 29 )$$

In one example, the UE and the gNB may be stationary (e.g., fixed positions), i.e., r(t₁, t₂)=r(t₃, t₄)=r. Therefore,

$$\frac{d}{df} ( \frac{Δϕ ( {t}_{1} , {t}_{2} )}{2 π} ) + \frac{d}{df} ( \frac{Δϕ ( {t}_{1} , {t}_{2} )}{2 π} ) = \frac{2 r}{c} \qquad ( 29 a )$$

In one example, the reference point for phase measurement for DL positioning reference signal and UL positioning reference signal (e.g., positioning sounding reference signal—positioning SRS) may be the same at the gNB and at the UE, i.e.,
ϕ_{b01}=ϕ_{b02}=ϕ_{b0}, e.g., the gNB may maintain phase continuity between time of transmitting a DL PRS used for carrier phase measurement at the UE and the time of receiving UL positioning reference signal (e.g., positioning SRS) and measuring the carrier phase and
ϕᵤ₀₁=ϕᵤ₀₂=ϕᵤ₀, e.g., the UE may maintain phase continuity between time of transmitting UL positioning reference signal (e.g., positioning SRS) used for carrier phase measurement at the gNB and the time of receiving DL PRS and measuring the carrier phase.

### Therefore,

$$\frac{Δϕ ( {t}_{1} , {t}_{2} )}{2 π} + \frac{Δϕ ( {t}_{3} , {t}_{4} )}{2 π} = \frac{r ( {t}_{1} , {t}_{2} ) + r ( {t}_{3} , {t}_{4} )}{λ} - N \qquad ( 30 )$$

In one example, the reference point for phase measurement for DL positioning reference signal and UL positioning reference signal (e.g., positioning sounding reference signal—positioning SRS) may be the same at the gNB and at the UE, i.e., ϕ_{b01}=ϕ_{b02}=ϕ_{b0} and ϕᵤ₀₁=ϕᵤ₀₂=ϕᵤ₀. Therefore,

$$\frac{d}{df} ( \frac{Δ ϕ ( {t}_{1} , {t}_{2} )}{2 π} ) + \frac{d}{df} ( \frac{Δ ϕ ( {t}_{3} , {t}_{4} )}{2 π} ) = \frac{r ( {t}_{1} , {t}_{2} ) + r ( {t}_{3} , {t}_{4} )}{c} \qquad ( 30 a )$$

In one example, the UE and the gNB may be stationary (e.g., fixed positions), i.e., r(t₁, t₂)=r(t₃, t₄)=r. Furthermore, the reference point for phase measurement for DL positioning reference signal and UL positioning reference signal (e.g., positioning sounding reference signal—positioning SRS) may be the same at the gNB and at the UE, i.e., ϕ_{b01}=ϕ_{b02}=ϕ_{b0} and ϕᵤ₀₁=ϕᵤ₀₂=ϕᵤ₀. Therefore,

$$\frac{Δϕ ( {t}_{1} , {t}_{2} )}{2 π} + \frac{Δϕ ( {t}_{3} , {t}_{4} )}{2 π} = \frac{2 r}{λ} - N \qquad ( 31 )$$

In one example, the propagation delay between the gNB and the UE, τ, may be estimated to within an accuracy of

$$\pm \frac{1}{4 f} .$$

This allows for the estimation of the integer component N of equation (27). The phase measurement provides a further refinement of the propagation delay.

In one example, the UE and the gNB may be stationary (e.g., fixed positions), i.e., r(t₁, t₂)=r(t₃, t₄)=r. Furthermore, the reference point for phase measurement for DL positioning reference signal and UL positioning reference signal (e.g., positioning sounding reference signal—positioning SRS) may be the same at the gNB and at the UE, i.e., ϕ_{b01}=ϕ_{b02}=ϕ_{b0} and ϕᵤ₀₁=ϕᵤ₀₂=ϕᵤ₀. Therefore,

$$\frac{d}{df} ( \frac{Δϕ ( {t}_{1} , {t}_{2} )}{2 π} ) + \frac{d}{df} ( \frac{Δϕ ( {t}_{3} , {t}_{4} )}{2 π} ) = \frac{2 r}{c} \qquad ( 31 a )$$

In equations, (28a), (29a), (30a) and (31a) the impact of integer ambiguity has been eliminated.

Although FIG. 8A illustrates one example of a round trip carrier-phase method, various changes may be made to FIG. 8A. For example, the reference times may change, the frames may change, etc.

FIG. 8B illustrates an example carrier phase method according to embodiments of the present disclosure. The embodiment of the carrier phase method in FIG. 8B is for illustration only. Other embodiments of a carrier phase method could be used without departing from the scope of this disclosure.

FIG. 8B illustrates an alternative example of the carrier phase method. In the example of FIG. 8B, the gNB has a bias in its clock relative to a common (global) reference time of δt_{b}. The UE has a bias in its clock relative to the common (global) reference time of δtᵤ. A reference symbol may be determined at the gNB and the UE. For example, the reference symbol may be symbol 0 (i.e., starting symbol) of a slot, a subframe, a frame or a frame with SFN 0. In an alternative example, this can be a DL PRS symbol. In an alternative example, this can be an UL PRS (or positioning SRS) symbol. In one example, the reference time of the reference signal can be the time of the transmission of the reference signal from the corresponding device. In another example, the reference time of the reference signal can be the time of the reception of the reference signal from the corresponding device.

The phase of the reference signal (or reference phase) at the gNB's reference time (t_{b}=0) is ϕ_{b0}. The phase of the reference signal (or reference phase) at the UE's reference time (tᵤ=0) is ϕᵤ₀. In one example, ϕᵤ₀=0. In one example, ϕ_{b0}=0.

The gNB transmits DL PRS n1, the DL PRS is transmitted after time Tₙ₁ from the gNB's reference time. Tₙ₁ can be deterministically determined, by knowing the reference symbol and the symbol of the PRS. In one example, Tₙ₁ includes the CP of symbol n1 (DL PRS symbol). In another example, Tₙ₁ is to the start of symbol n1 (DL PRS symbol). In one example, the phase of symbol n1 (DL PRS symbol) is ϕ_{b1}. In one example, ϕ_{b1}=0. In one example, ϕ_{b1} is after the CP of symbol n1 (DL PRS symbol). In one example, ϕ_{b1} is at the start of symbol n1 (DL PRS symbol).

The UE receives symbol n1 (DL PRS symbol) after a propagation delay of τ. As illustrated in FIG. 8B, symbol n1 (DL PRS symbol) is received after time Tₙ₁+τ+δt_{b}−δtᵤ from the UE's reference time. In FIG. 8A, the receive time is after the CP of symbol n1 (DL PRS symbol). In an alternative example, the receive time is at the start of symbol n1 (DL PRS symbol). The UE can measure the phase difference between the UE's reference signal (or reference phase) and the received signal. This phase difference is:

Δφᵤₑ=(ϕᵤ₀+(Tₙ₁+τ+δt_{b}−δtᵤ)2πf_{c}−ϕ_{b1})mod 2π

In one example, ϕᵤ₀=0, wherein Δφᵤₑ or −Δφᵤₑ is the phase of the signal (e.g., DL positioning reference signal) transmitted from the gNB received at the UE relative to a reference time at the UE.

The UE transmits UL PRS (e.g., positioning SRS) n2, the UL PRS (e.g., positioning SRS) is transmitted after time Tₙ₂ from the UE's reference time. Tₙ₂ can be deterministically determined, by knowing the reference symbol and the symbol of the UL PRS (positioning SRS) and the time advance at the UE (e.g., the difference in between the start of UL slot or subframe or frame and a corresponding DL slot or subframe or frame respectively). In one example, Tₙ₂ includes the CP of symbol n2 (UL PRS symbol or positioning SRS symbol). In another example, Tₙ₂ is to the start of symbol n2 (UL PRS symbol or positioning SRS symbol). In one example, the phase of symbol n2 (UL PRS symbol or positioning SRS symbol) is ϕᵤ₂. In one example, ϕᵤ₂=0. In one example, θᵤ₂ is after the CP of symbol n2 (UL PRS symbol or positioning SRS symbol). In one example, ϕᵤ₂ is at the start of symbol n2 (UL PRS symbol or positioning SRS symbol).

The gNB receives symbol n2 (UL PRS symbol or positioning SRS symbol) after a propagation delay of τ. As illustrated in FIG. 8B, symbol n2 (UL PRS symbol or positioning SRS symbol) is received after time Tₙ₂+τ−δt_{b}+δtᵤ from the gNB's reference time. In FIG. 8B, the receive time is after the CP of symbol n2 (UL PRS symbol or positioning SRS symbol). In an alternative example, the receive time may be at the start of symbol n2 (UL PRS symbol or positioning SRS symbol). The gNB may measure the phase difference between the gNB's reference signal (or reference phase) and the received signal. This phase difference is:

Δφ_{bs}=(ϕ_{b0}+(Tₙ₂+τ−δt_{b}+δtᵤ)2πf_{c}−ϕᵤ₂)mod 2π

In one example, ϕ_{b0}=0, wherein Δφ_{bs} or −Δφ_{bs} may be the phase of the signal (e.g., UL positioning reference signal) transmitted from the UE received at the gNB relative to a reference time at the UE.

By adding Δφᵤₑ and Δφ_{bs}, the clock biases of the UE and gNB may be eliminated, but not the integer ambiguity.

Δφᵤₑ+Δφ_{bs}=(ϕᵤ₀+ϕ_{b0}+(Tₙ₁+Tₙ₂+2τ)2πf_{c}−ϕ_{b1}−ϕᵤ₂)mod 2π

Taking the derivative of the last equation with respect to carrier frequency arrives at:

$$\frac{d}{d f} ( {Δφ}_{u e} ) + \frac{d}{d f} ( {Δφ}_{b s} ) = ( {T}_{n 1} + {T}_{n 2} + 2 τ ) 2 π$$

In a variant example, the measured phase at the UE may remove the phase effect of Tₙ₁, i.e.,

Δϕᵤₑ=Δφᵤₑ−Tₙ₁2πf_{c}=(ϕᵤ₀+(τ+δt_{b}−δtᵤ)2πf_{c}−ϕ_{b1})mod 2π

Similarly, the measured phase at the gNB may remove the phase effect of Tₙ₂, i.e.,

Δϕ_{bs}=Δφ_{bs}−Tₙ₂2πf_{c}=(ϕ_{b0}+(τ−δt_{b}+(tᵤ)2πf_{c}−ϕᵤ₂)mod 2π

Adding, Δϕᵤₑ and Δϕ_{bs} arrives at:

Δϕᵤₑ+Δϕ_{bs}=(ϕᵤ₀+ϕ_{b0}+(2τ)2πf_{c}−ϕ_{b1}−ϕᵤ₂)mod 2π

Taking the derivative arrives at:

$$\frac{d}{d f} ( Δ {ϕ}_{u e} ) + \frac{d}{d f} ( Δ {ϕ}_{b s} ) = ( 2 τ ) 2 π$$

Tₙ₁ and Tₙ₂ may be determined by knowing the reference symbols and symbols of DL PRS and UL PRS (or positioning SRS) and the time advance at the UE (e.g., the difference in between the start of UL slot or subframe or frame and a corresponding DL slot or subframe or frame respectively). ϕ_{b1} and ϕᵤ₂ may be specified in the system specification and/or configured or updated by RRC signaling and/or MAC CE signaling and/or L1 control signaling. Alternatively, ϕ_{b1} and ϕᵤ₂ may be reported by the gNB and UE respectively. ϕ_{b0} and ϕᵤ₀ may be reported by the gNB and UE respectively as separate parameters or can be included in the corresponding phase measurement or can have a value of 0. Alternatively, ϕ_{b1} and/or ϕᵤ₂ and/or ϕ_{b0} and ϕᵤ₀ may not be reported or configured or specified as they are eliminated from the last equation. Hence knowing the frequency derivatives,

$$\frac{d}{df} ( {Δφ}_{u e} ) and \frac{d}{df} ( {Δφ}_{b s} ) ,$$

or knowing

$$\frac{d}{df} ( Δ {ϕ}_{u e} ) and \frac{d}{df} ( Δ {ϕ}_{b s} ) ,$$

the propagation delay τ and corresponding the distance may be determined.

Although FIG. 8B illustrates one example of carrier phase method, various changes may be made to FIG. 8B. For example, the phase relationships may change, the cycle times may change, etc.

When taking the derivative, the phase is unwrapped to avoid any phase discontinuities. For example, the slope (frequency derivative) may be found by fitting the best curve with the phase measurements (after phase unwrapping) from the sub-carriers. An example is illustrated in FIG. 8C.

FIG. 8C illustrates an example slope from a best fit phase measurement curve according to embodiments of the present disclosure. The embodiment of best fit phase measurement curve in FIG. 8C is for illustration only. Other embodiments of a best fit phase measurement curve could be used without departing from the scope of this disclosure.

Although FIG. 8C illustrates one example of a best fit phase measurement curve, various changes may be made to FIG. 8C. For example, the slope may change, the data points may change, etc.

FIG. 8B illustrates that symbol n1, e.g., DL PRS symbol, is transmitted before symbol n2, e.g., UL PRS (or positioning SRS) symbol. In an alternative example, UL PRS (or positioning SRS) symbol may be transmitted before DL PRS symbol.

An alternative method to eliminate the clock biases between the UE and gNB is to use the single difference carrier phase measurement and double difference carrier phase measurement. Consider a network, as illustrated in FIG. 8D, that includes at least a UE, which is being positioned, two gNBs (or TRPs) and a reference device or unit (e.g., a device or unit whose position is known) referred to as RU or positioning reference unit (PRU).

FIG. 8D illustrates an example wireless network according to embodiments of the present disclosure. The embodiment of wireless network in FIG. 8D is for illustration only. Other embodiments of a wireless network could be used without departing from the scope of this disclosure.

In the example of FIG. 8D, the first gNB, i.e., gNB1 has a bias in its clock relative to a common (global) reference time of δt_{b1}. The second gNB, i.e., gNB2 has a bias in its clock relative to a common (global) reference time of δt_{b2}. The UE has a bias in its clock relative to the common (global) reference time of δtᵤₑ. The reference unit (RU) has a bias in its clock relative to the common (global) reference time of δtᵣᵤ.

A reference symbol may be determined at the gNB1, gNB2, UE and RU. For example, this may be symbol 0 of a slot, a subframe, a frame or a frame with SFN 0. In an alternative example, this may be a DL PRS symbol. In an alternative example, this may be an UL PRS (or positioning SRS) symbol. In one example, the reference time of the reference signal may be the time of the transmission of the reference signal from the corresponding device. In another example, the reference time of the reference signal may be the time of the reception of the reference signal from the corresponding device.

The phase of the reference signal at the gNB1's reference time (t_{b1}=0) may be ϕ_{b01}. The phase of the reference signal at the gNB2's reference time (t_{b2}=0) may be ϕ_{b02}. The phase of the reference signal at the UE's reference time (tᵤₑ=0) may be ϕᵤₑ₀. The phase of the reference signal at the RU's reference time (tᵣᵤ=0) may be ϕᵣᵤ₀.

gNB1 transmits DL PRS n11, the DL PRS is transmitted after time Tₙ₁₁ from gNB1's reference time. Tₙ₁₁ may be deterministically determined, by knowing the reference symbol and the symbol of the PRS. In one example, Tₙ₁₁ may include the CP of symbol n11 (DL PRS symbol). In another example, Tₙ₁₁ may be the start of symbol n11 (DL PRS symbol). In one example, the phase of symbol n11 (DL PRS symbol) may be ϕ_{b11}. In one example, ϕ_{b11}=0. In one example, ϕ_{b11} may be after the CP of symbol n11 (DL PRS symbol). In one example, ϕ_{b11} may be at the start of symbol n11 (DL PRS symbol).

The UE may receive symbol n11 (DL PRS symbol) after a propagation delay of τ1. Symbol n11 (DL PRS symbol from gNB1) may be received after time Tₙ₁₁+τ1+δt_{b1}−δtᵤₑ from the UE's reference time. The UE may measure the phase difference between the UE's reference signal and the received signal. This phase difference may be:

Δφᵤₑ₁=(ϕᵤₑ₀+(Tₙ₁₁+τ1+δt_{b0}−δtᵤₑ)2πf_{c}−ϕ_{b11})mod 2π

Similarly, gNB2 may transmit a DL PRS symbol n12 after time Tₙ₁₂ from gNB2's reference time. Symbol n12 may be transmitted with phase ϕ_{b12}. The UE may receive symbol n12 (DL PRS symbol) after a propagation delay of τ2. The UE may measure the phase difference between the UE's reference signal and the received signal. This phase difference may be shown to equal:

Δφᵤₑ₂=((Tₙ₁₂+τ2+δt_{b2}−δtᵤₑ)2πf_{c}−ϕ_{b12})mod 2π

The equations for Δφᵤₑ₁ and Δφᵤₑ₂, include the clock bias of gNB1, δt_{b1}, gNB2, δt_{b2} as well as the UE δtᵤₑ. By subtracting the two equations, the single difference is arrived at, which eliminates the clock bias of the UE, i.e.,

Δφ_{ue-sd}=Δφᵤₑ₁−Δφᵤₑ₂=((Tₙ₁₁−Tₙ₁₂+τ1−τ2+δt_{b1}−δt_{b2})2πf_{c}−ϕ_{b11}+ϕ_{b12})mod 2π

Similarly, the single difference carrier phase of the RU may be calculated. In the following equation, it is assumed that the RU uses the same DL PRS symbols n11 and n12 for its phase measurement, however different symbols may be used as well, different from those used for the UE. The RU may receive symbol n11 (DL PRS symbol from gNB1) after a propagation delay of τ1ᵣᵤ. The RU may receive symbol n12 (DL PRS symbol from gNB2) after a propagation delay of τ2ᵣᵤ. The single difference for the RU may be given by:

Δφ_{ru-sd}=(ϕᵣᵤ₀+(Tₙ₁₁−Tₙ₁₂+τ1ᵣᵤ−τ2ᵣᵤ+δt_{b1}−δt_{b2})2πf_{c}−ϕ_{b11}+ϕ_{b12})mod 2π

If the single difference carrier phase of the RU is subtracted from the single difference carrier phase of the UE, the double difference carrier phase is arrived at. This may be given by:

Δφ_{ue-dd}=Δφ_{ue-sd}−Δφ_{ru-sd}=(((τ1−τ2)−(τ1ᵣᵤ−τ2ᵣᵤ))2πf_{c})mod 2π

In the double difference equation, Δφ_{ue-dd}, the clock biases for all devices have been eliminated. The remaining factor is (τ1ᵣᵤ−τ2ᵣᵤ). However, the location of the RU is known, the difference in propagation delay from gNB1 and gNB2 to the RU may be also known.

Taking the derivative of double difference, Δφ_{ue-dd}, with respect to carrier frequency arrives at:

$$\frac{d}{d f} ( {Δφ}_{ue - dd} ) = ( ( τ 1 - τ 2 ) - ( τ {1}_{r u} - τ {2}_{r u} ) ) 2 π$$

Hence the difference in propagation delay between of the signal from gNB1 and gNB2 to the UE, i.e., τ1−τ2 may be determined.

When taking the derivative, the phase is unwrapped to avoid any phase discontinuities. For example, the slope (frequency derivative) may be found by fitting the best curve with the phase measurements (after phase unwrapping) from the sub-carriers. An example is illustrated in FIG. 8C.

While the previous description for the double difference phase was described for DL PRS, it may also be applied to UL PRS (positioning SRS). In this case, each gNB measures the phase of the signal received from the UE and RU. The measurements may be provided to the LMF or to one of the gNB or the UE, where the difference between the phase measured at each gNB is calculated for the UE and RU respectively (single difference). The difference between the single difference phase of the UE and the single difference phase of the RU may then be calculated to get the double difference phase that eliminates the clock biases.

As illustrated in FIG. 8C after phase unwrapping of the carrier phase measurement, the slope may be determined to get a propagation delay or a time of arrival difference. It should be apparent to those skilled in the art that τ maybe be determined by taking an inverse discrete Fourier transform (iDFT), or an inverse fast Fourier transform (iFFT), or a discrete Fourier transform (DFT), or a fast Fourier transform (iFFT), of a signal e^{jφ}^{ₙ}, where φₙ is the measured phase of sub-carrier n.

Consider measured sub-carrier phase of sub-carriers n=0, 1, 2, . . . , N−1 expressed as e^{jφ}^{ₙ}. If φₙ=2π(f_{c0}+n f_{sc})τ, the iDFT of the signal is

$${\sum }_{i = 0}^{N - 1} {e}^{j 2 π \frac{n m}{N}} {e}^{j 2 π ( {f}_{c 0} + n {f}_{sc} ) τ} = {e}^{j 2 π {f}_{c 0} τ} \frac{1 - {e}^{j 2 π ( m + N {f}_{s c} τ )}}{1 - {e}^{j 2 π ( \frac{m}{N} + {f}_{s c} τ )}} = exp ( j 2 π {f}_{c 0} + π ( N - 1 ) ( \frac{m}{N} + {f}_{sc} τ ) ) \frac{sin ( π ( m + N {f}_{s c} τ ) )}{sin ( \frac{π}{N} ( m + N {f}_{s c} τ ) )}$$

Using the last equation, the value of r may be estimated from the iDFT.

Although FIG. 8D illustrates one example of a wireless network, various changes may be made to FIG. 8D. For example, the wireless network could include any number of gNBs and any number of Ues in any suitable arrangement. Also, the gNB1 could communicate directly with any number of Ues and provide those Ues with wireless broadband access to the network. Similarly, gNB2 could communicate directly with the network and provide Ues with direct wireless broadband access to the network. Further, the gNB1 and gNB2 could provide access to other or additional external networks, such as external telephone networks or other types of data networks.

A gNB or TRP or base station may be configured to transmit a positioning reference signal in the downlink direction, e.g., the positioning reference signal may be a DL positioning reference signal (PRS).

A UE may be configured to receive a positioning reference signal in the downlink direction, e.g., the positioning reference signal may be a DL positioning reference signal (PRS).

The configuration of the downlink PRS may include:
Time domain resources, e.g., number of symbols and starting position within a slot of DL PRS.
Time domain behavior, whether transmission is aperiodic, semi-persistent or periodic transmission, including periodicity and/or offset for semi-persistent and periodic transmissions.
Frequency domain resources, e.g., starting position in frequency domain (e.g., FD shift), and length in frequency domain (e.g., number of PRBs or C-SRS).
Transmission comb related information. Number of transmission combs and transmission comb offset.
Code domain information, e.g., sequence ID, and group or sequence hopping type (e.g., neither, groupHopping or sequenceHopping).

Some of the aforementioned parameters may be common across the multiple TRPs, e.g., configured with a common configuration, and some may be distinct, e.g., specific for each TRP.

In one example, the reception of the DL PRS at the UE may be Omni-directional, e.g., a same spatial receive filter may receive transmissions from multiple TRPs.

In one example, the reception of the DL PRS at the UE from different TRPs may be on separate beams wherein a reception on a beam may be from one or more TRPs.

In one example, the gNB may report (e.g., to UE or to LMF) the reference symbol (e.g., corresponding to a reference time in the gNB). The start of the reference symbol may be used for determining the reference phase ϕ_{b01}. In one example, ϕ_{b01}=0. The reference symbol may be reported as:
Symbol n within slot m within subframe l within frame k
Most recent Symbol n within slot m within subframe l.
Most recent Symbol n within slot m.
Symbol n within subframe l within frame k
Most recent Symbol n within subframe l
Symbol n within slot m within frame k
Symbol n within frame k
Symbol 0 within slot m within subframe l within frame k
Most recent Symbol 0 within slot m within subframe l
Most recent Symbol 0 within slot m.
Symbol 0 within slot m within frame k
Symbol 0 within subframe l within frame k
Most recent Symbol 0 within subframe l
Symbol 0 within frame k
Symbol 0 of frame (SFN) 0.
The symbol of the DL PRS.
The first DL PRS symbol in the slot in which DL PRS is transmitted.

In one example, the gNB may configure or be configured the reference symbol (e.g., corresponding to a reference time in the gNB). The start of the reference symbol may be used for determining the reference phase ϕ_{b01}. In one example, ϕ_{b01}=0. The configuration may be by RRC signaling and/or MAC CE signaling and/or L1 control (e.g., DCI) signaling. The reference symbol may be configured as:
Symbol n within slot m within subframe l within frame k
Most recent Symbol n within slot m within subframe l.
Most recent Symbol n within slot m.
Symbol n within subframe l within frame k
Most recent Symbol n within subframe l
Symbol n within slot m within frame k
Symbol n within frame k
Symbol 0 within slot m within subframe l within frame k
Most recent Symbol 0 within slot m within subframe l
Most recent Symbol 0 within slot m.
Symbol 0 within slot m within frame k
Symbol 0 within subframe l within frame k
Most recent Symbol 0 within subframe l
Symbol 0 within frame k.
Symbol 0 of frame (SFN) 0.
The symbol of the DL PRS.
The first DL PRS symbol in the slot in which DL PRS is transmitted.

In one example, the reference symbol (e.g., corresponding to a reference time in the gNB) may be specified in the system specification. In one example, the default value may be specified in the system specifications and is used if no other value is configured by RRC signaling and/or MAC CE signaling and/or L1 control (e.g., DCI) signaling. E.g., reference time can be start of DL or UL symbol 0 of SFN 0, or the symbol of the DL PRS, or the first DL PRS symbol in the slot in which DL PRS is transmitted.

In one example, the gNB may report (e.g., to UE or to LMF) the phase at the start of the reference symbol, i.e., ϕ_{b01}. In one example, ϕ_{b01}=0.

In one example, the gNB may report (e.g., to UE or to LMF) the phase at the start of the reference symbol, i.e., ϕ_{b01} for one subcarrier. In one example, the sub-carrier may be at the middle (center) of the DL positioning reference signal allocation. In one example, the sub-carrier may be at the start of the DL positioning reference signal allocation. In one example, the sub-carrier may be at the end of the DL positioning reference signal allocation. In one example, the phase may be reported as the average phase for all sub-carriers in the PRB at a frequency that is an average frequency for all sub-carriers in the PRB. In one example, the reported carrier phase may correspond to point-A. In one example, the reported carrier phase may correspond to the RF-carrier frequency. In one example, the example the reported carrier phase may correspond to the absolute radio-frequency channel number (ARFCN). In one example, if the number of sub-carriers in the allocation is even, the middle (center) sub-carrier may be one of:
The average of the two middle sub-carriers.
The sub-carrier with the higher frequency of the two middle sub-carriers.
The sub-carrier with the lower frequency of the two middle sub-carriers.

In one example, the gNB may report (e.g., to UE or to LMF) the phase at the start of the reference symbol, i.e., ϕ_{b01} for all sub-carriers of the DL positioning reference signal. In one example, the phase at the start of the reference symbol, i.e., ϕ_{b01}, may be the same for all sub-carriers. In one example, ϕ_{b01}=0.

In one example, the gNB may report (e.g., to UE or to LMF) the phase at the start of the reference symbol, i.e., ϕ_{b01} for each (or some) PRB of the DL positioning reference signal. In one example, the reported carrier phase may correspond to common resource block 0. In one example, ϕ_{b01}=0. In one example, the reported carrier phase may correspond to a PRB at the start of the DL positioning reference signal allocation. In one example, the reported carrier phase may correspond to a PRB at the end of the DL positioning reference signal allocation. In one example, the reported carrier phase may correspond to a PRB at the center of the DL positioning reference signal allocation. In one example, the phase may be reported for the middle sub-carrier of the PRB (or center of PRB). In one example, the phase may be reported for the first sub-carrier of the PRB. In one example, the phase may be reported for the last sub-carrier of the PRB. In one example, the phase may be reported as the average phase for all sub-carriers in the PRB at a frequency that is an average frequency for all sub-carriers in the PRB. In one example, the number of sub-carriers per PRB may be even (e.g., 12), the middle (center) sub-carrier may be one of:
The average of the two middle sub-carriers.
The sub-carrier with the higher frequency of the two middle sub-carriers.
The sub-carrier with the lower frequency of the two middle sub-carriers.

In one example, the reference symbol may be the symbol of the DL positioning reference signal. In one example, the gNB may report the phase at the start of that reference signal.

In one example, the gNB may report an indication (e.g., to UE or another gNB or to LMF) if phase continuity has been maintained between the reference time (e.g., most recent reference time) and the transmission of the corresponding DL positioning reference signal.

In one example, the gNB may report an indication (e.g., to UE or another gNB or to LMF) if phase continuity is not maintained between the reference time (e.g., most recent reference time) and the transmission of the corresponding DL positioning reference signal.

In one example, the gNB may report an indication (e.g., to UE or another gNB or to LMF) if phase continuity is maintained between the reference time (e.g., most recent reference time) and the transmission of the corresponding DL positioning reference signal.

In one example, the gNB may report an indication (e.g., to UE or another gNB or to LMF) if phase continuity is maintained or is not maintained between the reference time (e.g., most recent reference time) and the transmission of the corresponding DL positioning reference signal.

In one example, the gNB may transmit the DL PRS if phase continuity is maintained between the start of the DL PRS transmissions and corresponding reference time.

In one example, the gNB may transmit the DL PRS regardless of whether or not phase continuity is maintained between the start of the DL PRS transmissions and corresponding reference time.

In one example, the gNB may report an indication (e.g., to UE or another gNB or to LMF), if phase continuity is maintained between a slot in which the DL PRS is transmitted and the most recent previous slot in which a second DL PRS has been transmitted.

In one example, the gNB may report an indication (e.g., to UE or another gNB or to LMF), if phase continuity is not maintained between a slot in which the DL PRS is transmitted and the most recent previous slot in which a second DL PRS has been transmitted.

In one example, the gNB may report an indication (e.g., to UE or another gNB or to LMF), whether or not phase continuity is maintained between a slot in which the DL PRS is transmitted and the most recent previous slot in which a second DL PRS has been transmitted.

In one example, the gNB may report an indication (e.g., to UE or another gNB or to LMF), if phase continuity is maintained between a symbol in which the DL PRS is transmitted and the most recent previous symbol in which a second DL PRS has been transmitted.

In one example, the gNB may report an indication (e.g., to UE or another gNB or to LMF), if phase continuity is not maintained between a symbol in which the DL PRS is transmitted and the most recent previous symbol in which a second DL PRS has been transmitted.

In one example, the gNB may report an indication (e.g., to UE or another gNB or to LMF), whether or not phase continuity is maintained between a symbol in which the DL PRS is transmitted and the most recent previous symbol in which a second DL PRS has been transmitted.

In one example, for the aforementioned examples, the second DL PRS transmission may have the same DL PRS resource ID as that of the DL PRS transmitted in the slot or the symbol.

In one example, for the aforementioned examples, the second DL PRS transmission may have the same DL PRS resource set ID as that of the DL PRS transmitted in the slot or the symbol.

In one example, for the aforementioned examples, the second DL PRS transmission may have the same DL PRS ID as that of the DL PRS transmitted in the slot or the symbol.

In one example, for the aforementioned examples, the second DL PRS transmission may have the same quasi-co-location source RS or TCI state as that of the DL PRS transmitted in the slot or the symbol.

In one example, for the aforementioned examples, the second DL PRS may be transmitted to UE U. In one example, the TRP may be configured with U by RRC signaling and/or MAC CE singling and or L1 control (e.g., DCI) signaling. In another example, U may be the same as that of the DL PRS transmitted in the slot or the symbol.

In one example, the gNB may report an indication (e.g., to UE or another gNB or to LMF), if phase continuity is maintained between DL PRS symbols transmitted in a slot.

In one example, the gNB may report an indication (e.g., to UE or another gNB or to LMF), if phase continuity is not maintained between DL PRS symbols transmitted in a slot.

In one example, the gNB may report an indication (e.g., to UE or another gNB or to LMF), whether or not phase continuity is maintained between DL PRS symbols transmitted in a slot.

In one example, phase continuity between a symbol transmitted at time Tₙ₁ and a symbol transmitted at time Tₙ₂ may be maintained if the phase at symbol Tₙ₁, i.e., φ(Tₙ₁), and the phase at symbol Tₙ₂, i.e., φ(Tₙ₂) is related by φ(Tₙ₂)=φ(Tₙ₁)+2πf_{c}(Tₙ₂−Tₙ₁), wherein, f_{c} is the frequency of the carrier or sub-carrier. In one example, the carrier phase can be the phase at the antenna port. In one example, the carrier phase may be the phase at the output of the antenna. In one example, the carrier phase may be the phase at the start of the symbol. In one example the carrier phase may be the phase after the CP of the symbol. In one example, one or more of the following may lead to the carrier phase continuity not being maintained:
A change in the RF chain.
A change in quasi-co-location.
A change in the transmission spatial filter.
A time advance or time retard between symbols.
The phase lock loop getting out of sync or slipping.

In one example, the UE may report (e.g., to gNB or to LMF) the reference symbol (e.g., corresponding to a reference time in the UE). The start of the reference symbol may be used for determining the reference phase ϕᵤ₀₁. In one example, ϕᵤ₀₁=0. The reference symbol may be reported as:
Symbol n within slot m within subframe l within frame k
Most recent Symbol n within slot m within subframe l.
Most recent Symbol n within slot m.
Symbol n within subframe l within frame k
Most recent Symbol n within subframe l
Symbol n within slot m within frame k
Symbol n within frame k
Symbol 0 within slot m within subframe l within frame k
Most recent Symbol 0 within slot m within subframe l
Most recent Symbol 0 within slot m.
Symbol 0 within slot m within frame k
Symbol 0 within subframe l within frame k
Most recent Symbol 0 within subframe l
Symbol 0 within frame k
Symbol 0 of frame (SFN) 0.

In one example, the UE may be configured the reference symbol (e.g., corresponding to a reference time in the UE). The start of the reference symbol may be used for determining the reference phase ϕᵤ₀₁. In one example, ϕᵤ₀₁=0. The configuration may be by RRC signaling and/or MAC CE signaling and/or L1 control (e.g., DCI) signaling. The reference symbol may be configured as:
Symbol n within slot m within subframe l within frame k
Most recent Symbol n within slot m within subframe l.
Most recent Symbol n within slot m.
Symbol n within subframe l within frame k
Most recent Symbol n within subframe l
Symbol n within slot m within frame k
Symbol n within frame k
Symbol 0 within slot m within subframe l within frame k
Most recent Symbol 0 within slot m within subframe l
Most recent Symbol 0 within slot m.
Symbol 0 within slot m within frame k
Symbol 0 within subframe l within frame k
Most recent Symbol 0 within subframe l
Symbol 0 within frame k
Symbol 0 of frame (SFN) 0.
The symbol of the DL PRS. This can be based on the UE's time reference.
The first DL PRS symbol in the slot in which DL PRS is received. This can be based on the UE's time reference.

In one example, the reference symbol (e.g., corresponding to a reference time in the UE) may be specified in the system specification. In one example, the default value may be specified in the system specifications and is used if no other value is configured by RRC signaling and/or MAC CE signaling and/or L1 control (e.g., DCI) signaling. E.g., reference time be start of DL or UL symbol 0 of SFN 0, or the symbol of the DL PRS (e.g., based on the UE's time reference), or the first DL PRS symbol in the slot in which DL PRS is received (e.g., based on the UE's time reference).

In one example, in the UE the start of an UL slot (or subframe or frame) for UL transmission is advanced relative to the corresponding reception time of a DL slot (or subframe or frame) by T_{TA} which is given as a sum of the round trip propagation delay and a TA, offset:

T_{TA}=(N_{TA}+N_{TA,offset})·T_{c}

Wherein, T_{c} is a reference unit time as defined TS 38.211 and is given by T_{c}=1/(Δfₘₐₓ·N_{f}), where Δfₘₐₓ=480 kHz and N_{f}=4096. In one example N_{TA,offset}=0. In one example N_{TA,offset}=25600. In one example N_{TA,offset}=39936. In one example, N_{TA,offset}=13792. N_{TA}·T_{c} corresponds to the round-trip propagation delay.

The time reference can be one of:
Start of UL Tx symbol or slot or subframe or frame corresponding to DL PRS symbol used for carrier phase measurement.

$$\frac{{T}_{TA}}{2}$$

after start of UL Tx symbol or slot or subframe or frame corresponding to DL PRS symbol used for carrier phase measurement.

$$\frac{{N}_{TA} \cdot {T}_{c}}{2}$$

after start of UL Tx symbol or slot or subframe or frame corresponding to DL PRS symbol used for carrier phase measurement.

$$\frac{{N}_{TA} \cdot {T}_{c}}{2} + {N}_{TA , offset} \cdot {T}_{c}$$

after start of UL Tx symbol or slot or subframe or frame corresponding to DL PRS symbol used for carrier phase measurement.
CP after start of UL Tx symbol or slot or subframe or frame corresponding to DL PRS symbol used for carrier phase measurement.

$$CP + \frac{{T}_{TA}}{2}$$

after start of UL Tx symbol or slot or subframe or frame corresponding to DL PRS symbol used for carrier phase measurement.

$$CP + \frac{{N}_{TA} \cdot {T}_{c}}{2}$$

after start of UL Tx symbol or slot or subframe or frame corresponding to DL PRS symbol used for carrier phase measurement.

$$C P + \frac{{N}_{TA} \cdot {T}_{c}}{2} + {N}_{TA , offset} \cdot {T}_{c}$$

after start of UL Tx symbol or slot or subframe or frame corresponding to DL PRS symbol used for carrier phase measurement.

In one example, the UE may report (e.g., to gNB or to LMF) the phase at the start of the reference symbol, i.e., ϕᵤ₀₁. In one example, ϕᵤ₀₁=0.

In one example, the UE may report (e.g., to gNB or to LMF) the phase at the start of the reference symbol, i.e., ϕᵤ₀₁ for one subcarrier. In one example, the sub-carrier may be at the middle (center) of the DL positioning reference signal allocation. In one example, the sub-carrier may be at the start of the DL positioning reference signal allocation. In one example, the sub-carrier may be at the end of the DL positioning reference signal allocation. In one example, the phase may be reported as the average phase for all sub-carriers in the PRB at a frequency that is an average frequency for all sub-carriers in the PRB. In one example, the reported carrier phase may correspond to point-A. In one example, the reported carrier phase may correspond to the RF-carrier frequency. In one example, the reported carrier phase may correspond to the absolute radio-frequency channel number (ARFCN). In one example, if the number of sub-carriers in the allocation is even, the middle (or center) sub-carrier may be one of:
The average of the two middle sub-carriers.
The sub-carrier with the higher frequency of the two middle sub-carriers.
The sub-carrier with the lower frequency of the two middle sub-carriers.

In one example, the UE may report (e.g., to gNB or to LMF) the phase at the start of the reference symbol, i.e., ϕᵤ₀₁ for all sub-carriers of the DL positioning reference signal. In one example, the phase at the start of the reference symbol, i.e., ϕᵤ₀₁, may be the same for all sub-carriers. In one example, ϕᵤ₀₁=0.

In one example, the UE may report (e.g., to gNB or to LMF) the phase at the start of the reference symbol, i.e., ϕᵤ₀₁ for each (or some) PRB of the DL positioning reference signal. In one example, the reported carrier phase may correspond to common resource block 0. In one example, ϕᵤ₀₁=0. In one example, the reported carrier phase may correspond to a PRB at the start of the DL positioning reference signal allocation. In one example, the reported carrier phase may correspond to a PRB at the end of the DL positioning reference signal allocation. In one example, the reported carrier phase may correspond to a PRB at the center of the DL positioning reference signal allocation. In one example, the phase may be reported for the middle sub-carrier of the PRB (or center of PRB). In one example, the phase may be reported for the first sub-carrier of the PRB. In one example, the phase may be reported for the last sub-carrier of the PRB. In one example, the phase may be reported as the average phase for all sub-carriers in the PRB at a frequency that is an average frequency for all sub-carriers in the PRB. In one example, the number of sub-carriers per PRB may be even (e.g., 12), the middle (center) sub-carrier may be one of:
The average of the two middle sub-carriers.
The sub-carrier with the higher frequency of the two middle sub-carriers.
The sub-carrier with the lower frequency of the two middle sub-carriers.

In one example, the reference symbol may be the symbol of the DL positioning reference signal. In one example, the UE may report the phase at the start of that reference signal.

In one example, the UE may report an indication (e.g., to gNB or to LMF) if phase continuity has been maintained between the reference time (e.g., most recent reference time) and the reception of the corresponding DL positioning reference signal.

In one example, the UE may report an indication (e.g., to gNB or to LMF) if phase continuity is not maintained between the reference time (e.g., most recent reference time) and the reception of the corresponding DL positioning reference signal.

In one example, the UE may report an indication (e.g., to gNB or to LMF) if phase continuity is maintained between the reference time (e.g., most recent reference time) and the reception of the corresponding DL positioning reference signal.

In one example, the UE may report an indication (e.g., to gNB or to LMF) if phase continuity is maintained or is not maintained between the reference time (e.g., most recent reference time) and the reception of the corresponding DL positioning reference signal.

In one example, the UE may report an indication (e.g., to gNB or to LMF), if phase continuity is maintained between a slot in which the DL PRS is received and the most recent previous slot in which a second DL PRS has been received.

In one example, the UE may report an indication (e.g., to gNB or to LMF), if phase continuity is not maintained between a slot in which the DL PRS is received and the most recent previous slot in which a second DL PRS has been received.

In one example, the UE may report an indication (e.g., to gNB or to LMF), whether or not phase continuity is maintained between a slot in which the DL PRS is received and the most recent previous slot in which a second DL PRS has been received.

In one example, the UE may report an indication (e.g., to gNB or to LMF), if phase continuity is maintained between a symbol in which the DL PRS is received and the most recent previous symbol in which a second DL PRS has been received.

In one example, the UE may report an indication (e.g., to gNB or to LMF), if phase continuity is not maintained between a symbol in which the DL PRS is received and the most recent previous symbol in which a second DL PRS has been received.

In one example, the UE may report an indication (e.g., to gNB or to LMF), whether or not phase continuity is maintained between a symbol in which the DL PRS is received and the most recent previous symbol in which a second DL PRS has been received.

In one example, for the aforementioned examples, the second DL PRS reception may have the same DL PRS resource ID as that of the DL PRS received in the slot or the symbol.

In one example, for the aforementioned examples, the second DL PRS reception may have the same DL PRS resource set ID as that of the DL PRS received in the slot or the symbol.

In one example, for the aforementioned examples, the second DL PRS reception may have the same DL PRS ID as that of the DL PRS received in the slot or the symbol.

In one example, for the aforementioned examples, the second DL PRS reception may have the same quasi-co-location source RS or TCI state as that of the DL PRS received in the slot or the symbol.

In one example, for the aforementioned examples, the second DL PRS may be received from cell C or TRP T or gNB G. In one example, the UE may be configured with C or T or G by RRC signaling and/or MAC CE singling and or L1 control (e.g., DCI) signaling. In another example, C or T or G may be the same as that of the DL PRS transmitted in the slot or the symbol.

In one example, the UE may report an indication (e.g., to gNB or to LMF), if phase continuity is maintained for DL PRS symbols received in a slot.

In one example, the UE may report an indication (e.g., to gNB or to LMF), if phase continuity is not maintained for DL PRS symbols received in a slot.

In one example, the UE may report an indication (e.g., to gNB or to LMF), whether or not phase continuity is maintained for DL PRS symbols received in a slot.

In one example, phase continuity between a reference phase for a symbol received at time Tₙ₁ and a reference phase for a symbol received at time Tₙ₂ may be maintained if the reference phase at symbol Tₙ₁, i.e., φ(Tₙ₁), and the phase at symbol Tₙ₂, i.e., φ(Tₙ₂) is related by φ(Tₙ₂)=φ(T₁)+2πf_{c}(Tₙ₂−Tₙ₁), wherein, f_{c} is the frequency of the carrier or sub-carrier. The phase shift through the RF circuitry or the front-end of the receiver may be the same at Tₙ₁ and Tₙ₂, i.e., phase coherency is maintained through the RF circuitry or the front-end of the receiver for phase continuity. In one example, the phase reference may be the phase at the start of the symbol. In one example the phase reference may be the phase after the CP of the symbol. In one example, one or more of the following may lead to the phase reference continuity not being maintained:
A change in the RF chain.
A change in quasi-co-location.
A change in the reception spatial filter.
A time advance or time retard between symbols.
The phase lock loop getting out of sync or slipping.

In one example, the UE may measure the phase between a reference signal (e.g., reference phase) and corresponding received DL PRS symbol, e.g., the UE measures the carrier phase of the received DL PRS, for example, this measurement may be relative to the reference phase of the UE.

The reference signal generated at the UE may give by (in complex domain):

Aᵣe^{j2πt}^{ᵤ}^{+jϕ}^{ᵤ₀₁}

In the real domain, the signal is given by

Aᵣ cos(2πftᵤ+ϕᵤ₀₁)

### Where,

Aᵣ is the amplitude of the reference signal
f is the carrier frequency
tᵤ is the time relative to the UE's reference time using the UE's clock. to can be given by tᵤ=t+δtᵤ, where t is according to the common (global) time reference and δtᵤ is the bias in the UE's clock.
ϕᵤ₀₁ is the phase of the reference signal at the UE's reference time. In one example, ϕᵤ₀₁=0, for example the phase difference between the received DL positioning reference signal and a reference signal of the UE is the phase of the received DL positioning reference signal.
   The received DL PRS at the UE, which corresponds to the DL PRS transmitted time r earlier may be given by (in complex domain):

Aₛe^{j2πf(t}^{_{b}}^{-τ)+jϕ}^{_{b01}}

In the real domain, the signal is given by

Aₛ cos(2πf(t_{b}−τ)+ϕ_{b01})

### Where,

Aₛ is the amplitude of the DL positioning reference signal
f is the carrier frequency
τ is the propagation delay from the gNB to the UE.
t_{b} is the time relative to the gNB's reference time using the gNB's clock. t_{b} can be given by t_{b}=t+δt_{b}, where t is according to the common (global) time reference and δt_{b} is the bias in the gNB's clock.
ϕ_{b01} is the phase of the reference signal at the gNB's reference time. In one example, ϕ_{b01}=0.

In one example, to measure the phase difference at the UE the reference signal (e.g., corresponding to the reference phase) may be multiplied by the complex conjugate of the received DL positioning reference signal at the UE. i.e.,

Aᵣe^{j2πft}^{ᵤ}^{+jϕ}^{ᵤ₀₁}Aₛe^{-j2πf(t}^{_{b}}^{τT)-jϕ}^{_{b01}}=AᵣAₛe^{j2πf(t}^{ᵤ}^{-t}^{_{b}}^{+τ)+jϕ}^{ᵤ₀₁}^{-jϕ}^{_{b}}01

Therefore, the phase difference may be: 2πf(tᵤ−t_{b}+τ)+ϕᵤ₀₁−ϕ_{b01}, which equals 2πf(δtᵤ−δt_{b}−+τ)+ϕᵤ₀₁−ϕ_{b01}.

In one example, a similar result may be found if the signals in the real domain are multiplied and passed through a low pass filter to eliminate the double carrier frequency component. This arrives at:

$$\frac{{A}_{r} {A}_{s}}{2} cos ( 2 π f ( {t}_{u} - {t}_{b} + τ ) + {ϕ}_{u 01} - {ϕ}_{b 01} )$$

Giving the same phase difference as before, which is: 2πf(tᵤ−t_{b}+τ)+ϕᵤ₀₁−ϕ_{b01}

In one example, if ϕᵤ₀₁=ϕ_{b01}, the phase difference is 2πf(tᵤ−t_{b}+τ).

In one example, if ϕᵤ₀₁=ϕ_{b01}=0, the phase difference is 2πf(tᵤ−t_{b}+τ).

The UE may estimate the derivative of the phase difference

$$( e . g . , \frac{d}{df} ( \frac{Δ ϕ ( {t}_{1} , {t}_{2} )}{2 π} ) ) .$$

This may be estimated for example by finding the slope of the best straight line that fits phase difference measurement of each sub-carrier.

In one example, the UE may report (e.g., to gNB or to LMF) the derivative of the phase difference between the reference signal (e.g., reference phase) and the corresponding received DL positioning reference signal of a TRP or gNB e.g., the UE measures the carrier phase of the received DL PRS from a TRP or gNB, for example, this measurement may be relative to the reference phase of the UE.

In one example, the phase may be unwrapped with respect to 2π, then the phase derivative is calculated.

In one example, the derivative of the phase difference (e.g., carrier phase of received DL PRS in a PRS occasion) may be reported if DL PRS is detected and measured.

In one example, the derivative of the phase difference (e.g., carrier phase of received DL PRS in a PRS occasion) may be reported if phase continuity is maintained between the corresponding reference time (e.g., most recent) and time of reception of the DL positioning reference signal.

In one example, the derivative of the phase difference (e.g., carrier phase of received DL PRS in a PRS occasion) may be reported regardless of maintaining phase continuity between the corresponding reference time (e.g., most recent) and time of reception of the DL positioning reference signal. In a further example, an indication may be included within the measurement report or in a separate message, that indicates whether or not phase continuity is maintained between the corresponding reference time (e.g., most recent) and time of reception of the DL positioning reference signal corresponding to the phase difference (e.g., carrier phase of received DL PRS) measurement.

In one example, the derivative of the phase difference (e.g., carrier phase of received DL PRS in a PRS occasion) may be reported if phase continuity is maintained between the DL positioning reference signal occasion corresponding to most recent (previous) phase difference (e.g., carrier phase of received DL PRS) measurement and the DL positioning reference signal occasion corresponding to current phase difference (e.g., carrier phase of received DL PRS) measurement.

In one example, the derivative of the phase difference (e.g., carrier phase of received DL PRS in a PRS occasion) may be reported regardless of maintaining phase continuity between the DL positioning reference signal occasion corresponding to most recent (previous) phase difference (e.g., carrier phase of received DL PRS) measurement and the DL positioning reference signal occasion corresponding to current phase difference (e.g., carrier phase of received DL PRS) measurement. In a further example, an indication may be included within the measurement report or in a separate message, that indicates whether or not phase continuity is maintained between the DL positioning reference signal occasion corresponding to most recent (previous) phase difference (e.g., carrier phase of received DL PRS) measurement and the DL positioning reference signal occasion corresponding to current phase difference (e.g., carrier phase of received DL PRS) measurement.

In one example, the derivative of the phase difference (e.g., carrier phase of received DL PRS in a PRS occasion) may be reported if phase continuity is maintained within the DL positioning reference signal occasion corresponding to current phase difference (e.g., carrier phase of received DL PRS) measurement.

In one example, the derivative of the phase difference (e.g., carrier phase of received DL PRS in a PRS occasion) may be reported whether or not phase continuity is maintained within the DL positioning reference signal occasion corresponding to current phase difference (e.g., carrier phase of received DL PRS) measurement. In a further example, an indication may be included within the measurement report or in a separate message, that indicates whether or not phase continuity is maintained within the DL positioning reference signal occasion corresponding to current phase difference (e.g., carrier phase of received DL PRS) measurement.

In a variant example, the UE may report (e.g., to gNB or to LMF) the phase difference of each sub-carrier of the DL positioning reference signal.

In a variant example, the UE may report (e.g., to gNB or to LMF) the phase difference for each PRB of the DL positioning reference signal. In one example, the phase may be reported for the middle sub-carrier of the PRB (or center of PRB). In one example, the phase may be reported for the first sub-carrier of the PRB. In one example, the phase may be reported for the last sub-carrier of the PRB. In one example, the phase difference may be reported as the average phase difference for all sub-carriers in the PRB at a frequency that is an average frequency for all sub-carriers in the PRB. In one example, the number of sub-carriers per PRB may be even (e.g., 12), the middle (center) sub-carrier may be one of:
The average of the two middle sub-carriers.
The sub-carrier with the higher frequency of the two middle sub-carriers.
The sub-carrier with the lower frequency of the two middle sub-carriers.

In one example, UE may report the derivative of the phase difference (e.g., carrier phase of received DL PRS in a PRS occasion) of the first (earliest) multi-path component (e.g., first detected multi-path component). In a further example, the UE may report for the first (earliest) multi-path along with derivative of the carrier phase, the RSRPP or ratio between the power of the first (earliest) multi-path to the total power (or the power of the remaining multi-path).

In one example, a UE may be provided a threshold, wherein the threshold may be specified in the system specifications and/or configured or updated by higher layer RRC signaling and/or MAC CE signaling and/or L1 control (e.g., DCI) signaling. UE measures/reports the derivative of the phase difference (e.g., carrier phase of received DL PRS in a PRS occasion) of the first (earliest) multi-path component (e.g., first detected multi-path component) if the RSRPP exceeds the threshold, or in an alternative example if the ratio between the power of the first (earliest) multi-path to the total power (or the power of the remaining multi-path) exceeds the threshold. In a further example, the UE may report for the first (earliest) multi-path along with the derivative of the carrier phase, the RSRPP or ratio between the power of the first (earliest) multi-path to the total power (or the power of the remaining multi-path).

In one example, UE may report the derivative of the phase difference (e.g., carrier phase of received DL PRS in a PRS occasion) of each multi-path component (e.g., each detected multi-path component). In a further example, the UE may report for each multi-path, along with the derivative of the carrier phase, the RSRPP and/or delay (e.g., relative to the first (earliest) multi-path) of the multi-path.

In one example, a UE may be provided a threshold, wherein the threshold can be specified in the system specifications and/or configured or updated by higher layer RRC signaling and/or MAC CE signaling and/or L1 control (e.g., DCI) signaling. In one example, the threshold can be a relative threshold between power of a multi-path component to the total power. In one example, the threshold can be a relative threshold between power of a multi-path component to the power of the first (earliest) multi-path component. The UE may report the derivative of the phase difference (e.g., carrier phase of received DL PRS in a PRS occasion) of each multi-path component with RSRPP that exceeds the threshold (e.g., each detected multi-path component with RSRPP that exceeds the threshold). In a further example, the UE may report for each multi-path, along with the carrier phase, the RSRPP and/or delay (e.g., relative to the first (earliest) multi-path) of the multi-path.

In one example, for the aforementioned examples, a PRS occasion may be one PRS symbol.

In one example, for the aforementioned examples, a PRS occasion may be all PRS symbols of a slot.

In one example, for the aforementioned examples, a PRS occasion may be a subset of PRS symbols of a slot.

In one example, for the aforementioned examples, phase continuity between a reference phase for a symbol received at time Tₙ₁ and a reference phase for a symbol received at time Tₙ₂ may be maintained if the reference phase at symbol Tₙ₁, i.e., φ(Tₙ₁), and the phase at symbol Tₙ₂, i.e., φ(Tₙ₂) is related by φ(Tₙ₂)=φ(Tₙ₁)+2πf_{c}(Tₙ₂−Tₙ₁), wherein, f_{c} is the frequency of the carrier or sub-carrier. The phase shift through the RF circuitry or the front-end of the receiver is the same at Tₙ₁ and Tₙ₂, i.e., phase coherency is maintained through the RF circuitry or the front-end of the receiver for phase continuity. In one example, the phase reference may be the phase at the start of the symbol. In one example the phase reference may be the phase after the CP of the symbol. In one example, one or more of the following may lead to the phase reference continuity not being maintained:
A change in the RF chain.
A change in quasi-co-location.
A change in the reception spatial filter.
A time advance or time retard between symbols.
The phase lock loop getting out of sync or slipping.

In one example, the UE may be configured a delta offset between two frequencies (or two sub-carriers) for which the UE uses to measure the carrier phase slope. In one example, the UE may measure the carrier phase slope based on any (selection can be up to the UE's implementation) or all sub-carriers in the DL PRS (e.g., within the DL BWP) that satisfy the configured delta offset.

In one example, the UE may determine a delta offset between two frequencies (or two sub-carriers) for which the UE uses to measure the carrier phase slope. In one example, the UE may measure the carrier phase slope based on any (selection can be up to the UE's implementation) or all sub-carriers in the DL PRS (e.g., within the DL BWP) that satisfy the determined delta offset. In one example, the UE may report in the measurement report the selected delta offset.

In one example, the number of measurements between sub-carriers to determine the slope of the carrier phase may be configured. The selection of sub-carriers may be up to UE's implementation as long as N measurements of carrier phase difference for the slope are performed.

In one example, the number of sub-carriers to use to determine the slope of the carrier phase may be configured. The selection of sub-carriers may be up to UE's implementation as long as N sub-carriers are selected.

In one example, a reliability metric may be configured for the carrier phase measurement (e.g., carrier phase slope), it may be up to the UE's implementation to select enough sub-carries to satisfy the reliability metric.

In one example, the UE is may be configured for two (or more) frequencies (or two (or more) sub-carriers) for which the UE uses to measure the carrier phase difference between. In one example, the difference in frequency between each two consecutive configured frequencies may be the same.

In one example, the UE may report (e.g., to gNB or to LMF) the delta, between two subcarriers of the phase difference between the reference signal and the corresponding received DL positioning reference signal. Let the phase difference between the reference signal and the corresponding received DL positioning reference signal at sub-carrier m be ϕₘ, and let the phase difference between the reference signal and the corresponding received DL positioning reference signal at sub-carrier n be ϕₙ. The delta phase difference between subcarrier m and subcarrier n is ϕₘ−ϕₙ.

In one example, the phase may be unwrapped with respect to 2π, then the delta phase difference may be calculated.

In one example, m and n may be consecutive sub-carriers of the DL PRS. For example, if the Comb size in N and the sub-carrier spacing is f_{sc}, wherein f_{sc}=2^{μ}·15 kHz, μ is the sub-carrier spacing configuration which can be 0, 1, 2, or 3, the difference in frequency between two consecutive sub-carriers is N·f_{sc}.

In one example, the delta of the phase difference may be reported for each consecutive (or in a variant example non-consecutive) pairs of m and n of the DL PRS.

In one example, the average of the delta of the phase difference for each consecutive (or in a variant example non-consecutive) pairs of m and n of the DL PRS may be reported.

In one example, the variance or standard deviation of the delta of the phase difference for each consecutive (or in a variant example non-consecutive) pairs of m and n of the DL PRS may be additionally reported.

In one example, the delta of the phase difference may be reported if DL PRS is detected and measured.

In one example, the delta of the phase difference may be reported if phase continuity is maintained between the corresponding reference time (e.g., most recent) and time of reception of the DL positioning reference signal.

In one example, the delta of the phase difference may be reported regardless of maintaining phase continuity between the corresponding reference time (e.g., most recent) and time of reception of the DL positioning reference signal.

In a variant example, the UE may report (e.g., to gNB or to LMF) the delta phase difference for each pair of consecutive (or in a variant example non-consecutive) PRBs of the DL positioning reference signal. In one example, the delta phase may be reported based on the middle (center) sub-carriers of the consecutive (or in a variant example non-consecutive) PRBs. In one example, the delta phase may be reported based on the first sub-carrier of the consecutive (or in a variant example non-consecutive) PRBs. In one example, the delta phase may be reported based on the last sub-carrier of the consecutive (or in a variant example non-consecutive) PRBs. In one example, the delta of phase difference may be reported based on the average phase difference for all sub-carriers in the consecutive (or in a variant example non-consecutive) PRBs. In one example, the number of sub-carriers per PRB may be even (e.g., 12), the middle (center) sub-carrier may be one of:
The average of the two middle sub-carriers.
The sub-carrier with the higher frequency of the two middle sub-carriers.
The sub-carrier with the lower frequency of the two middle sub-carriers.

In a variant example, the UE may report (e.g., to gNB or to LMF) the average of the delta phase difference for each pair of consecutive (or in a variant example non-consecutive) PRBs of the DL positioning reference signal. In one example, the average of the delta phase may be reported based on the middle (center) sub-carriers of the consecutive (or in a variant example non-consecutive) PRBs. In one example, the average of the delta phase may be reported based on the first sub-carrier of the consecutive (or in a variant example non-consecutive) PRBs. In one example, the average of the delta phase may be reported based on the last sub-carrier of the consecutive (or in a variant example non-consecutive) PRBs. In one example, the average of the delta of phase difference may be reported based on the average phase difference for all sub-carriers in the consecutive (or in a variant example non-consecutive) PRBs. In one example, the number of sub-carriers per PRB may be even (e.g., 12), the middle (center) sub-carrier may be one of:
The average of the two middle sub-carriers.
The sub-carrier with the higher frequency of the two middle sub-carriers.
The sub-carrier with the lower frequency of the two middle sub-carriers.

In a variant example, the UE may additionally report (e.g., to gNB or to LMF) the variance or the standard deviation of the delta phase difference for each pair of consecutive (or in a variant example non-consecutive) PRBs of the DL positioning reference signal. In one example, the variance or the standard deviation of the delta phase may be reported based on the middle (center) sub-carriers of the consecutive (or in a variant example non-consecutive) PRBs. In one example, the variance or the standard deviation of the delta phase may be reported based on the first sub-carrier of the consecutive (or in a variant example non-consecutive) PRBs. In one example, the variance or the standard deviation of the delta phase may be reported based on the last sub-carrier of the consecutive (or in a variant example non-consecutive) PRBs. In one example, the variance or the standard deviation of the delta of phase difference may be reported based on the average phase difference for all sub-carriers in the consecutive (or in a variant example non-consecutive) PRBs. In one example, the number of sub-carriers per PRB may be even (e.g., 12), the middle (center) sub-carrier may be one of:
The average of the two middle sub-carriers.
The sub-carrier with the higher frequency of the two middle sub-carriers.
The sub-carrier with the lower frequency of the two middle sub-carriers.

In one example, the UE may be configured a delta offset between two frequencies (or two sub-carriers) for which the UE measures the carrier phase difference between. In one example, the configured delta offset is in units of frequency (e.g., Hz or kHz or MHz). In one example, the configured delta offset is in number of sub-carriers. In one example, the configured delta offset is in number of sub-carriers multiplied by comb-size. In one example, the configured delta offset is in number of PRBs. In one example, the UE may measure the carrier phase difference between any (selection can be up to the UE's implementation) or all sub-carriers in the DL PRS (e.g., within the DL BWP) that satisfy the configured delta offset. In one example, the UE may determine and report an average carrier phase difference based on the measured carrier phase differences.

In one example, the UE determines or is configured, as aforementioned or is specified in the specifications, a delta offset between two frequencies (or two sub-carriers) for which the UE measures the carrier phase difference between. In one example, the UE may measure the carrier phase difference between any (selection can be up to the UE's implementation) or all sub-carriers in the DL PRS (e.g., within the DL BWP) that satisfy the determined delta offset. In one example, the UE may report in the measurement report the selected delta offset. In one example, the UE may determine and reports an average carrier phase difference based on the measured carrier phase differences.

In one example, the number of measurements between sub-carriers to determine the carrier phase difference may be configured. The selection of sub-carriers may be up to the UE's implementation as long as N measurements of carrier phase difference are performed.

In one example, the number of sub-carriers to use to determine the carrier phase difference may be configured. The selection of sub-carriers may be up to UE's implementation as long as N sub-carriers are selected.

In one example, a reliability metric may be configured for the carrier phase measurement (e.g., carrier phase difference), it is up the UE's implementation to select enough sub-carries to satisfy the reliability metric.

In one example, the UE may be configured two (or more) frequencies (or two (or more) sub-carriers) for which the UE measures the carrier phase difference between. In one example, if the UE is configured with multiple frequencies, and the difference between each two adjacent frequencies is the same, the UE may determine and report an average carrier phase difference based on the measured carrier phase differences between the multiple configured frequencies.

In one example, the UE may report (e.g., to gNB or to LMF) the delta phase, between two subcarriers of the received DL positioning reference signal. Let the phase of the received DL positioning reference signal at sub-carrier m be ϕₘ, and let the phase of the received DL positioning reference signal at sub-carrier n be ϕₙ. The delta phase between subcarrier m and subcarrier n is ϕₘ−ϕₙ.

In one example, the phase may be unwrapped with respect to 2π, then delta phase may be calculated.

In one example, m and n may be consecutive sub-carriers of the DL PRS. For example, if the Comb size in N and the sub-carrier spacing is f_{sc}, wherein f_{sc}=2^{μ}·15 kHz, μ is the sub-carrier spacing configuration which can be 0, 1, 2, or 3, the difference in frequency between two consecutive sub-carriers is N·f_{sc}.

In one example, the delta of the phase may be reported for each consecutive (or in a variant example non-consecutive) pair of m and n of the DL PRS.

In one example, the average of the delta of the phase for each consecutive (or in a variant example non-consecutive) pair of m and n of the DL PRS may be reported.

In one example, the variance or standard deviation of the delta of the phase for each consecutive (or in a variant example non-consecutive) pair of m and n of the DL PRS may be additionally reported.

In one example, the delta of the phase may be reported if DL PRS is detected and measured.

In one example, the delta of the phase may be reported if phase continuity is maintained between the corresponding reference time (e.g., most recent) and time of reception of the DL positioning reference signal.

In one example, the delta of the phase may be reported regardless of maintaining phase continuity between the corresponding reference time (e.g., most recent) and time of reception of the DL positioning reference signal.

In a variant example, the UE may report (e.g., to gNB or to LMF) the delta phase for each pair of consecutive (or in a variant example non-consecutive) PRBs of the DL positioning reference signal. In one example, the delta phase may be reported based on the middle (center) sub-carriers of the consecutive (or in a variant example non-consecutive) PRBs. In one example, the delta phase may be reported based on the first sub-carrier of the consecutive (or in a variant example non-consecutive) PRBs. In one example, the delta phase may be reported based on the last sub-carrier of the consecutive (or in a variant example non-consecutive) PRBs. In one example, the delta of phase may be reported based on the average phase for all sub-carriers in the consecutive (or in a variant example non-consecutive) PRBs. In one example, the number of sub-carriers per PRB may be even (e.g., 12), the middle (center) sub-carrier may be one of:
The average of the two middle sub-carriers.
The sub-carrier with the higher frequency of the two middle sub-carriers.
The sub-carrier with the lower frequency of the two middle sub-carriers.

In a variant example, the UE may report (e.g., to gNB or to LMF) the average of the delta phase for each pair of consecutive (or in a variant example non-consecutive) PRBs of the DL positioning reference signal. In one example, the average of the delta phase may be reported based on the middle (center) sub-carriers of the consecutive (or in a variant example non-consecutive) PRBs. In one example, the average of the delta phase may be reported based on the first sub-carrier of the consecutive (or in a variant example non-consecutive) PRBs. In one example, the average of the delta phase may be reported based on the last sub-carrier of the consecutive (or in a variant example non-consecutive) PRBs. In one example, the average of the delta of phase may be reported based on the average phase for all sub-carriers in the consecutive (or in a variant example non-consecutive) PRBs. In one example, the number of sub-carriers per PRB may be even (e.g., 12), the middle (center) sub-carrier may be one of:
The average of the two middle sub-carriers.
The sub-carrier with the higher frequency of the two middle sub-carriers.
The sub-carrier with the lower frequency of the two middle sub-carriers.

In a variant example, the UE may additionally report (e.g., to gNB or to LMF) the variance or the standard deviation of the delta phase for each pair of consecutive (or in a variant example non-consecutive) PRBs of the DL positioning reference signal. In one example, the variance or the standard deviation of the delta phase may be reported based on the middle (center) sub-carriers of the consecutive (or in a variant example non-consecutive) PRBs. In one example, the variance or the standard deviation of the delta phase may be reported based on the first sub-carrier of the consecutive (or in a variant example non-consecutive) PRBs. In one example, the variance or the standard deviation of the delta phase may be reported based on the last sub-carrier of the consecutive (or in a variant example non-consecutive) PRBs. In one example, the variance or the standard deviation of the delta of phase may be reported based on the average phase for all sub-carriers in the consecutive (or in a variant example non-consecutive) PRBs. In one example, the number of sub-carriers per PRB may be even (e.g., 12), the middle (center) sub-carrier may be one of:
The average of the two middle sub-carriers.
The sub-carrier with the higher frequency of the two middle sub-carriers.
The sub-carrier with the lower frequency of the two middle sub-carriers.

In one example, the UE is configured a delta offset between two frequencies (or two sub-carriers) for which the UE measures the carrier phase difference between. In one example, the configured delta offset is in units of frequency (e.g., Hz or kHz or MHz). In one example, the configured delta offset is in number of sub-carriers. In one example, the configured delta offset is in number of sub-carriers multiplied by comb-size. In one example, the configured delta offset is in number of PRBs. In one example, the UE may measure the carrier phase difference between any (selection can be up to the UE's implementation) or all sub-carriers in the DL PRS (e.g., within the DL BWP) that satisfy the configured delta offset. In one example, the UE may determine and report an average carrier phase difference based on the measured carrier phase differences.

In one example, the UE determines or is configured, as aforementioned or is specified in the specifications, a delta offset between two frequencies (or two sub-carriers) for which the UE measures the carrier phase difference between. In one example, the UE may measure the carrier phase difference between any (selection can be up to the UE's implementation) or all sub-carriers in the DL PRS (e.g., within the DL BWP) that satisfy the determined delta offset. In one example, the UE may report in the measurement report the selected delta offset. In one example, the UE may determine and report an average carrier phase difference based on the measured carrier phase differences.

In one example, the number of measurements between sub-carriers to determine the carrier phase difference may be configured. The selection of sub-carriers may be up to UE's implementation as long as N measurements of carrier phase difference are performed.

In one example, the number of sub-carriers to use to determine the carrier phase difference may be configured. The selection of sub-carriers may be up to UE's implementation as long as N sub-carriers are selected.

In one example, a reliability metric may be configured for the carrier phase measurement (e.g., carrier phase difference), it may be up to the UE's implementation to select enough sub-carries to satisfy the reliability metric.

In one example, the UE may be configured two (or more) frequencies (or two (or more) sub-carriers) for which the UE measures the carrier phase difference between. In one example, if the UE is configured with multiple frequencies, and the difference between each two adjacent frequencies is the same, the UE may determine and report an average carrier phase difference based on the measured carrier phase differences between the multiple configured frequencies.

In one example, the UE may report (e.g., to gNB or to LMF) a measurement based on the carrier phase difference between a first received DL positioning reference signal of a first TRP/gNB and a second received DL positioning reference signal of a second TRP/gNB. For example, the reported quantity may be derivative of the corresponding carrier phase difference or the delta phase between two sub-carriers of the carrier phase difference. The aforementioned examples apply to this case.

A UL positioning reference signal may be a positioning sounding reference signal—positioning SRS.

A UE may be configured to transmit a positioning reference signal in the uplink direction, e.g., the positioning reference signal may be a UL positioning reference signal (PRS) or positioning SRS.

A gNB or TRP or base station may be configured to receive a positioning reference signal in the uplink direction, e.g., the positioning reference signal may be a UL positioning reference signal (PRS) or positioning SRS.

The configuration of the uplink PRS or positioning SRS may include:
Time domain resources, e.g., number of symbols and starting position within a slot of UL PRS or positioning SRS.
Time domain behavior, whether transmission is aperiodic, semi-persistent or periodic transmission, including periodicity and/or offset for semi-persistent and periodic transmissions.
Frequency domain resources, e.g., starting position in frequency domain (e.g., FD shift), and length in frequency domain (e.g., number of PRBs or C-SRS).
Transmission comb related information. Number of transmission combs and transmission comb offset.
Code domain information, e.g., sequence ID, and group or sequence hopping type (e.g., neither, groupHopping or sequenceHopping).

Some of the aforementioned parameters may be common across the multiple TRPs, e.g., configured with a common configuration, and some may be distinct, e.g., specific for each TRP receiving the UL PRS or positioning SRS.

In one example, the transmission of the UL PRS or positioning SRS at the UE may be Omni-directional, e.g., a same spatial receive filter can transmit to multiple TRPs.

In one example, the transmission of the UL PRS or positioning SRS at the UE to different TRPs may be on separate beams wherein a transmission on a beam is to one or more TRPs.

In one example, the UE may report (e.g., to gNB or to LMF) the reference symbol (e.g., corresponding to a reference time in the UE). The start of the reference symbol may be used for determining the reference phase ϕᵤ₀₂. In one example, ϕᵤ₀₂=0. The reference symbol may be reported as:
Symbol n within slot m within subframe l within frame k
Most recent Symbol n within slot m within subframe l.
Most recent Symbol n within slot m.
Symbol n within subframe l within frame k
Most recent Symbol n within subframe l
Symbol n within slot m within frame k
Symbol n within frame k
Symbol 0 within slot m within subframe l within frame k
Most recent Symbol 0 within slot m within subframe l
Most recent Symbol 0 within slot m.
Symbol 0 within slot m within frame k
Symbol 0 within subframe l within frame k
Most recent Symbol 0 within subframe l
Symbol 0 within frame k
Symbol 0 of frame (SFN) 0.
The symbol of the UL PRS (e.g., positioning SRS).
The first UL PRS (e.g., positioning SRS) symbol in the slot in which UL PRS (e.g., positioning SRS) is transmitted.

In one example, the UE may be configured the reference symbol (e.g., corresponding to a reference time in the UE). The start of the reference symbol may be used for determining the reference phase ϕᵤ₀₂. In one example, ϕᵤ₀₂=0. The configuration may be by RRC signaling and/or MAC CE signaling and/or L1 control (e.g., DCI) signaling. The reference symbol may be configured as:
Symbol n within slot m within subframe l within frame k
Most recent Symbol n within slot m within subframe l.
Most recent Symbol n within slot m.
Symbol n within subframe l within frame k
Most recent Symbol n within subframe l
Symbol n within slot m within frame k
Symbol n within frame k
Symbol 0 within slot m within subframe l within frame k
Most recent Symbol 0 within slot m within subframe l
Most recent Symbol 0 within slot m.
Symbol 0 within slot m within frame k
Symbol 0 within subframe l within frame k
Most recent Symbol 0 within subframe l
Symbol 0 within frame k
Symbol 0 of frame (SFN) 0.
The symbol of the UL PRS (e.g., positioning SRS).
The first UL PRS (e.g., positioning SRS) symbol in the slot in which UL PRS (e.g., positioning SRS) is transmitted.

In one example, the reference symbol (e.g., corresponding to a reference time in the UE) may be specified in the system specification. In one example, the default value may be specified in the system specifications and may be used if no other value is configured by RRC signaling and/or MAC CE signaling and/or L1 control (e.g., DCI) signaling. e.g., reference time can be start of DL or UL symbol 0 of SFN 0, or the symbol of the UL PRS (e.g., positioning SRS), or the first DL PRS symbol in the slot in which UL PRS (e.g., positioning SRS) is transmitted.

In one example, the UE may report (e.g., to gNB or to LMF) the phase at the start of the reference symbol, i.e., ϕᵤ₀₂. In one example, ϕᵤ₀₂=0.

In one example, the UE may report (e.g., to gNB or to LMF) the phase at the start of the reference symbol, i.e., ϕᵤ₀₂ for one subcarrier. In one example, the sub-carrier may be at the middle (center) of the UL positioning reference signal or positioning SRS allocation. In one example, the sub-carrier may be at the start of the UL positioning reference signal or positioning SRS allocation. In one example, the reported carrier phase may correspond to point-A. In one example, the reported carrier phase may correspond to the RF-carrier frequency. In one example, the reported carrier phase may correspond to the absolute radio-frequency channel number (ARFCN). In one example, the sub-carrier may be at the end of the UL positioning reference signal or positioning SRS allocation. In one example, the phase may be reported as the average phase for all sub-carriers in the PRB at a frequency that is an average frequency for all sub-carriers in the PRB. In one example, if the number of sub-carriers is in the allocation even, the middle (center) sub-carrier may be one of:
The average of the two middle sub-carriers.
The sub-carrier with the higher frequency of the two middle sub-carriers.
The sub-carrier with the lower frequency of the two middle sub-carriers.

In one example, the UE may report (e.g., to gNB or to LMF) the phase at the start of the reference symbol, i.e., ϕᵤ₀₂ for all sub-carriers of the UL positioning reference signal or positioning SRS. In one example, the phase at the start of the reference symbol, i.e., ϕᵤ₀₂, may be the same for all sub-carriers. In one example, ϕᵤ₀₂=0.

In one example, the UE may report (e.g., to gNB or to LMF) the phase at the start of the reference symbol, i.e., ϕᵤ₀₂ for each (or some) PRB of the UL positioning reference signal or positioning SRS. In one example, the reported carrier phase may correspond to common resource block 0. In one example, ϕᵤ₀₂=0. In one example, the reported carrier phase may correspond to a PRB at the start of the UL positioning reference signal or positioning SRS allocation. In one example, the reported carrier phase may correspond to a PRB at the end of the DL positioning reference signal or positioning SRS allocation. In one example, the reported carrier phase may correspond to a PRB at the center of the DL positioning reference signal or positioning SRS allocation. In one example, the phase may be reported for the middle sub-carrier of the PRB (or center of PRB). In one example, the phase may be reported for the first sub-carrier of the PRB. In one example, the phase may be reported for the last sub-carrier of the PRB. In one example, the phase may be reported as the average phase for all sub-carriers in the PRB at a frequency that is an average frequency for all sub-carriers in the PRB. In one example, the number of sub-carriers per PRB may be even (e.g., 12), the middle (center) sub-carrier may be one of:
The average of the two middle sub-carriers.
The sub-carrier with the higher frequency of the two middle sub-carriers.
The sub-carrier with the lower frequency of the two middle sub-carriers.

In one example, the reference symbol may be the symbol of the UL positioning reference signal or positioning SRS. The UE may report the phase at the start of that reference signal.

In one example, the UE may report an indication (e.g., to gNB or to LMF) if phase continuity has been maintained between the reference time (e.g., most recent reference time) and the corresponding transmission of the UL positioning reference signal or positioning SRS.

In one example, the UE may report an indication (e.g., to gNB or to LMF) if phase continuity is not maintained between the reference time (e.g., most recent reference time) and the corresponding transmission of the UL positioning reference signal or positioning SRS.

In one example, the UE may report an indication (e.g., to gNB or to LMF) if phase continuity is maintained between the reference time (e.g., most recent reference time) and the corresponding transmission of the UL positioning reference signal or positioning SRS.

In one example, the UE may report an indication (e.g., to gNB or to LMF) if phase continuity is maintained or is not maintained between the reference time (e.g., most recent reference time) and the corresponding transmission of the UL positioning reference signal or positioning SRS.

In one example, the UE may transmit the UL PRS if phase continuity is maintained between the start of the UL PRS or positioning SRS transmissions and corresponding reference time.

In one example, the UE may transmit the UL PRS regardless of whether or not phase continuity is maintained between the start of the UL PRS or positioning SRS transmissions and corresponding reference time.

In one example, the UE may report an indication (e.g., to gNB or to LMF), if phase continuity is maintained between a slot in which the UL PRS or positioning SRS is transmitted and the most recent previous slot in which a second UL PRS or positioning SRS has been transmitted.

In one example, the UE may report an indication (e.g., to gNB or to LMF), if phase continuity is not maintained between a slot in which the UL PRS or positioning SRS is transmitted and the most recent previous slot in which a second UL PRS or positioning SRS has been transmitted.

In one example, the UE may report an indication (e.g., to gNB or to LMF), whether or not phase continuity is maintained between a slot in which the UL PRS or positioning SRS is transmitted and the most recent previous slot in which a second UL PRS or positioning SRS has been transmitted.

In one example, the UE may report an indication (e.g., to gNB or to LMF), if phase continuity is maintained between a symbol in which the UL PRS or positioning SRS is transmitted and the most recent previous symbol in which a second UL PRS or positioning SRS has been transmitted.

In one example, the UE may report an indication (e.g., to gNB or to LMF), if phase continuity is not maintained between a symbol in which the UL PRS or positioning SRS is transmitted and the most recent previous symbol in which a UL PRS or positioning SRS has been transmitted.

In one example, the UE may report an indication (e.g., to gNB or to LMF), whether or not phase continuity is maintained between a symbol in which the UL PRS or positioning SRS is transmitted and the most recent previous symbol in which a second UL PRS or positioning SRS has been transmitted.

In one example, for the aforementioned examples, the second UL PRS or positioning SRS transmission may have the same positioning SRS resource ID as that of the UL PRS or positioning SRS transmitted in the slot or symbol.

In one example, for the aforementioned examples, the second UL PRS or positioning SRS transmission may have same positioning SRS resource set ID as that of the UL PRS or positioning SRS transmitted in the slot or symbol.

In one example, for the aforementioned examples, the second UL PRS or positioning SRS transmission may have the same quasi-co-location source RS or TCI state as that of the UL PRS or positioning SRS transmitted in the slot or symbol.

In one example, for the aforementioned examples, the second UL PRS or positioning SRS may be transmitted to cell C or TRP T or gNB G. In one example, the UE may be configured with C or T or G by RRC signaling and/or MAC CE singling and or L1 control (e.g., DCI) signaling. In another example, C or T or G may be the same as those of the UL PRS or positioning SRS transmitted in the slot or symbol.

In one example, the UE may report an indication (e.g., to gNB or to LMF), if phase continuity is maintained between UL PRS or positioning SRS symbols transmitted in a slot.

In one example, the UE may report an indication (e.g., to gNB or to LMF), if phase continuity is not maintained between UL PRS or positioning SRS symbols transmitted in a slot.

In one example, the UE may report an indication (e.g., to gNB or to LMF), whether or not phase continuity is maintained between UL PRS or positioning SRS symbols transmitted in a slot.

In one example, phase continuity between a symbol transmitted at time Tₙ₁ and a symbol transmitted at time Tₙ₂ may be maintained if the phase at symbol Tₙ₁, i.e., φ(Tₙ₁), and the phase at symbol Tₙ₂, i.e., φ(Tₙ₂) is related by φ(Tₙ₂)=φ(Tₙ₁)+2πf_{c}(Tₙ₂−Tₙ₁), wherein, f_{c} is the frequency of the carrier or sub-carrier. In one example, the carrier phase may be the phase at the antenna port. In one example, the carrier phase may be the phase at the output of the antenna. In one example, the carrier phase may be the phase at the start of the symbol. In one example the carrier phase may be the phase after the CP of the symbol. In one example, one or more of the following may lead to the carrier phase continuity not being maintained:
A change in the RF chain.
A change in quasi-co-location.
A change in the transmission spatial filter.
A time advance or time retard between symbols.
The phase lock loop getting out of sync or slipping.

In one example, the gNB may report (e.g., to UE or to LMF) the reference symbol (e.g., corresponding to a reference time in the gNB). The start of the reference symbol may be used for determining the reference phase ϕ_{b02}. In one example, ϕ_{b02}=0. The reference symbol may be reported as:
Symbol n within slot m within subframe l within frame k
Most recent Symbol n within slot m within subframe l.
Most recent Symbol n within slot m.
Symbol n within subframe l within frame k
Most recent Symbol n within subframe l
Symbol n within slot m within frame k
Symbol n within frame k
Symbol 0 within slot m within subframe l within frame k
Most recent Symbol 0 within slot m within subframe l
Most recent Symbol 0 within slot m.
Symbol 0 within slot m within frame k
Symbol 0 within subframe l within frame k
Most recent Symbol 0 within subframe l
Symbol 0 within frame k
Symbol 0 of frame (SFN) 0.

In one example, the gNB may configure or be configured the reference symbol (e.g., corresponding to a reference time in the gNB). The start of the reference symbol may be used for determining the reference phase ϕ_{b02}. In one example, ϕ_{b02}=0. The configuration can be by RRC signaling and/or MAC CE signaling and/or L1 control (e.g., DCI) signaling. The reference symbol may be configured as:
Symbol n within slot m within subframe l within frame k
Most recent Symbol n within slot m within subframe l.
Most recent Symbol n within slot m.
Symbol n within subframe l within frame k
Most recent Symbol n within subframe l
Symbol n within slot m within frame k
Symbol n within frame k
Symbol 0 within slot m within subframe l within frame k
Most recent Symbol 0 within slot m within subframe l
Most recent Symbol 0 within slot m.
Symbol 0 within slot m within frame k
Symbol 0 within subframe l within frame k
Most recent Symbol 0 within subframe l
Symbol 0 within frame k
Symbol 0 of frame (SFN) 0.
The symbol of the UL PRS or positioning SRS. This can be based on the TRP's/gNB's time reference.
The first UL PRS or positioning SRS symbol in the slot in which UL PRS or positioning SRS is received. This can be based on the TRP's/gNB's time reference.

In one example, the reference symbol (e.g., corresponding to a reference time in the gNB) may be specified in the system specification. In one example, the default value may be specified in the system specifications and is used if no other value is configured by RRC signaling and/or MAC CE signaling and/or L1 control (e.g., DCI) signaling. E.g., reference time can be start of DL or UL symbol 0 of SFN 0 or the symbol of the UL PRS or positioning SRS (e.g., based on the TRP's/gNB's time reference), or the first UL PRS or positioning SRS symbol in the slot in which UL PRS or positioning SRS is received (e.g., based on the TRP's/gNB's time reference).

In one example, the may gNB report (e.g., to UE or to another gNB or to LMF) the phase at the start of the reference symbol, i.e., ϕ_{b02}. In one example, ϕ_{b02}=0.

In one example, the gNB may report (e.g., to UE or to another gNB or to LMF) the phase at the start of the reference symbol, i.e., ϕ_{b02} for one subcarrier. In one example, the sub-carrier may be at the middle (center) of the UL positioning reference signal or positioning SRS allocation. In one example, the sub-carrier may be at the start of the UL positioning reference signal or positioning SRS allocation. In one example, the sub-carrier may be at the end of the UL positioning reference signal or positioning SRS allocation. In one example, the phase may be reported as the average phase for all sub-carriers in the PRB at a frequency that is an average frequency for all sub-carriers in the PRB. In one example, the reported carrier phase may correspond to point-A. In one example, the reported carrier phase may correspond to the RF-carrier frequency. In one example, the reported carrier phase may correspond to the absolute radio-frequency channel number (ARFCN). In one example, if the number of sub-carriers in the allocation is even, the middle (center) sub-carrier may be one of:
The average of the two middle sub-carriers.
The sub-carrier with the higher frequency of the two middle sub-carriers.
The sub-carrier with the lower frequency of the two middle sub-carriers.

In one example, the gNB may report (e.g., to UE or to LMF) the phase at the start of the reference symbol, i.e., ϕ_{b02} for all sub-carriers of the UL positioning reference signal or positioning SRS. In one example, the phase at the start of the reference symbol, i.e., ϕ_{b02}, may be the same for all sub-carriers. In one example, ϕ_{b02}=0.

In one example, the gNB may report (e.g., to UE or to LMF) the phase at the start of the reference symbol, i.e., ϕ_{b02} for each (or some) PRB of the UL positioning reference signal or positioning SRS. In one example, the reported carrier phase may correspond to common resource block 0. In one example, ϕ_{b02}=0. In one example, the reported carrier phase may correspond to a PRB at the start of the UL positioning reference signal or positioning SRS allocation. In one example, the reported carrier phase may correspond to a PRB at the end of the UL positioning reference signal or positioning SRS allocation. In one example, the reported carrier phase may correspond to a PRB at the center of the UL positioning reference signal or positioning SRS allocation. In one example, the phase may be reported for the middle sub-carrier of the PRB (or center of PRB). In one example, the phase may be reported for the first sub-carrier of the PRB. In one example, the phase may be reported for the last sub-carrier of the PRB. In one example, the phase may be reported as the average phase for all sub-carriers in the PRB at a frequency that is an average frequency for all sub-carriers in the PRB. In one example, the number of sub-carriers per PRB may be even (e.g., 12), the middle (center) sub-carrier may be one of:
The average of the two middle sub-carriers.
The sub-carrier with the higher frequency of the two middle sub-carriers.
The sub-carrier with the lower frequency of the two middle sub-carriers.

In one example, the reference symbol may be the symbol of the UL positioning reference signal or positioning SRS. The UE may report the phase at the start of that reference.

In one example, the gNB may report an indication (e.g., to UE or to another gNB or to LMF) if phase continuity has been maintained between the reference time (e.g., most recent reference time) and the corresponding reception of the UL positioning reference signal or positioning SRS.

In one example, the gNB may report an indication (e.g., to UE or to another gNB or to LMF) if phase continuity is not maintained between the reference time (e.g., most recent reference time) and the corresponding reception of the UL positioning reference signal or positioning SRS.

In one example, the gNB may report an indication (e.g., to UE or to another gNB or to LMF) if phase continuity is maintained between the reference time (e.g., most recent reference time) and the corresponding reception of the UL positioning reference signal or positioning SRS.

In one example, the gNB may report an indication (e.g., to UE or to another gNB or to LMF) if phase continuity is maintained or is not maintained between the reference time (e.g., most recent reference time) and the corresponding reception of the UL positioning reference signal or positioning SRS.

In one example, the gNB may report an indication (e.g., to UE or to LMF), if phase continuity is maintained between a slot in which the UL PRS or positioning SRS is received and the most recent previous slot in which a second UL PRS or positioning SRS has been received.

In one example, the gNB may report an indication (e.g., to UE or to LMF), if phase continuity is not maintained between a slot in which the UL PRS or positioning SRS is received and the most recent previous slot in which a second UL PRS or positioning SRS has been received.

In one example, the gNB may report an indication (e.g., to UE or to LMF), whether or not phase continuity is maintained between a slot in which the UL PRS or positioning SRS is received and the most recent previous slot in which a second UL PRS or positioning SRS has been received.

In one example, the gNB may report an indication (e.g., to UE or to LMF), if phase continuity is maintained between a symbol in which the UL PRS or positioning SRS is received and the most recent previous symbol in which a second UL PRS or positioning SRS has been received.

In one example, the gNB may report an indication (e.g., to UE or to LMF), if phase continuity is not maintained between a symbol in which the UL PRS or positioning SRS is received and the most recent previous symbol in which a second UL PRS or positioning SRS has been received.

In one example, the gNB may report an indication (e.g., to UE or to LMF), whether or not phase continuity is maintained between a symbol in which the UL PRS or positioning SRS is received and the most recent previous symbol in which a second UL PRS or positioning SRS has been received.

In one example, for the aforementioned examples, the second UL PRS or positioning SRS reception may have the same positioning SRS resource ID as that of the UL PRS or positioning SRS received in the slot or the symbol.

In one example, for the aforementioned examples, the second UL PRS or positioning SRS reception may have the same positioning resource set ID as that of the UL PRS or positioning SRS received in the slot or the symbol.

In one example, for the aforementioned examples, the second UL PRS or positioning SRS reception may have the same quasi-co-location source RS or TCI state as that of the UL PRS or positioning SRS received in the slot or the symbol.

In one example, for the aforementioned examples, the second UL PRS or positioning SRS may be received from UE U. In one example, the TRP may be configured with U by RRC signaling and/or MAC CE singling and or L1 control (e.g., DCI) signaling. In another example, U may be the same as that of the UL PRS or positioning SRS transmitted in the slot or the symbol.

In one example, the gNB may report an indication (e.g., to UE or to LMF), if phase continuity is maintained for UL PRS or positioning SRS symbols received in a slot.

In one example, the gNB may report an indication (e.g., to UE or to LMF), if phase continuity is not maintained for UL PRS or positioning SRS symbols received in a slot.

In one example, the gNB may report an indication (e.g., to UE or to LMF), whether or not phase continuity is maintained for UL PRS or positioning SRS symbols received in a slot.

In one example, phase continuity between a reference phase for a symbol received at time Tₙ₁ and a reference phase for a symbol received at time Tₙ₂ may be maintained if the reference phase at symbol Tₙ₁, i.e., φ(Tₙ₁), and the phase at symbol Tₙ₂, i.e., φ(Tₙ₂) is related by φ(Tₙ₂)=φ(T₁)+2πf_{c}(Tₙ₂−Tₙ₁), wherein, f_{c} is the frequency of the carrier or sub-carrier. The phase shift through the RF circuitry or the front-end of the receiver is the same at Tₙ₁ and Tₙ₂, i.e., phase coherency is maintained through the RF circuitry or the front-end of the receiver for phase continuity. In one example, the phase reference can be the phase at the start of the symbol. In one example the phase reference can be the phase after the CP of the symbol. In one example, one or more of the following can lead to the phase reference continuity not being maintained:
A change in the RF chain.
A change in quasi-co-location.
A change in the reception spatial filter.
A time advance or time retard between symbols.
The phase lock loop getting out of sync or slipping.

In one example, the TRP/gNB may measure the phase between reference signal (e.g., reference phase) and corresponding received UL PRS or positioning SRS symbol, e.g., the TRP/gNB measures the carrier phase of the received UL PRS or positioning SRS, for example, this measurement may be relative to the reference phase of the TRP/gNB.

The reference signal generated at the gNB may be given by (in complex domain):

Aᵣe^{j2πft}^{_{b}}^{+jϕ}^{_{b02}}

In the real domain, the signal may be given by

Aᵣ cos(2πft_{b}+ϕ_{b02})

### Where,

Aᵣ is the amplitude of the reference signal
f is the carrier frequency
t_{b} is the time relative to the gNB's reference time using the gNB's clock. t_{b} can be given by t_{b}=t+δt_{b}, where t is according to the common (global) time reference and δt_{b} is the bias in the gNB's clock.
ϕ_{b02} is the phase of the reference signal at the gNB's reference time. In one example, ϕ_{b02}=0, for example the phase difference between the received UL positioning reference signal and a reference signal of the gNB is the phase of the received UL positioning reference signal.

The received UL PRS or positioning SRS at the gNB, which corresponds to the UL PRS transmitted time r earlier may be given by (in complex domain):

Aₛe^{j2πf(t}^{ᵤ}^{-τ)+jϕ}^{ᵤ₀₂}

In the real domain, the signal may be given by

Aₛ cos(2πf(tᵤ−τ)+ϕᵤ₀₂)

### Where,

Aₛ is the amplitude of the UL positioning reference signal or positioning SRS positioning reference signal
f is the carrier frequency
τ is the propagation delay from the UE to the gNB.
tᵤ is the time relative to the UE's reference time using the UE's clock. tᵤ can be given by tᵤ=t+δtᵤ, where t is according to the common (global) time reference and δtᵤ is the bias in the UE's clock.
ϕᵤ₀₂ is the phase of the reference signal at the UE's reference time. In one example, ϕᵤ₀₂=0.

In one example, to measure the phase difference at the gNB the reference signal (e.g., corresponding to the reference phase) may be multiplied by the complex conjugate of the received UL positioning reference signal or positioning SRS at the gNB. i.e.,

Aᵣe^{j2πft}^{_{b}}^{+jϕ}^{_{b02}}Aₛe^{-j2πf(t}^{ᵤ}^{-τ)-jϕ}^{ᵤ₀₂}=AᵣAₛe^{j2πf(t}^{_{b}}^{-t}^{ᵤ}^{+τ)+jϕ}^{_{b02}}^{-jϕ}^{ᵤ}02

Therefore, the phase difference may be: 2πf(t_{b}−tᵤ+τ)+ϕ_{b02}−ϕᵤ₀₂, which equals 2πf(δt_{b}−δtᵤ+τ)+ϕ_{b02}−ϕᵤ₀₂.

In one example, a similar result may be found if you multiply the signals in the real domain and pass through a low pass filter to eliminate the double carrier frequency component. The result is

$$\frac{{A}_{r} {A}_{s}}{2} cos ( 2 π f ( {t}_{b} - {t}_{u} + τ ) + {ϕ}_{b 02} - {ϕ}_{u 02} )$$

Giving the same phase difference as before, which is: 2πf(t_{b}−tᵤ+τ)+ϕ_{b02}−ϕᵤ₀₂

The UE may estimate the derivative of the phase difference

$$( e . g . , \frac{d}{df} ( \frac{Δ ϕ ( {t}_{1} , {t}_{2} )}{2 π} ) ) .$$

This may be estimated for example by finding the slope of the best straight line that fits phase difference measurement of each sub-carrier.

In one example, the TRP/gNB may report (e.g., to UE or to LMF) the derivative of the phase difference between the reference signal (e.g., reference phase) and the corresponding received UL positioning reference signal or positioning SRS of a UE e.g., the TRP/gNB measures the carrier phase of the received UL PRS or positioning SRS from a UE, for example, this measurement may be relative to the reference phase of the TRP/gNB.

In one example, the phase may be unwrapped with respect to 2π, then the phase derivative may be calculated.

In one example, the derivative of the phase difference (e.g., carrier phase of received UL PRS or positioning SRS in a PRS occasion) may be reported if UL PRS or positioning SRS is detected and measured.

In one example, the derivative of the phase difference (e.g., carrier phase of received UL PRS or positioning SRS in a PRS occasion) may be reported if phase continuity is maintained between the corresponding reference time (e.g., most recent) and time of reception of the UL positioning reference signal or positioning SRS.

In one example, the derivative of the phase difference (e.g., carrier phase of received UL PRS or positioning SRS in a PRS occasion) may be reported regardless of maintaining phase continuity between the corresponding reference time (e.g., most recent) and time of reception of the UL positioning reference signal or positioning SRS. In a further example, an indication may be included within the measurement report or in a separate message, that indicates whether or not phase continuity is maintained between the corresponding reference time (e.g., most recent) and time of reception of the UL positioning reference signal or positioning SRS corresponding to the phase difference (e.g., carrier phase of received DL PRS) measurement.

In one example, the derivative of the phase difference (e.g., carrier phase of received UL PRS or positioning SRS in a PRS occasion) may be reported if phase continuity is maintained between the UL positioning reference signal occasion corresponding to most recent (previous) phase difference (e.g., carrier phase of received UL PRS or positioning SRS) measurement and the UL positioning reference signal occasion corresponding to current phase difference (e.g., carrier phase of received UL PRS or positioning SRS) measurement.

In one example, the derivative of the phase difference (e.g., carrier phase of received UL PRS or positioning SRS in a PRS occasion) may be reported regardless of maintaining phase continuity between the UL positioning reference signal occasion corresponding to most recent (previous) phase difference (e.g., carrier phase of received UL PRS or positioning SRS) measurement and the UL positioning reference signal occasion corresponding to current phase difference (e.g., carrier phase of received UL PRS or positioning SRS) measurement. In a further example, an indication may be included within the measurement report or in a separate message, that indicates whether or not phase continuity is maintained between the UL positioning reference signal occasion corresponding to most recent (previous) phase difference (e.g., carrier phase of received UL PRS or positioning SRS) measurement and the UL positioning reference signal occasion corresponding to current phase difference (e.g., carrier phase of received UL PRS or positioning SRS) measurement.

In one example, the derivative of the phase difference (e.g., carrier phase of received UL PRS or positioning SRS in a PRS occasion) may be reported if phase continuity is maintained within the UL positioning reference signal occasion corresponding to current phase difference (e.g., carrier phase of received UL PRS or positioning SRS) measurement.

In one example, the derivative of the phase difference (e.g., carrier phase of received UL PRS or positioning SRS in a PRS occasion) may be reported whether or not phase continuity is maintained within the UL positioning reference signal occasion corresponding to current phase difference (e.g., carrier phase of received UL PRS or positioning SRS) measurement. In a further example, an indication; is included within the measurement report or in a separate message, that indicates whether or not phase continuity is maintained within the UL positioning reference signal occasion corresponding to current phase difference (e.g., carrier phase of received UL PRS or positioning SRS) measurement.

In a variant example, the gNB may report (e.g., to UE or to LMF) the phase difference of each sub-carrier of the UL positioning reference signal or positioning SRS.

In one example, the gNB may report (e.g., to UE or to LMF) the phase difference for each PRB of the UL positioning reference signal or positioning SRS. In one example, the phase may be reported for the middle sub-carrier of the PRB (or center of PRB). In one example, the phase may be reported for the first sub-carrier of the PRB. In one example, the phase may be reported for the last sub-carrier of the PRB. In one example, the phase difference may be reported as the average phase difference for all sub-carriers in the PRB at a frequency that is an average frequency for all sub-carriers in the PRB. In one example, the number of sub-carriers per PRB may be even (e.g., 12), the middle (center) sub-carrier may be one of:
The average of the two middle sub-carriers.
The sub-carrier with the higher frequency of the two middle sub-carriers.
The sub-carrier with the lower frequency of the two middle sub-carriers.

In one example, TRP/gNB may report the derivative of the phase difference (e.g., carrier phase of received UL PRS or positioning SRS in a PRS occasion) of the first (earliest) multi-path component (e.g., first detected multi-path component). In a further example, the TRP/gNB may report for the first (earliest) multi-path along with the carrier phase, the RSRPP or ratio between the power of the first (earliest) multi-path to the total power (or the power of the remaining multi-path).

In one example, a TRP/gNB may be provided a threshold, wherein the threshold may be specified in the system specifications and/or configured or updated by higher layer RRC signaling and/or MAC CE signaling and/or L1 control (e.g., DCI) signaling. gNB/TRP measures/reports the derivative of the phase difference (e.g., carrier phase of received UL PRS or positioning SRS in a PRS occasion) of the first (earliest) multi-path component (e.g., first detected multi-path component) if the RSRPP exceeds the threshold, or in an alternative example if the ratio between the power of the first (earliest) multi-path to the total power (or the power of the remaining multi-path) exceeds the threshold. In a further example, the TRP/gNB may report for the first (earliest) multi-path along with the derivative of the carrier phase, the RSRPP or ratio between the power of the first (earliest) multi-path to the total power (or the power of the remaining multi-path).

In one example, TRP/gNB may report the derivative of the phase difference (e.g., carrier phase of received UL PRS or positioning SRS in a PRS occasion) of each multi-path component (e.g., each detected multi-path component). In a further example, the TRP/gNB may report for each multi-path, along with the derivative of the carrier phase, the RSRPP and/or delay (e.g., relative to the first (earliest) multi-path) of the multi-path.

In one example, a TRP/gNB may be provided a threshold, wherein the threshold may be specified in the system specifications and/or configured or updated by higher layer RRC signaling and/or MAC CE signaling and/or L1 control (e.g., DCI) signaling. In one example, the threshold can be a relative threshold between power of a multi-path component to the total power. In one example, the threshold can be a relative threshold between power of a multi-path component to the power of the first (earliest) multi-path component. TRP/gNB reports the derivative of the phase difference (e.g., carrier phase of received UL PRS or positioning SRS in a PRS occasion) of each multi-path component with RSRPP that exceeds the threshold (e.g., each detected multi-path component with RSRPP that exceeds the threshold). In a further example, the TRP/gNB may report for each multi-path, along with the derivative of the carrier phase, the RSRPP and/or delay (e.g., relative to the first (earliest) multi-path) of the multi-path.

In one example, for the aforementioned examples, a PRS occasion may be one PRS or positioning SRS symbol.

In one example, for the aforementioned examples, a PRS occasion may be all PRS or positioning SRS symbols of a slot.

In one example, for the aforementioned examples, a PRS occasion may be a subset of PRS or positioning SRS symbols of a slot.

In one example, for the aforementioned examples, phase continuity between a reference phase for a symbol received at time Tₙ₁ and a reference phase for a symbol received at time Tₙ₂ may be maintained if the reference phase at symbol Tₙ₁, i.e., φ(Tₙ₁), and the phase at symbol Tₙ₂, i.e., φ(Tₙ₂) is related by φ(Tₙ₂)=φ(Tₙ₁)+2πf_{c}(Tₙ₂−Tₙ₁), wherein, f_{c} is the frequency of the carrier or sub-carrier. The phase shift through the RF circuitry or the front-end of the receiver is the same at Tₙ₁ and Tₙ₂, i.e., phase coherency is maintained through the RF circuitry or the front-end of the receiver for phase continuity. In one example, the phase reference may be the phase at the start of the symbol. In one example the phase reference may be the phase after the CP of the symbol. In one example, one or more of the following may lead to the phase reference continuity not being maintained:
A change in the RF chain.
A change in quasi-co-location.
A change in the reception spatial filter.
A time advance or time retard between symbols.
The phase lock loop getting out of sync or slipping.

In one example, the gNB may configure or be configured a delta offset between two frequencies (or two sub-carriers) for which the gNB uses to measure the carrier phase slope. In one example, the gNB may measure the carrier phase slope based on any (selection can be up to the gNB's implementation) or all sub-carriers in the UL PRS or SRS used for positioning (e.g., within the UL BWP) that satisfy the configured delta offset.

In one example, the gNB may determine a delta offset between two frequencies (or two sub-carriers) for which the gNB uses to measure the carrier phase slope. In one example, the gNB may measure the carrier phase slope based on any (selection can be up to the gNB's implementation) or all sub-carriers in the UL PRS or SRS used for positioning (e.g., within the UL BWP) that satisfy the determined delta offset. In one example, the gNB may report in the measurement report the selected delta offset.

In one example, the number of measurements between sub-carriers to determine the slope of the carrier phase may be configured. The selection of sub-carriers may be up to the gNB's implementation as long as N measurements of carrier phase difference for the slope are performed.

In one example, the number of sub-carriers to use to determine the slope of the carrier phase may be configured. The selection of sub-carriers may be up to gNB's implementation as long as N sub-carriers are selected.

In one example, a reliability metric may be configured for the carrier phase measurement (e.g., carrier phase slope), it is up the gNB's implementation to select enough sub-carries to satisfy the reliability metric.

In one example, the gNB may configure or be configured two (or more) frequencies (or two (or more) sub-carriers) for which the gNB uses to measure the carrier phase difference between. In one example, the difference in frequency between each two consecutive configured frequencies may be the same.

In one example, the gNB may report (e.g., to UE or to LMF) the delta, between two subcarriers of the phase difference between the reference signal and the corresponding received UL positioning reference signal or positioning SRS. Let the phase difference between the reference signal and the corresponding received UL positioning reference signal or positioning SRS at sub-carrier m be ϕₘ, and let the phase difference between the reference signal and the corresponding received UL positioning reference signal or positioning SRS at sub-carrier n be ϕₙ. The delta phase difference between subcarrier m and subcarrier n is ϕₘ−ϕₙ.

In one example, the phase may be unwrapped with respect to 2π, then delta phase difference is calculated.

In one example, m and n may be consecutive sub-carriers of the UL PRS or positioning SRS. For example, if the Comb size in N and the sub-carrier spacing is f_{sc}, wherein f_{sc}=2^{μ}·15 kHz, μ is the sub-carrier spacing configuration which can be 0, 1, 2, or 3, the difference in frequency between two consecutive sub-carriers is N·f_{sc}.

In one example, the delta of the phase difference may be reported for each consecutive (or in a variant example non-consecutive) pairs of m and n of the UL PRS or positioning SRS.

In one example, the average of the delta of the phase difference for each consecutive (or in a variant example non-consecutive) pairs of m and n of the UL PRS or positioning SRS may be reported.

In one example, the variance or standard deviation of the delta of the phase difference for each consecutive (or in a variant example non-consecutive) pairs of m and n of the UL PRS or positioning SRS may be additionally reported.

In one example, the delta of the phase difference may be reported if UL PRS or positioning SRS is detected and measured.

In one example, the delta of the phase difference may be reported if phase continuity is maintained between the corresponding reference time (e.g., most recent) and time of reception of the UL positioning reference signal or positioning SRS.

In one example, the delta of the phase difference may be reported regardless of maintaining phase continuity between the corresponding reference time (e.g., most recent) and time of reception of the UL positioning reference signal or positioning SRS.

In a variant example, the gNB may report (e.g., to UE or to LMF) the delta phase difference for each pair of consecutive (or in a variant example non-consecutive) PRBs of the UL positioning reference signal or positioning SRS. In one example, the delta phase may be reported based on the middle (center) sub-carriers of the consecutive (or in a variant example non-consecutive) PRBs. In one example, the delta phase may be reported based on the first sub-carrier of the consecutive (or in a variant example non-consecutive) PRBs. In one example, the delta phase may be reported based on the last sub-carrier of the consecutive (or in a variant example non-consecutive) PRBs. In one example, the delta of phase difference may be reported based on the average phase difference for all sub-carriers in the consecutive (or in a variant example non-consecutive) PRBs. In one example, the number of sub-carriers per PRB may be even (e.g., 12), the middle (center) sub-carrier may be one of:
The average of the two middle sub-carriers.
The sub-carrier with the higher frequency of the two middle sub-carriers.
The sub-carrier with the lower frequency of the two middle sub-carriers.

In a variant example, the gNB may report (e.g., to UE or to LMF) the average of the delta phase difference for each pair of consecutive (or in a variant example non-consecutive) PRBs of the UL positioning reference signal or positioning SRS. In one example, the average of the delta phase may be reported based on the middle (center) sub-carriers of the consecutive (or in a variant example non-consecutive) PRBs. In one example, the average of the delta phase may be reported based on the first sub-carrier of the consecutive (or in a variant example non-consecutive) PRBs. In one example, the average of the delta phase may be reported based on the last sub-carrier of the consecutive (or in a variant example non-consecutive) PRBs. In one example, the average of the delta of phase difference may be reported based on the average phase difference for all sub-carriers in the consecutive (or in a variant example non-consecutive) PRBs. In one example, the number of sub-carriers per PRB may be even (e.g., 12), the middle (center) sub-carrier may be one of:
The average of the two middle sub-carriers.
The sub-carrier with the higher frequency of the two middle sub-carriers.
The sub-carrier with the lower frequency of the two middle sub-carriers.

In a variant example, the gNB may additionally report (e.g., to UE or to LMF) the variance or the standard deviation of the delta phase difference for each pair of consecutive (or in a variant example non-consecutive) PRBs of the UL positioning reference signal or positioning SRS. In one example, the variance or the standard deviation of the delta phase may be reported based on the middle (center) sub-carriers of the consecutive (or in a variant example non-consecutive) PRBs. In one example, the variance or the standard deviation of the delta phase may be reported based on the first sub-carrier of the consecutive (or in a variant example non-consecutive) PRBs. In one example, the variance or the standard deviation of the delta phase may be reported based on the last sub-carrier of the consecutive (or in a variant example non-consecutive) PRBs. In one example, the variance or the standard deviation of the delta of phase difference may be reported based on the average phase difference for all sub-carriers in the consecutive (or in a variant example non-consecutive) PRBs. In one example, the number of sub-carriers per PRB may be even (e.g., 12), the middle (center) sub-carrier may be one of:
The average of the two middle sub-carriers.
The sub-carrier with the higher frequency of the two middle sub-carriers.
The sub-carrier with the lower frequency of the two middle sub-carriers.

In one example, the gNB may configure or be configured a delta offset between two frequencies (or two sub-carriers) for which the gNB measures the carrier phase difference between. In one example, the configured delta offset is in units of frequency (e.g., Hz or kHz or MHz). In one example, the configured delta offset is in number of sub-carriers. In one example, the configured delta offset is in number of sub-carriers multiplied by comb-size. In one example, the configured delta offset is in number of PRBs. In one example, the gNB may measure the carrier phase difference between any (selection can be up to the gNB's implementation) or all sub-carriers in the UL PRS or SRS used for positioning (e.g., within the UL BWP) that satisfy the configured delta offset. In one example, the gNB may determine and report an average carrier phase difference based on the measured carrier phase differences.

In one example, the gNB determines or is configured, as aforementioned or is specified in the specifications, a delta offset between two frequencies (or two sub-carriers) for which the gNB measures the carrier phase difference between. In one example, the gNB may measure the carrier phase difference between any (selection can be up to the gNB's implementation) or all sub-carriers in the UL PRS or SRS used for positioning (e.g., within the UL BWP) that satisfy the determined delta offset. In one example, the gNB may report in the measurement report the selected delta offset. In one example, the gNB may determine and report an average carrier phase difference based on the measured carrier phase differences.

In one example, the number of measurements between sub-carriers to determine the carrier phase difference may be configured. The selection of sub-carriers may be up to gNB's implementation as long as N measurements of carrier phase difference are performed.

In one example, the number of sub-carriers to use to determine the carrier phase difference may be configured. The selection of sub-carriers may be up to gNB's implementation as long as N sub-carriers are selected.

In one example, a reliability metric may be configured for the carrier phase measurement (e.g., carrier phase difference), it is up the gNB's implementation to select enough sub-carries to satisfy the reliability metric.

In one example, the gNB may configure or be configured two (or more) frequencies (or two (or more) sub-carriers) for which the gNB measures the carrier phase difference between. In one example, if the gNB is configured with multiple frequencies, and the difference between each two adjacent frequencies is the same, the gNB may determine and report an average carrier phase difference based on the measured carrier phase differences between the multiple configured frequencies.

In one example, the gNB may report (e.g., to UE or to LMF) the delta phase, between two subcarriers of the received UL positioning reference signal or positioning SRS. Let the phase of the received UL positioning reference signal or positioning SRS at sub-carrier m be ϕₘ, and let the phase of the received UL positioning reference signal or positioning SRS at sub-carrier n be ϕₙ. The delta phase between subcarrier m and subcarrier n is ϕₘ−ϕₙ.

In one example, the phase may be unwrapped with respect to 2π, then delta phase is calculated.

In one example, m and n may be consecutive sub-carriers of the UL PRS or positioning SRS. For example, if the Comb size in N and the sub-carrier spacing is f_{sc}, wherein f_{sc}=2^{μ}·15 kHz, μ is the sub-carrier spacing configuration which can be 0, 1, 2, or 3, the difference in frequency between two consecutive sub-carriers is N·f_{sc}.

In one example, the delta of the phase may be reported for each consecutive (or in a variant example non-consecutive) pairs of m and n of the UL PRS or positioning SRS.

In one example, the average of the delta of the phase for each consecutive (or in a variant example non-consecutive) pairs of m and n of the UL PRS or positioning SRS may be reported.

In one example, the variance or standard deviation of the delta of the phase for each consecutive (or in a variant example non-consecutive) pairs of m and n of the UL PRS or positioning SRS may be additionally reported.

In one example, the delta of the phase may be reported if UL PRS or positioning SRS is detected and measured.

In one example, the delta of the phase may be reported if phase continuity is maintained between the corresponding reference time (e.g., most recent) and time of reception of the UL positioning reference signal or positioning SRS.

In one example, the delta of the phase may be reported regardless of maintaining phase continuity between the corresponding reference time (e.g., most recent) and time of reception of the UL positioning reference signal or positioning SRS.

In a variant example, the gNB may report (e.g., to UE or to LMF) the delta phase for each pair of consecutive (or in a variant example non-consecutive) PRBs of the UL positioning reference signal or positioning SRS. In one example, the delta phase may be reported based on the middle (center) sub-carriers of the consecutive (or in a variant example non-consecutive) PRBs. In one example, the delta phase may be reported based on the first sub-carrier of the consecutive (or in a variant example non-consecutive) PRBs. In one example, the delta phase may be reported based on the last sub-carrier of the consecutive (or in a variant example non-consecutive) PRBs. In one example, the delta of phase may be reported based on the average phase for all sub-carriers in the consecutive (or in a variant example non-consecutive) PRBs. In one example, the number of sub-carriers per PRB may be even (e.g., 12), the middle (center) sub-carrier may be one of:
The average of the two middle sub-carriers.
The sub-carrier with the higher frequency of the two middle sub-carriers.
The sub-carrier with the lower frequency of the two middle sub-carriers.

In a variant example, the gNB may report (e.g., to UE or to LMF) the average of the delta phase for each pair of consecutive (or in a variant example non-consecutive) PRBs of the UL positioning reference signal or positioning SRS. In one example, the average of the delta phase may be reported based on the middle (center) sub-carriers of the consecutive (or in a variant example non-consecutive) PRBs. In one example, the average of the delta phase may be reported based on the first sub-carrier of the consecutive (or in a variant example non-consecutive) PRBs. In one example, the average of the delta phase may be reported based on the last sub-carrier of the consecutive (or in a variant example non-consecutive) PRBs. In one example, the average of the delta of phase may be reported based on the average phase for all sub-carriers in the consecutive (or in a variant example non-consecutive) PRBs. In one example, the number of sub-carriers per PRB may be even (e.g., 12), the middle (center) sub-carrier may be one of:
The average of the two middle sub-carriers.
The sub-carrier with the higher frequency of the two middle sub-carriers.
The sub-carrier with the lower frequency of the two middle sub-carriers.

In a variant example, the gNB may additionally report (e.g., to UE or to LMF) the variance or the standard deviation of the delta phase for each pair of consecutive (or in a variant example non-consecutive) PRBs of the UL positioning reference signal or positioning SRS. In one example, the variance or the standard deviation of the delta phase may be reported based on the middle (center) sub-carriers of the consecutive (or in a variant example non-consecutive) PRBs. In one example, the variance or the standard deviation of the delta phase may be reported based on the first sub-carrier of the consecutive (or in a variant example non-consecutive) PRBs. In one example, the variance or the standard deviation of the delta phase may be reported based on the last sub-carrier of the consecutive (or in a variant example non-consecutive) PRBs. In one example, the variance or the standard deviation of the delta of phase may be reported based on the average phase for all sub-carriers in the consecutive (or in a variant example non-consecutive) PRBs. In one example, the number of sub-carriers per PRB may be even (e.g., 12), the middle (center) sub-carrier may be one of:
The average of the two middle sub-carriers.
The sub-carrier with the higher frequency of the two middle sub-carriers.
The sub-carrier with the lower frequency of the two middle sub-carriers.

In one example, the gNB may configure or be configured a delta offset between two frequencies (or two sub-carriers) for which the gNB measures the carrier phase difference between. In one example, the configured delta offset is in units of frequency (e.g., Hz or kHz or MHz). In one example, the configured delta offset is in number of sub-carriers. In one example, the configured delta offset is in number of sub-carriers multiplied by comb-size. In one example, the configured delta offset is in number of PRBs. In one example, the gNB may measure the carrier phase difference between any (selection can be up to the gNB's implementation) or all sub-carriers in the UL PRS or SRS used for positioning (e.g., within the UL BWP) that satisfy the configured delta offset. In one example, the gNB may determine and report an average carrier phase difference based on the measured carrier phase differences.

In one example, the gNB determines or is configured, as aforementioned or is specified in the specifications a delta offset between two frequencies (or two sub-carriers) for which the gNB measures the carrier phase difference between. In one example, the gNB may measure the carrier phase difference between any (selection can be up to the gNB's implementation) or all sub-carriers in the UL PRS or SRS used for positioning (e.g., within the UL BWP) that satisfy the determined delta offset. In one example, the gNB may report in the measurement report the selected delta offset. In one example, the gNB may determine and report an average carrier phase difference based on the measured carrier phase differences.

In one example, the number of measurements between sub-carriers to determine the carrier phase difference may be configured. The selection of sub-carriers may be up to gNB's implementation as long as N measurements of carrier phase difference are performed.

In one example, the number of sub-carriers to use to determine the carrier phase difference may be configured. The selection of sub-carriers may be up to gNB's implementation as long as N sub-carriers are selected.

In one example, a reliability metric may be configured for the carrier phase measurement (e.g., carrier phase difference), it may be up to the gNB's implementation to select enough sub-carries to satisfy the reliability metric.

In one example, the gNB may configure or be configured two (or more) frequencies (or two (or more) sub-carriers) for which the gNB measures the carrier phase difference between. In one example, if the gNB is configured with multiple frequencies, and the difference between each two adjacent frequencies is the same, the gNB may determine and report an average carrier phase difference based on the measured carrier phase differences between the multiple configured frequencies.

In one example, the gNB may report (e.g., to UE or to LMF) a measurement based on the carrier phase difference between a first received UL positioning reference signal or positioning SRS of a first UE and a second received UL positioning reference signal or positioning SRS of a second UE. In one example, one of the first UE or the second UE may be a positioning reference unit (PRU), wherein the PRU may have a known location. For example, the reported quantity may be derivative of the corresponding carrier phase difference or the delta phase between two sub-carriers of the carrier phase difference. The aforementioned examples may apply to this case.

In one example, one or more of the measurements or configurations previously described with respect to DL positioning reference signal for Carrier-phase method and UL positioning reference signal for Carrier-phase method may be received by a UE and/or gNB and/or LMF. The UE and/or gNB and/or LMF may use the derivative of the phase difference measurement with respect to frequency of DL PRS and UL PRS or positioning SRS to determine the propagation delay as given by equations (23a) or (24a) or (25a) or (26a) or (27a).

In one example, the UE and/or gNB and/or LMF may use the delta (or average of the delta) of the phase difference measurement between two consecutive (or in a variant example non-consecutive) sub-carriers of DL PRS and UL PRS or positioning SRS to determine the propagation delay. For example, if the Comb size in N and the sub-carrier spacing is f_{sc}, wherein f_{sc}=2^{μ}·15 kHz, μ is the sub-carrier spacing configuration which may be 0, 1, 2, or 3, the difference in frequency between two consecutive sub-carriers is N·f_{sc}. The derivative of the phase difference measurement with respect to frequency of DL PRS and UL PRS or positioning SRS may be calculated (dividing the average of the delta of the phase difference of consecutive (or in a variant example non-consecutive) sub-carriers by the frequency between consecutive (or in a variant example non-consecutive) sub-carriers), the propagation delay can then be calculated based on equations (23a) or (24a) or (25a) or (26a) or (27a).

In one example, the UE and/or gNB and/or LMF may use the delta (or average of the delta) of the phase measurement between two consecutive (or in a variant example non-consecutive) sub-carriers of DL PRS and UL PRS or positioning SRS to determine the propagation delay. For example, if the Comb size in N and the sub-carrier spacing is f_{sc}, wherein f_{sc}=2^{μ}·15 kHz, μ is the sub-carrier spacing configuration which can be 0, 1, 2, or 3, the difference in frequency between two consecutive sub-carriers is N·f_{sc}. The derivative of the phase measurement with respect to frequency of DL PRS and UL PRS or positioning SRS can be calculated (dividing the average of the delta of the phase of consecutive (or in a variant example non-consecutive) sub-carriers by the frequency between consecutive (or in a variant example non-consecutive) sub-carriers), the propagation delay can then be calculated based on equations (23a) or (24a) or (25a) or (26a) or (27a).

By multiplying the propagation delay by the speed of light, the distance between the gNB and the UE may be determined.

In one example, the derivative of the phase difference measurement with respect to frequency of DL PRS and UL PRS or positioning SRS may be used if phase continuity is maintained between DL PRS and corresponding UL PRS or positioning SRS in the gNB and the UE.

In one example, the derivative of the phase difference measurement with respect to frequency of DL PRS and UL PRS or positioning SRS may be used if phase continuity is maintained between reference time and corresponding DL PRS and corresponding UL PRS or positioning SRS in the gNB and the UE.

In one example, a TRP/gNB may report to the LMF or UE when or if DL carrier phase continuity for DL PRS has not been maintained following the examples of this disclosure. A TRP/gNB may report to the LMF or UE when or if DL carrier phase continuity for DL PRS has been maintained following the examples of this disclosure.

In one example, a TRP/gNB may report to the LMF or UE a measurement report that includes UL carrier phase measurement. In one example, the measurement report may be a standalone measurement report for carrier phase measurement. In one example, the measurement report may be included with other positioning measurements (e.g., relative time of arrival (RTOA) or gNB Rx−Tx time difference or angle of arrival measurements or UL SRS-RSRP or UL SRS-RSRPP). The measurement report may include one or more of the following:
Reference signal ID used to measure the carrier phase (e.g., positioning SRS resource ID and/or positioning SRS resource set ID). If the carrier phase difference is the difference between the carrier phase of a first UL PRS or positioning SRS from a first UE and a second UL PRS or positioning SRS from a second UE, the measurement report may include a first reference signal ID for the first UE (e.g., first positioning SRS resource ID and/or first positioning SRS resource set ID) and a second reference signal ID for the second UE (e.g., second positioning SRS resource ID and/or second positioning SRS resource set ID). In one example, a TRP/gNB may configure or be configured the UL PRS or positioning SRS resource to use for carrier phase or carrier phase difference measurement. In another example, a TRP/gNB may select the UL PRS or positioning SRS resource to use for carrier phase or carrier phase difference measurement. For example, the selection may be based on LOS conditions, selecting the UL PRS or positioning SRS resource with the best LOS condition (strongest relative power of first (earliest) multi-path or strongest multi-path, or largest RSRPP of first (earliest) multi-path or strongest multi-path). In another example, the selection may be based on RSRP of UL PRS or positioning SRS. In another example, the selection may be based on RSRPP of first (earliest) multi-path or strongest multi-path of UL PRS or positioning SRS. In another example, the selection may be based on RSRP of LOS component of UL PRS or positioning SRS. In another example, the selection may be based on one or more of the previously mentioned examples.
The frequency or frequency index used for measuring and calculating the carrier phase. In one example, the gNB/TRB provides carrier phase measurements for multiple carriers or sub-carriers and provides frequency or frequency index in the measurement report for each reported carrier respectively.
In one example the carrier phase measurement or carrier phase derivative measurement is for multiple frequencies. The number of frequencies for which the carrier phase measurement is reported is configured. In one example, the TRP/gNB determines the frequencies. In one example, the frequencies are evenly spread through the frequency allocation (e.g., BW) of the UL PRS or SRS for positioning. In one example, the frequency or frequency index is not included in the measurement report but is determined implicitly (e.g., evenly spread through the frequency allocation (e.g., BW) of the UL PRS or SRS for positioning).
The antenna port or receive antenna or receive RF chain or antenna connector or ARP of the signal used for carrier phase measurement. The impact of the antenna port or receive antenna or receive RF chain or antenna connector or ARP on the carrier phase measurement is later described in this disclosure. In one example, gNB/TRP may report the antenna reference point (position) ARP for the antenna port or antenna connector, or antenna or receive RF chain used for the carrier phase measurement.
A time stamp. Wherein the time stamp can include a frame number/ID/index and/or a subframe number/ID/index and/or a slot number/ID/index and/or symbol number/ID/index and/or an UL PRS or positioning SRS occasion number/ID/index.
The carrier phase measurement as described herein in this disclosure. For example, reporting based on the carrier phase of UL PRS or positioning SRS of a single UE. This may, for example, be relative to the reference phase of the TRP/gNB. In another example, reporting may be based on the carrier phase difference of UL PRS or positioning SRS of a first UE and a second UE.
The derivative of the carrier phase or derivative of the carrier phase difference may be reported for one sub-carrier or a group of sub-carriers or all sub-carriers of the UL PRS or positioning SRS allocation, or for one PRB or a group of PRBs or all PRBs of the UL PRS or positioning SRS allocation. The delta between two sub-carriers of the carrier phase or delta between two sub-carriers of the carrier phase difference may be reported for one sub-carrier pair or a group of sub-carrier pairs or all sub-carrier pairs of the UL PRS or positioning SRS allocation, or for one PRB pair or a group of PRB pairs or all PRB pairs of the UL PRS or positioning SRS allocation.
In one example, the one carrier phase or carrier phase difference or derivative of the carrier phase or derivative of the carrier phase difference is reported for one UL PRS or positioning SRS symbol. For example, the first UL PRS or positioning SRS symbol of a slot or any UL PRS or positioning SRS symbol, and the symbol index is reported. In one example, the symbol index is in the time stamp.
In one example, multiple carrier phase or carrier phase difference or multiple derivative of the carrier phase or multiple derivative of the carrier phase difference are reported for multiple UL PRS or positioning SRS symbols. For example, all UL PRS or positioning SRS symbol of a slot or a subset of UL PRS or positioning SRS symbols. In one example, the symbol indices are included in the report. In another example, the symbol indices to be reported are configured or pre-determined.
In one example, one carrier phase is reported or carrier phase difference or one derivative of the carrier phase or one derivative of the carrier phase difference is reported based on the combining of carrier phase or carrier phase difference or derivative of the carrier phase or derivative of the carrier phase difference, respectively, of multiple UL PRS or positioning SRS symbols. In one example, there is no reporting of symbol index used to get the carrier phase or carrier phase difference or derivative of the carrier phase or derivative of the carrier phase difference, just the slot index is reported. In one example, all UL PRS or positioning SRS symbols of a slot or a subset of UL PRS or positioning SRS symbols are used to determine the carrier phase or carrier phase difference or derivative of the carrier phase or derivative of the carrier phase difference, respectively. In one example, the symbol indices are included in the report. In another example, the symbol indices to be used for the measurement reporting are configured or pre-determined.
A quality indicator. This may be hard decision (e.g., 1-bit with 0 signaling low/bad quality and 1 signaling high/good quality, or vice versa 1 signaling low/bad quality and 0 signaling high/good quality), or a soft decision with n-bits. In one example the quality indicator may be based on LOS/NLOS indicator. In another example the quality indicator may be based on the RSRPP of the first (earliest) multi-path or of the strongest multi-path, or the ratio between the power (e.g., RSRPP) of the first (earliest) multi-path or the strongest multi-path and the total power (or the power of the remaining (earliest) multi-path).
A phase continuity indicator as described in this disclosure. The phase continuity is from a reference time to the time of the UL PRS or positioning SRS being measured. In one example, the reference time can be a time determined by or configured in the TRP/gNB. In another example, the reference time can be a time of pervious UL PRS or positioning SRS reception of a pervious measurement. In another example, the reference time can be a time of pervious DL PRS transmission.

In one example, a TRP/gNB transmitting a downlink positioning reference signal (DL PRS), can report the antenna port or transmit antenna or transmit RF chain or antenna connector or ARP of the DL PRS, e.g., used for carrier phase measurement or carrier phase derivative measurement. The impact of the antenna port or transmit antenna or transmit RF chain or antenna connector on the carrier phase measurement or ARP is later described in this disclosure. In one example, gNB/TRP reports the antenna reference point (position) (ARP) for the antenna port or antenna connector or antenna or transmit RF chain of the DL PRS, e.g., used for the carrier phase measurement.

In one example, a UE may report to the LMF or TRP/gNB when or if UL carrier phase continuity for UL PRS or positioning SRS has not been maintained following the examples of this disclosure. A UE may report to the LMF or TRP/gNB when or if UL carrier phase continuity for UL PRS or positioning SRS has been maintained following the examples of this disclosure.

In one example, a UE may report to the LMF or TRP/gNB a measurement report that includes DL carrier phase measurement. In one example, the measurement report may be a standalone measurement report for carrier phase measurement. In one example, the measurement report may be included with other positioning measurements (e.g., DL reference signal time difference (RSTD) or UE Rx−Tx time difference or DL PRS-RSRP or DL PRS RSRPP). The measurement report may include one or more of the following:
Reference signal ID used to measure the carrier phase (e.g., DL PRS resource ID and/or DL PRS resource set ID and/or DL PRS ID). If the carrier phase difference is the difference between the carrier phase of a first DL PRS from a first TRP/gNB and a second UL PRS or positioning SRS from a second TRP/gNB, the measurement report may include a first reference signal ID for the first TRP/gNB (e.g., first DL PRS resource ID and/or first DL PRS resource set ID and/or first DL PRS ID) and a second reference signal ID for the second TRP/gNB (e.g., second DL PRS resource ID and/or second DL PRS resource set ID and/or second DL PRS ID). In one example, a UE may be configured the DL PRS resource to use for carrier phase or carrier phase difference measurement. In another example, a UE may select the DL PRS resource to use for carrier phase or carrier phase difference measurement. For example, the selection can be based on LOS conditions, selecting the DL PRS resource with the best LOS condition (strongest relative power of first (earliest) multi-path or strongest multi-path, or largest RSRPP of first (earliest) multi-path or strongest multi-path). In another example, the selection may be based on RSRP of DL PRS. In another example, the selection can be based on RSRPP of first (earliest) multi-path or strongest multi-path of DL PRS. In another example, the selection can be based on RSRP of LOS component of DL PRS. In another example, the selection can be based on one or more of the previously mentioned examples.
The frequency or frequency index used for measuring and calculating the carrier phase. In one example, the UE may provide carrier phase measurements for multiple carriers or sub-carriers and provides frequency or frequency index in the measurement report for each reported carrier respectively.
In one example the carrier phase measurement or carrier phase derivative measurement is for multiple frequencies. The number of frequencies for which the carrier phase measurement is reported is configured. In one example, the UE determines the frequencies. In one example, the frequencies are evenly spread through the frequency allocation (e.g., BW) of the DL PRS or DL PFL. In one example, the frequency or frequency index is not included in the measurement report but is determined implicitly (e.g., evenly spread through the frequency allocation (e.g., BW) of the DL PRS or DL PFL).
The antenna port or receive antenna or receive RF chain or antenna connector or ARP of the signal used for carrier phase measurement. The impact of the antenna port or receive antenna or receive RF chain or antenna connector or ARP on the carrier phase measurement is later described in this disclosure. In one example, UE may report the antenna reference point (position) (ARP) for the antenna port or antenna connector, or antenna or receive RF chain used for the carrier phase measurement.
A time stamp. Wherein the time stamp may include a frame number/ID/index and/or a subframe number/ID/index and/or a slot number/ID/index and/or symbol number/ID/index and/or an UL PRS or positioning SRS occasion number/ID/index.
The carrier phase measurement as described herein in this disclosure. For example, reporting may be based on the carrier phase of DL PRS of a single TRP/gNB. This may be, for example, relative to the reference phase of the UE. In another example, reporting may be based on the carrier phase difference of DL PRS of a first TRP/gNB and a second TRP/gNB.
The derivative of the carrier phase or derivative of the carrier phase difference may be reported for one sub-carrier or a group of sub-carriers or all sub-carriers of the DL PRS, or for one PRB or a group of PRBs or all PRBs of the DL PRS. The delta between two sub-carriers of the carrier phase or delta between two sub-carriers of the carrier phase difference may be reported for one sub-carrier pair or a group of sub-carrier pairs or all sub-carrier pairs of the DL PRS, or for one PRB pair or a group of PRB pairs or all PRB pairs of the DL PRS.
In one example, the one carrier phase or carrier phase difference or one derivative of the carrier phase or one derivative of the carrier phase difference is reported for one DL PRS symbol. For example, the first DL PRS symbol of a slot or any DL PRS symbol, and the symbol index is reported. In one example, the symbol index is in the time stamp.
In one example, multiple carrier phase or carrier phase difference or multiple derivative of the carrier phase or multiple derivative of the carrier phase difference are reported for multiple DL PRS symbols. For example, all DL PRS symbol of a slot or a subset of DL PRS symbols. In one example, the symbol indices are included in the report. In another example, the symbol indices to be reported are configured or pre-determined.
In one example, one carrier phase is reported or carrier phase difference or one derivative of the carrier phase or one derivative of the carrier phase difference is reported based on the combining of carrier phase or carrier phase difference or derivative of the carrier phase or derivative of the carrier phase difference, respectively, of multiple DL PRS symbols. In one example, there is no reporting of symbol index used to get the carrier phase or carrier phase difference or derivative of the carrier phase or derivative of the carrier phase difference, just the slot index is reported. In one example, all DL PRS symbols of a slot or a subset of DL PRS symbols are used to determine the carrier phase or carrier phase difference or derivative of the carrier phase or derivative of the carrier phase difference, respectively. In one example, the symbol indices are included in the report. In another example, the symbol indices to be used for the measurement reporting are configured or pre-determined.
A quality indicator. This may be hard decision (e.g., 1-bit with 0 signaling low/bad quality and 1 signaling high/good quality, or vice versa 1 signaling low/bad quality and 0 signaling high/good quality), or a soft decision with n-bits. In one example the quality indicator may be based on LOS/NLOS indicator. In another example the quality indicator may be based on the RSRPP of the first (earliest) multi-path or of the strongest multi-path, or the ratio between the power (e.g., RSRPP) of the first (earliest) multi-path or the strongest multi-path and the total power (or the power of the remaining multi-path).
A phase continuity indicator as described in this disclosure. The phase continuity may be from a reference time to the time of the DL PRS being measured. In one example, the reference time may be a time determined by or configured in the UE. In another example, the reference time can be a time of pervious DL PRS reception of a pervious measurement. In another example, the reference time may be a time of pervious UL PRS or positioning SRS transmission.

In one example, a UE transmitting an uplink positioning reference signal (e.g., SRS for positioning), can report the antenna port or transmit antenna or transmit RF chain or antenna connector or ARP of the SRS for positioning, e.g., used for carrier phase measurement or carrier phase derivative measurement. The impact of the antenna port or transmit antenna or transmit RF chain or antenna connector or ARP on the carrier phase measurement is later described in this disclosure. In one example, UE reports the antenna reference point (position) (ARP) for the antenna port or antenna connector or antenna or transmit RF chain of the SRS for positioning, e.g., used for the carrier phase measurement.

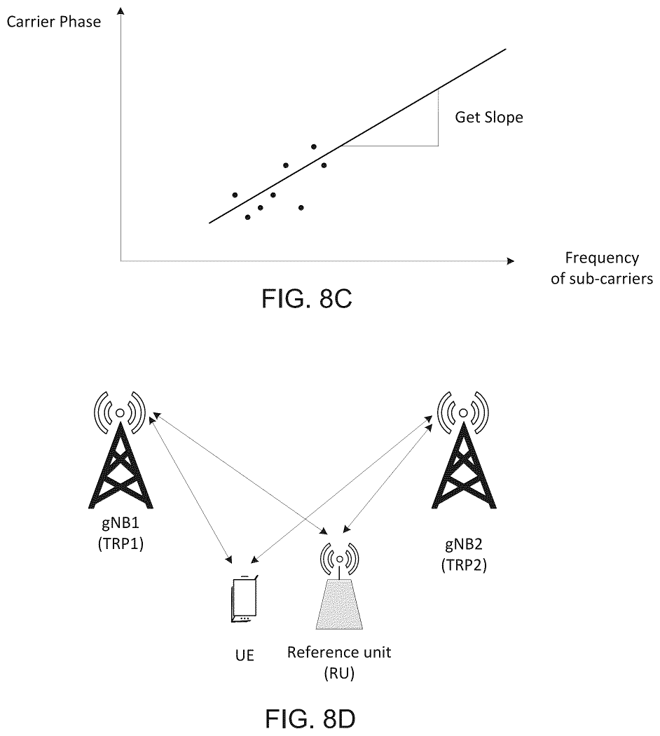

The carrier phase measurement depends on the antenna or antenna port or antenna connector or RF chain or ARP used for the carrier phase measurement. Consider a two-element antenna array as shown in FIG. 9.

FIG. 9 illustrates an example two element antenna array according to embodiments of the present disclosure. The embodiment of the antenna array in FIG. 9 is for illustration only. Other embodiments of an antenna array could be used without departing from the scope of this disclosure.

In the example of FIG. 9, if the signal at Ant0 is A cos(w(t−τ)), with a phase−wτ, the signal at Ant1 is

$$A cos ( w ( t - τ ) - \frac{2 π d sin θ}{λ} ) ,$$

with a

$$phase - w τ - \frac{2 π d sin θ}{λ} .$$

The phase depends on the antenna element used for the carrier phase measurement. The device (UE or gNB/TRP) may use one of the antenna elements to measure the phase, this would correspond to the carrier phase measurement at that antenna element and hence positioning based on that antenna element. Alternatively, if the signal is combined across the antenna elements of the array, the combined signal (in complex form) is

$${AW}_{0} exp j ( w ( t - τ ) ) + {AW}_{1} exp j ( w ( t - τ ) - \frac{2 π d sin θ}{λ} )$$

Where W₀ is the weight for Ant0, and W₁ is the weight for Ant1. It can be shown that the combined signal can be A_{c} exp j(w(t−τ)−α_{c}), where A_{c} is the amplitude of the combined signal, which depends on A, W₀, W₁, d/Δ and θ. α_{c} is the phase of the combined signal which depends on W₀, W₁, d/λ and θ. α_{c} is related to antenna reference point (ARP) of the antenna area. Hence, the calculated carrier phase at an antenna port of antenna array reflects the phase of the antenna reference point (ARP).

In one example, for DL reference signal carrier phase (DL RSCP), the reference point can be defined as (same as the reference point of RSTD):
In FR1: The antenna connector of the UE.
In FR2: The antenna of the UE.

In one example, for UL reference signal carrier phase (UL RSCP), the reference point can be defined as (same as the reference point of RTOA):
Type 1-C base station: The Rx antenna connector
Type 1-O or 2-O base station: The Rx antenna (i.e., the center location of the radiating region of the Rx antenna)
Type 1-H base station: The Rx Transceiver Array Boundary connector.

The device (e.g., UE or gNB/TRP) measuring the carrier phase may configure or be configured with the antenna port or antenna connector or receive antenna or receive RF chain or ARP to measure the carrier phase on. Alternatively, the device may determine the antenna port or antenna connector or receive antenna or receive RF chain or ARP based on its own implementation. In one example, the device may report the antenna port or antenna connector or receive antenna or receive RF chain or ARP used for the carrier phase measurement.

The device (e.g., UE or gNB/TRP) transmitting a PRS (e.g., DL PRS or UL-PRS or SRS for positioning), may configure or be configured the antenna port or antenna connector or transmit antenna or transmit RF chain or ARP to use for the PRS. Alternatively, the device may determine the antenna port or antenna connector or transmit antenna or transmit RF chain or ARP based on its own implementation. In one example, the device may report the antenna port or antenna connector or transmit antenna or transmit RF chain or ARP used for PRS transmission.

In one example, if a TRP is configured to transmit a first DL PRS, and a second DL PRS, the TRP can be configured to use the same antenna port or the same antenna connector or the same transmit antenna or the same transmit RF chain or the same ARP to transmit the first DL PRS and the second DL PRS. In one example, TRP is configured the antenna port or antenna connector or transmit antenna or transmit RF chain or ARP to use for the first DL PRS and the second DL PRS. In one example, it is up to the TRP to determine the antenna port or antenna connector or transmit antenna or transmit RF chain to use for the first DL PRS and the second DL PRS. In one example, if a TRP is configured to transmit a first DL PRS, and a second DL PRS, the TRP can be configured to use antenna ports or antenna connectors or transmit antennas or transmit RF chains or ARPs to transmit the first DL PRS and the second DL PRS that are synchronized to the same clock or source.

In one example, if a TRP is configured to receive a first UL PRS or SRS used for positioning, and a second UL PRS or SRS used for positioning, the TRP can be configured to use the same antenna port or the same antenna connector or the same receive antenna or the same receive RF chain or the same ARP to receive the first UL PRS or SRS used for positioning and the second UL PRS or SRS used for positioning. In one example, TRP is configured the antenna port or antenna connector or receive antenna or receive RF chain or ARP to use for the first UL PRS or SRS used for positioning and the second UL PRS or SRS used for positioning. In one example, it is up to the TRP to determine the antenna port or antenna connector or receive antenna or receive RF chain or ARP to use for the first UL PRS or SRS used for positioning and the second UL PRS or SRS used for positioning. In one example, if a TRP is configured to receive a first UL PRS or SRS used for positioning, and a second UL PRS or SRS used for positioning, the TRP can be configured to use antenna ports or antenna connectors or receive antennas or receive RF chains or ARPs to receive the first UL PRS or SRS used for positioning and the second UL PRS or SRS used for positioning that are synchronized to the same clock or source.

In one example, if a UE is configured to transmit a first UL PRS or SRS used for positioning, and a second UL PRS or SRS used for positioning, the UE can be configured to use the same antenna port or the same antenna connector or the same transmit antenna or the same transmit RF chain or the same ARP to transmit the first UL PRS or SRS used for positioning and the second UL PRS or SRS used for positioning. In one example, UE is configured the antenna port or antenna connector or transmit antenna or transmit RF chain or ARP to use for the first UL PRS or SRS used for positioning and the second UL PRS or SRS used for positioning. In one example, it is up to the UE to determine the antenna port or antenna connector or transmit antenna or transmit RF chain or ARP to use for the first UL PRS or SRS used for positioning and the second UL PRS or SRS used for positioning. In one example, if a UE is configured to transmit a first UL PRS or SRS used for positioning, and a second UL PRS or SRS used for positioning, the UE can be configured to use antenna ports or antenna connectors or transmit antennas or transmit RF chains or ARPs to transmit the first UL PRS or SRS used for positioning and the second UL PRS or SRS used for positioning that are synchronized to the same clock or source.

In one example, if a UE is configured to receive a first DL PRS, and a second DL PRS, the UE can be configured to use the same antenna port or the same antenna connector or the same receive antenna or the same receive RF chain or the same ARP to receive the first DL PRS and the second DL PRS. In one example, UE is configured the antenna port or antenna connector or receive antenna or receive RF chain or ARP to use for the first DL PRS and the second DL PRS. In one example, it is up to the UE to determine the antenna port or antenna connector or receive antenna or receive RF chain or ARP to use for DL PRS and the second DL PRS. In one example, if a UE is configured to receive a first DL PRS, and a second DL PRS, the UE can be configured to use antenna ports or antenna connectors or receive antennas or receive RF chains or ARPs to receive the first DL PRS and the second DL PRS that are synchronized to the same clock or source.

Although FIG. 9 illustrates one example of an antenna array, various changes may be made to FIG. 9. For example, the number of antennas in the array may change, etc.

In one example, the DL positioning reference signal (e.g., DL PRS) in this disclosure may be a reference signal designed for the carrier-phase method.

In one example, the DL positioning reference signal (e.g., DL PRS) in this disclosure may be a reference signal introduced in the Rel-16 and Rel-17 3GPP specifications for positioning.

In one example, the UL positioning reference signal (e.g., Positioning Sounding Reference Signal—Pos-SRS) in this disclosure may be a reference signal designed for the carrier-phase method.

In one example, the UL positioning reference signal (e.g., Positioning Sounding Reference Signal—Pos-SRS) in this disclosure may be a reference signal introduced in the Rel-16 and Rel-17 3GPP specifications for positioning.

The propagation delay between the gNB and UE may be expressed as:

Tₚ=N·T_{c}+T_{f}
Where,
T_{c} is the period of the carrier,

$${T}_{c} = \frac{1}{{f}_{c}} \cdot {f}_{c}$$

is the frequency of the carrier.
T_{f} corresponds to a time of a partial cycle T_{f}<T_{c}.

The carrier phase in this case is given by:

$$φ = ( 2 π {f}_{c} {T}_{p} ) mod 2 π = ( 2 π {f}_{c} \frac{d}{c} ) mod 2 π$$

$$φ = 2 π {f}_{c} {T}_{p} - 2 π N = 2 π {f}_{c} \frac{d}{c} - 2 π N$$

N is the integer ambiguity, where, N=0, ±1, ±2, . . .

The carrier phase method can estimate T_{f}, with a high degree of accuracy. To address the integer ambiguity, N, The UE's position may be estimated using Rel-16/17 positioning techniques, which can provide a coarse accuracy of the UE's position (e.g., an accuracy in the range of 1 to 3 meters). Therefore, the measured propagation delay may be expressed as:

Tₚ₋ₘ=N·T_{c}+T_{f}+e₁

If e₁ is small, e.g., less than half a cycle (less than T_{c}/2), the value of N may be estimated, and subsequently the value of T_{f} can be accurately measured using the carrier phase method, after applying the round-trip carrier phase or the double difference carrier phase or other methods to eliminate the clock biases of the devices involved in the carrier phase measurement. With a positioning measurement accuracy of 1 to 3 meters, e₁=3.3−10 ns. For e₁ to be less than

$$\frac{{T}_{c}}{2} ,$$

this would imply a carrier frequency of 50 MHz or less. This is well below the carrier frequencies used in cellular systems. To address this issue, we consider the carrier phase at two different frequencies (more than two frequencies may also be considered).

For the first carrier at frequency f_{c1}, the measured carrier phase is with integer ambiguity N₁, and propagation delay Tₚ is

φ₁=2f_{c1}Tₚ−2πN₁

For the second carrier at frequency f_{c2}, the measured carrier phase is with integer ambiguity N₂, and propagation delay Tₚ is

φ₂=2πf_{c2}Tₚ−2πN₂

Subtracting φ₂ from φ₁ we arrive at

φ₁−φ₂=2π(f_{c1}−f_{c2})T_{P}−2π(N₁−N₂)

This creates a virtual carrier frequency with frequency f_{cv}=f_{c}−f_{c2}, and virtual phase φᵥ=φ₁−φ₂. If f_{c1} and f_{c2} are close in value, f_{cv}<<f_{c1} and f_{cv}<<f_{c2}. Hence, the tolerance (error) of the legacy-based positioning methods may be small compared to period of the virtual carrier (e.g., less than half or quarter of the period of the virtual carrier) allowing the traditional (e.g., coarse) positioning method to estimate the number of cycles for the virtual carrier.

The following steps may be followed to provide an accurate positioning measurement using the carrier phase method:
Using Rel-16/17 positioning techniques a coarse positioning estimate can be found e.g., a coarse estimate of Tₚ of difference in time of arrival or propagation delay.
The carrier phase is measured at two frequencies (at least) f_{c1} and f_{c2}, e.g., f_{c1}>f_{c2}. The corresponding carrier phase is φ₁ and φ₂. A virtual frequency is determined f_{vc}=f_{c1}−f_{c2}. The virtual frequency period is significantly larger than the error in T_{P} of the Rel-16/17 positioning technique used to estimate Tₚ. In the examples of this disclosure, the phase value could be reported by gNB or UE, or the negative of the phase value.
N₁−N₂ is computed for φ₁−φ₂. T_{P} can be more accurately estimated using φ₁−φ₂=2π(f_{c1}−f_{c2})T_{P}−2π(N₁−N₂).
Optionally, Tₚ can be further refined using φ₁=2πf_{c1}Tₚ−2πN₁ or using φ₂=2πf_{c2}Tₚ−2πN₂.

Now consider using two carriers for the carrier phase measurement. For the first carrier at frequency f_{c1}, the double difference carrier phase with integer ambiguity N₁, and propagation delay difference, or time of arrival difference (τ1−τ2) is

Δφ_{ue-dd1}=((τ1−τ2)−(τ1ᵣᵤ−τ2ᵣᵤ))2πf_{c1}−2πN₁

For the second carrier at frequency f_{c2}, the double difference carrier phase with integer ambiguity N₂, and propagation delay difference, or time of arrival difference (τ1−τ2) is

Δϕ_{ue-dd2}=((τ1−τ2)−(τ1ᵣᵤ−τ2ᵣᵤ))2πf_{c2}−2πN₂

Subtracting φ₂ from φ₁ we arrive at

φ₁−φ₂=2π(f_{c1}−f_{c2})T_{P}−2π(N₁−N₂)

This creates a virtual carrier frequency with frequency f_{cv}=f_{c1}−f_{c2}, and virtual phase φᵥ=φ₁−φ₂. If f_{c1} and f_{c2} are close in value, f_{cv}<<f_{c1} and f_{cv}<<f_{c2}. Hence, the tolerance (error) of the legacy-based positioning methods may be less than half or quarter the period of the virtual carrier allowing the traditional positioning method to estimate the number of cycles for the virtual carrier.

While the previous description for the double difference phase was described for DL PRS, it may also be applied to UL PRS (positioning SRS). In this case, each gNB measures the phase of the signal received from the UE and RU. The measurements may be provided to the LMF or to one of the gNB or the UE, where the difference between the phase measured at each gNB is calculated for the UE and RU respectively (single difference). The difference between the single difference phase of the UE and the single difference phase of the RU is then calculated to get the double difference phase that eliminates the clock biases.

As described earlier, a gNB may transmit a DL PRS, a UE can receive the DL PRS and can measure the DL phase of a carrier (or sub-carrier), which is given by:

Δφᵤₑ=(ϕᵤ₀+(Tₙ₁+τ+δt_{b}−δtᵤ)2πf_{c}−ϕ_{b1})mod 2π

For a carrier with frequency f_{c1}, the UE can measure the DL phase of the carrier at frequency f_{c1}:

Δφᵤₑ₁=(ϕᵤ₀+(Tₙ₁+τ+δt_{b}−δtᵤ)2πf_{c1}−ϕ_{b1})mod 2π

For a carrier with frequency f_{c2}, the UE can measure the DL phase of the carrier at frequency f_{c2}:

Δφᵤₑ₂=(ϕᵤ₀+(Tₙ₁+τ+δt_{b}−δtᵤ)2πf_{c2}−ϕ_{b1})mod 2π

In the above two equation, the phase of the UE at the reference time may be the same for both carriers f_{c1} and f_{c2} which is ϕᵤ₀. In a variant example, the phase of the two carriers at the reference time may be different.

In the above two equations, the phase of the DL PRS at the gNB may be the same for both carriers f_{c1} and f_{c2} which is ϕ_{b1}. In a variant example, the phase of the two carriers of the DL PRS at the gNB may be different.

In one example, the UE may calculate Δφᵤₑ₁−Δφᵤₑ₂:

Δφᵤₑ₁−Δφᵤₑ₂=((Tₙ₁+τ+δt_{b}−δtᵤ)2π(f_{c1}−f_{c2}))mod 2π

In one example, the UE may report (e.g., to LMF or to gNB) Δφᵤₑ₁ and Δφᵤₑ₂.

In one example, the UE may report (e.g., to LMF or to gNB) Δφᵤₑ₁−Δφᵤₑ₂.

In one example, the UE may use Δφᵤₑ₁ and Δφᵤₑ₂ to calculate τ.

In one example, the UE may use Δφᵤₑ₁−Δφᵤₑ₂ to calculate τ.

As described earlier, a UE may transmit an UL PRS (positioning SRS), a gNB can receive the UL PRS (positioning SRS) and may measure the UL phase of a carrier (or sub-carrier), which is given by:

Δφ_{bs}=(ϕ_{b0}+(Tₙ₂+τ−δt_{b}+δtᵤ)2πf_{c}−ϕᵤ₂)mod 2π

For a carrier with frequency f_{c1}, the gNB may measure the UL phase of the carrier at frequency f_{c1}:

Δφ_{bs1}=(ϕ_{b0}+(Tₙ₂+τ−δt_{b}+δtᵤ)2πf_{c1}−ϕᵤ₂)mod 2π

For a carrier with frequency f_{c2}, the gNB may measure the UL phase of the carrier at frequency f_{c2}:

Δφ_{bs2}=(ϕ_{b0}+(Tₙ₂+τ−δt_{b}+δtᵤ)2πf_{c2}−ϕᵤ₂)mod 2π

In one example, the same carrier frequencies f_{c1} and f_{c2} may be configured for the UL positioning reference signal (e.g., positioning sounding reference signal—positioning SRS) as configured for DL positioning reference signal.

In the above two equation, the phase of the gNB at the reference time may be the same for both carriers f_{c1} and f_{c2} which is ϕ_{b0}. In a variant example, the phase of the two carriers at the reference time may be different.

In the above two equations, the phase of the UL PRS at the UE may be the same for both carriers f_{c1} and f_{c2} which is ϕᵤ₂. In a variant example, the phase of the two carriers of the UL PRS at the UE may be different.

In one example, the UE can calculate Δφ_{bs1}−Δφ_{bs2}:

Δφ_{bs1}−Δφ_{bs2}=((Tₙ₂+τ−δt_{b}+δtᵤ)2π(f_{c1}−f_{c2}))mod 2π

In one example, the gNB may report (e.g., to LMF or to the UE) Δφ_{bs1} and Δφ_{bs2} or −Δφ_{bs1} and −Δφ_{bs2}.

In one example, the gNB may report (e.g., to LMF or to the UE) Δφ_{bs1}−Δφ_{bs2} or ) Δφ_{bs2}−Δφ_{bs1}.

In one example, the gNB may use Δφ_{bs1} and Δφ_{bs2} for positioning, e.g., to calculate τ.

In one example, the gNB may use Δφ_{bs1}−Δφ_{bs2} for positioning, e.g., to calculate τ.

In one example, an entity (e.g., LMF, gNB, or UE) may get or have Δφ_{bs1}, Δφ_{bs2}, Δφᵤₑ₁ and Δφᵤₑ₂. The entity may compute for the first carrier f_{c1}.

Δφ_{bs1}+Δφᵤₑ₁=(ϕ_{b0}+ϕᵤ₀+(Tₙ₂+Tₙ₁+2τ)2πf_{c1}−ϕᵤ₂−ϕ_{b1})mod 2π

The entity may compute for the second carrier f_{c2}.

Δφ_{bs2}+Δφᵤₑ₂=(ϕ_{b0}+ϕᵤ₀+(Tₙ₂+Tₙ₁+2τ)2πf_{c2}−ϕᵤ₂−ϕ_{b1})mod 2π

The entity may compute the difference between the last two

Δφ=Δφ_{bs1}+Δφᵤₑ₁−(Δφ_{bs2}+Δφᵤₑ₂)=((Tₙ₂+Tₙ₁+2τ)2π(f_{c1}−f_{c2}))mod 2πΔφ=2π(Tₙ₂+Tₙ₁+2τ)(f_{c1}−f_{c2})−2πN

The value of N may be estimated using legacy positioning methods. A refined estimate of τ may then be obtained using the round-trip carrier phase method.

In one example, an entity (e.g., LMF, gNB, or UE) may get or have Δφ_{bs1}−Δφ_{bs2}, and Δφᵤₑ₁−Δφᵤₑ₂. The entity computes

Δφ=Δφ_{bs1}−Δφ_{bs2}−(Δφᵤₑ₁−Δφᵤₑ₂·)=((Tₙ₂+Tₙ₁+2τ)2π(f_{c1}−f_{c2}))mod 2πΔφ=2π(Tₙ₂+Tₙ₁+2τ)(f_{c1}−f_{c2})−2πN

the virtual frequency may be given by f_{vc}=f_{c1}−f_{c2}, with f_{vc}<<f_{c1} and f_{vc}<<f_{c2}. As the virtual frequency is small, the value of N may be estimated using legacy positioning methods. A refined estimate of T may then then obtained using the round-trip carrier phase method.

As described earlier, a first gNB, gNB1, may transmit a DL PRS, a UE may receive the DL PRS and may measure the DL phase, Δφᵤₑ₁₁ of a first carrier (or sub-carrier), f_{c1}, and the DL phase, Δφᵤₑ₁₂ of a second carrier (or sub-carrier), f_{c2}. A second gNB, gNB2, may transmit a DL PRS, the UE can receive the DL PRS and may measure the DL phase, Δφᵤₑ₂₁ of the first carrier (or sub-carrier), f_{c1}, and the DL phase, Δφᵤₑ₂₂ of the second carrier (or sub-carrier), f_{c2}.

In one example, the UE may report (e.g., to LMF or to gNB), Δφᵤₑ₁₁, Δφᵤₑ₁₂, Δφᵤₑ₂₁ and Δφᵤₑ₂₂.

In one example, the UE may determine the single difference for the first carrier (or sub-carrier), f_{c1},

Δφ_{ue-sd1}=Δφᵤₑ₁₁−Δφᵤₑ₂₁

The UE may further determine the single difference for the second carrier (or sub-carrier), f_{c2},

Δφ_{ue-sd2}=Δφᵤₑ₁₂−Δφᵤₑ₂₂

The UE may report (e.g., to LMF or to gNB), the single difference, Δφ_{ue-sd1}, of the first carrier (sub-carrier), f_{c1} and the single difference, Δφ_{ue-sd2}, of the second carrier (sub-carrier), f_{c2}.

In one example, the UE may determine the phase difference between the first carrier (sub-carrier), f_{c1}, and the second carrier (sub-carrier), f_{c2}, for the first gNB, gNB1

Δφ_{ue-gnb1}=Δφᵤₑ₁₁−Δφᵤₑ₁₂

In one example, the UE may determine the phase difference between for the first carrier (sub-carrier), f_{c1}, and the second carrier (sub-carrier), f_{c2}, for the second gNB, gNB2

Δφ_{ue-gnb2}=Δφᵤₑ₂₁−Δφᵤₑ₂₂

The UE may report (e.g., to LMF or to gNB), the phase difference, Δφ_{ue-gnb1} between the first carrier (sub-carrier), f_{c1}, and the second carrier (sub-carrier), f_{c2}, of gNB1, and the phase difference, Δφ_{ue-gnb2} between the first carrier (sub-carrier), f_{c1}, and the second carrier (sub-carrier), f_{c2}, of gNB2.

In one example, the UE may determine the single difference of the phase difference between the first carrier (sub-carrier), f_{c1}, and the second carrier (sub-carrier), f_{c2},

Δφ_{ue-sd}=Δφ_{ue-gnb1}−Δφ_{ue-gnb2}

Or

Δφ_{ue-sd}=Δφ_{ue-sd1}−Δφ_{ue-sd2}

Or

Δφ_{ue-sd}=Δφᵤₑ₁₁+Δφᵤₑ₂₂−Δφᵤₑ₁₂−Δφᵤₑ₂₁

The UE may report (e.g., to LMF or to gNB), the single difference of the phase difference between the first carrier (sub-carrier), f_{c1}, and the second carrier (sub-carrier), f_{c2}.

In one example, the UE may use Δφᵤₑ₁₁, Δφᵤₑ₁₂, Δφᵤₑ₂₁ and Δφᵤₑ₂₂ for positioning, e.g., to calculate τ1−τ2. Where, τ1 is the time of arrival at the UE of the signal from gNB1, or the propagation time between the UE and gNB1. τ2 is the time of arrival at the UE of the signal from gNB2, or the propagation time between the UE and gNB2.

In one example, the UE may use Δφ_{ue-sd1}, and Δφ_{ue-sd2} for positioning, e.g., to calculate τ1−τ2. Where, τ1 is the time of arrival at the UE of the signal from gNB1, or the propagation time between the UE and gNB1. τ2 is the time of arrival at the UE of the signal from gNB2, or the propagation time between the UE and gNB2.

In one example, the UE may use Δφ_{ue-gnb1}, and Δφ_{ue-gnb2} for positioning, e.g., to calculate τ1−τ2. Where, τ1 is the time of arrival at the UE of the signal from gNB1, or the propagation time between the UE and gNB1. τ2 is the time of arrival at the UE of the signal from gNB2, or the propagation time between the UE and gNB2.

In one example, the UE may use Δφ_{ue-sd} for positioning, e.g., to calculate τ1−τ2. Where, τ1 is the time of arrival at the UE of the signal from gNB1, or the propagation time between the UE and gNB1. τ2 is the time of arrival at the UE of the signal from gNB2, or the propagation time between the UE and gNB2.

As described earlier, the first gNB, gNB1, may transmit a DL PRS, a reference unit or UE, RU, or positioning reference unit (PRU) can receive the DL PRS and can measure the DL phase, Δφᵣᵤ₁₁ of a first carrier (or sub-carrier), f_{c1}, and the DL phase, Δφᵣᵤ₁₂ of a second carrier (or sub-carrier), f_{c2}. A second gNB, gNB2, may transmit a DL PRS, the RU can receive the DL PRS and can measure the DL phase, Δφᵣᵤ₂₁ of the first carrier (or sub-carrier), f_{c1}, and the DL phase, Δφᵣᵤ₂₂ of the second carrier (or sub-carrier), f_{c2}.

In one example, the RU may report (e.g., to LMF or to gNB or the UE), Δφᵣᵤ₁₁, Δφᵣᵤ₁₂, Δφᵣᵤ₂₁ and Δφᵣᵤ₂₂.

In one example, the RU may determine the single difference for the first carrier (or sub-carrier), f_{c1},

Δφ_{ru-sd1}=Δφᵣᵤ₁₁−Δφᵣᵤ₂₁

The RU may further determine the single difference for the second carrier (or sub-carrier), f_{c2},

Δφ_{ru-sd2}=Δφᵣᵤ₁₂−Δφᵣᵤ₂₂

The RU may report (e.g., to LMF or to gNB or the UE), the single difference, Δφ_{ru-sd1}, of the first carrier (sub-carrier), f_{c1} and the single difference, Δφ_{ru-sd2}, of the second carrier (sub-carrier), f_{c2}.

In one example, the RU may determine the phase difference between the first carrier (sub-carrier), f_{c1}, and the second carrier (sub-carrier), f_{c2}, for the first gNB, gNB1

Δφ_{ru-sd2}=Δφᵣᵤ₁₂−Δφᵣᵤ₂₂

In one example, the RU may determine the phase difference between for the first carrier (sub-carrier), f_{c1}, and the second carrier (sub-carrier), f_{c2}, for the second gNB, gNB2

Δφ_{ru-gnb2}=Δφᵣᵤ₂₁−Δφᵣᵤ₂₂

The RU may report (e.g., to LMF or to gNB or the UE), the phase difference, Δφ_{ru-gnb1} between the first carrier (sub-carrier), f_{c1}, and the second carrier (sub-carrier), f_{c2}, of gNB1, and the phase difference, Δφ_{ru-gnb2} between the first carrier (sub-carrier), f_{c1}, and the second carrier (sub-carrier), f_{c2}, of gNB2.

In one example, the RU may determine the single difference of the phase difference between the first carrier (sub-carrier), f_{c1}, and the second carrier (sub-carrier), f_{c2},

Δφ_{ru-sd}=Δφ_{ru-gnb1}−Δφ_{ru-gnb2}

Or

Δφ_{ru-sd}=Δφ_{ru-sd1}−Δφ_{ru-sd2}

Or

Δφ_{ru-sd}=Δφᵣᵤ₁₁+Δφᵣᵤ₂₂−Δφᵣᵤ₁₂−Δφᵣᵤ₂₁

The RU may report (e.g., to LMF or to gNB or the UE), the single difference of the phase difference between the first carrier (sub-carrier), f_{c1}, and the second carrier (sub-carrier), f_{c2}.

In one example, an entity (e.g., LMF, gNB, or UE or RU) may get or have an entry from column 1 and an entry from column 2 of TABLE 4.

TABLE 4

| Carrier Phase measurements | Carrier phase measurement |
|---|---|
| from UE | from RU |
| Δφᵤₑ₁₁, Δφᵤₑ₁₂, Δφᵤₑ₂₁, | Δφᵣᵤ₁₁, Δφᵣᵤ₁₂, Δφᵣᵤ₂₁, |
| and Δφᵤₑ₂₂ | and Δφᵣᵤ₂₂ |
| Δφ_{ue-sd1} and Δφ_{ue-sd2} | Δφ_{ru-sd1} and Δφ_{ru-sd2} |
| Δφ_{ue-gnb1} and Δφ_{ue-gnb2} | Δφ_{ru-gnb1} and Δφ_{ru-gnb2} |
| Δφ_{ue-sd} | Δφ_{ru-sd} |

The entity may calculate the double difference of the phase difference between the first carrier (sub-carrier), f_{c1}, and the second carrier (sub-carrier), f_{c2},

Δφ_{ue-dd}=Δφ_{ue-sd}−Δφ_{ru-sd}

Which may be found to equal

Δφ_{ue-dd}=(((τ1−τ2)−(τ1ᵣᵤ−τ2ᵣᵤ))2π(f_{c1}−f_{c2}))mod 2π

Δφ_{ue-dd}=((τ1−τ2)−(τ1ᵣᵤ−τ2ᵣᵤ))2π(f_{c1}−f_{c2})−2πN

The virtual frequency may be given by f_{vc}=f_{c1}−f_{c2}, with f_{vc}<<f_{c1} and f_{vc}<<f_{c2}. As the virtual frequency is small, the value of N may be estimated using legacy positioning methods. A refined estimate of τ1−τ2 is then obtained using the double difference carrier phase method.

In one example, a UE may transmit an UL PRS (positioning SRS) to a first gNB, gNB1. gNB1 can receive the UL PRS (positioning SRS) and may measure the UL phase, Δφ_{bsu11} of a first carrier (or sub-carrier), f_{c1}, and the UL phase, Δφ_{bsu12} of a second carrier (or sub-carrier), f_{c2}. In one example, an RU or UE, may transmit an UL PRS (positioning SRS) to a first gNB, gNB1. gNB1 may receive the UL PRS (positioning SRS) and may measure the UL phase, Δφ_{bsr11} of a first carrier (or sub-carrier), f_{c1}, and the UL phase, Δφ_{bsr12} of a second carrier (or sub-carrier), f_{c2}.

In one example, gNB1 may report (e.g., to LMF or to another gNB or UE), Δφ_{bsu11}, Δφ_{bsu12}, Δφ_{bsr11} and Δφ_{bsr11}.

In one example, gNB1 may determine the single difference for the first carrier (or sub-carrier), f_{c1}, by subtracting the carrier phase measurement of the RU from the UE, this eliminates the clock biases of gNB1 for f_{c1}

Δφ_{bs1-sd1}=Δφ_{bsu11}−Δφ_{bsr11}

gNB1 may further determine the single difference for the second carrier (or sub-carrier), f_{c2}, by subtracting the carrier phase measurement of the RU from the UE, this eliminates the clock biases of gNB1 for f_{c2}

Δφ_{bs1-sd2}=Δφ_{bsu12}−Δφ_{bsr12}

gNB1 may report (e.g., to LMF or to another gNB or UE), the single difference, Δφ_{bs1-sd1}, of the first carrier (sub-carrier), f_{c1} and the single difference, Δφ_{bs1-sd2}, of the second carrier (sub-carrier), f_{c2}.

In one example, gNB1 may determine the phase difference between the first carrier (sub-carrier), f_{c1}, and the second carrier (sub-carrier), f_{c2}, for the UE

Δφ_{ue-gnb1}=Δφ_{bsu11}−Δφ_{bsu11}

In one example, gNB1 may determine the phase difference between for the first carrier (sub-carrier), f_{c1}, and the second carrier (sub-carrier), f_{c2}, for the RU

Δφ_{ru-gnb1}=Δφ_{bsr11}−Δφ_{bsu12}

gNB1 may report (e.g., to LMF or to another gNB or UE), the phase difference, Δφ_{ue-gnb1} between the first carrier (sub-carrier), f_{c1}, and the second carrier (sub-carrier), f_{c2}, of the UE, and the phase difference, Δφ_{ru-gnb1} between the first carrier (sub-carrier), f_{c1}, and the second carrier (sub-carrier), f_{c2}, of the RU.

In one example, gNB1 may determine the single difference of the phase difference between the first carrier (sub-carrier), f_{c1}, and the second carrier (sub-carrier), f_{c2},

Δφ_{bs1-sd}=Δφ_{ue-gnb1}−Δφ_{ru-gnb1}

Or

Δφ_{bs1-sd}=Δφ_{bs1-sd1}−Δφ_{bs1-sd2}

Or

Δφ_{bs1-sd}=Δφ_{bsu11}+Δφ_{bsr12}−Δφ_{bsu12}−Δφ_{bsr11}

gNB1 may report (e.g., to LMF or to another gNB or UE), the single difference of the phase difference between the first carrier (sub-carrier), f_{c1}, and the second carrier (sub-carrier), f_{c2}.

In one example, gNB1 may use Δφ_{bsu11}, Δφ_{bsu12}, Δφ_{bsr11} and Δφ_{bsr12} for positioning, e.g., to calculate τ1−τ2. Where, τ1 is the time of arrival at gNB1 of the signal from the UE, or the propagation time between the UE and gNB1. τ2 is the time of arrival at gNB2 of the signal from the RU, or the propagation time between the RU and gNB1.

In one example, gNB1 may use Δϕ_{ue-gnb1}, and Δφ_{ru-gnb1} for positioning, e.g., to calculate τ1−τ2. Where, τ1 is the time of arrival at gNB1 of the signal from the UE, or the propagation time between the UE and gNB1. τ2 is the time of arrival at gNB1 of the signal from the RU, or the propagation time between the RU and gNB1.

In one example, gNB1 may use Δφ_{bs1-sd1}, and Δφ_{bs1-sd2} for positioning, e.g., to calculate τ1−τ2. Where, τ1 is the time of arrival at gNB1 of the signal from the UE, or the propagation time between the UE and gNB1. τ2 is the time of arrival at gNB1 of the signal from the RU, or the propagation time between the RU and gNB1.

In one example, the gNB1 may use Δφ_{bs1-sd} for positioning, e.g., to calculate τ1−τ2. Where, τ1 is the time of arrival at gNB1 of the signal from the UE, or the propagation time between the UE and gNB1. τ2 is the time of arrival at gNB1 of the signal from the RU, or the propagation time between the RU and gNB1.

In one example, a UE may transmit an UL PRS (positioning SRS) to a second gNB, gNB2, this can be the same UL PRS (positioning SRS) transmitted to gNB1 or a different UL PRS (positioning SRS). gNB2 may receive the UL PRS and can measure the UL phase, Δφ_{bsu21} of a first carrier (or sub-carrier), f_{c1}, and the UL phase, Δφ_{bsu22} of a second carrier (or sub-carrier), f_{c2}. In one example, an RU or UE, may transmit an UL PRS (positioning SRS) to a second gNB, gNB2, this may be the same UL PRS (positioning SRS) transmitted to gNB1 or a different UL PRS (positioning SRS). gNB2 may receive the UL PRS (positioning SRS) and may measure the UL phase, Δφ_{bsr21} of a first carrier (or sub-carrier), f_{c1}, and the UL phase, Δφ_{bsr22} of a second carrier (or sub-carrier), f_{c2}.

In one example, gNB2 may report (e.g., to LMF or to another gNB or UE), Δφ_{bsu21}, Δφ_{bsu22}, Δφ_{bsr21} and Δφ_{bsr21}.

In one example, gNB2 may determine the single difference for the first carrier (or sub-carrier), f_{c1}, by subtracting the carrier phase measurement of the RU from the UE, this eliminates the clock biases of gNB2 for f_{c1}

Δφ_{bs2-sd1}=Δφ_{bsu21}−Δφ_{bsr21}

gNB2 may further determine the single difference for the second carrier (or sub-carrier), f_{c2}, by subtracting the carrier phase measurement of the RU from the UE, this eliminates the clock biases of gNB1 for f_{c2}

Δφ_{bs2-sd2}=Δφ_{bsu22}−Δφ_{bsr22}

gNB2 may report (e.g., to LMF or to another gNB or UE), the single difference, Δφ_{bs2-sd1}, of the first carrier (sub-carrier), f_{c1} and the single difference, Δφ_{bs2-sd2}, of the second carrier (sub-carrier), f_{c2}.

In one example, gNB2 may determine the phase difference between the first carrier (sub-carrier), f_{c1}, and the second carrier (sub-carrier), f_{c2}, for the UE

Δφ_{ue-gnb2}=Δφ_{bsu21}−Δφ_{bsr22}

In one example, gNB2 may determine the phase difference between for the first carrier (sub-carrier), f_{c1}, and the second carrier (sub-carrier), f_{c2}, for the RU

Δφ_{ru-gnb2}=Δφ_{bsu21}−Δφ_{bsr22}

gNB2 may report (e.g., to LMF or to another gNB or UE), the phase difference, Δφ_{ue-gnb2} between the first carrier (sub-carrier), f_{c1}, and the second carrier (sub-carrier), f_{c2}, of the UE, and the phase difference, Δφ_{ru-gnb2} between the first carrier (sub-carrier), f_{c1}, and the second carrier (sub-carrier), f_{c2}, of the RU.

In one example, gNB2 may determine the single difference of the phase difference between the first carrier (sub-carrier), f_{c1}, and the second carrier (sub-carrier), f_{c2},

Δφ_{bs2-sd}=Δφ_{ue-gnb2}−Δφ_{ru-gnb2}

Or

Δφ_{bs2-sd}=Δφ_{bs2-sd1}−Δφ_{bs2-sd2}

Or

Δφ_{bs2-sd}=Δφ_{bsu21}+Δφ_{bsr22}−Δφ_{bsu22}−Δφ_{bsr21}

gNB2 may report (e.g., to LMF or to another gNB or UE), the single difference of the phase difference between the first carrier (sub-carrier), f_{c1}, and the second carrier (sub-carrier), f_{c2}.

In one example, gNB2 may use Δφ_{bsu21}, Δφ_{bsu22}, Δφ_{bsr21} and Δφ_{bsr22} for positioning, e.g., to calculate τ1−τ2. Where, τ1 is the time of arrival at gNB2 of the signal from the UE, or the propagation time between the UE and gNB2. τ2 is the time of arrival at gNB2 of the signal from the RU, or the propagation time between the RU and gNB2.

In one example, gNB2 may use Δφ_{ue-gnb2}, and Δφ_{ru-gnb2} for positioning, e.g., to calculate τ1−τ2. Where, τ1 is the time of arrival at gNB2 of the signal from the UE, or the propagation time between the UE and gNB2. τ2 is the time of arrival at the gNB2 of the signal from the RU, or the propagation time between the RU and gNB2.

In one example, gNB2 may use Δφ_{bs2-sd1}, and Δφ_{bs2-sd2} for positioning, e.g., to calculate τ1−τ2. Where, τ1 is the time of arrival at gNB2 of the signal from the UE, or the propagation time between the UE and gNB2. τ2 is the time of arrival at gNB2 of the signal from the RU, or the propagation time between the RU and gNB2.

In one example, the gNB2 may use Δφ_{bs2-sd} for positioning, e.g., to calculate τ1−τ2. Where, τ1 is the time of arrival at gNB2 of the signal from the UE, or the propagation time between the UE and gNB2. τ2 is the time of arrival at gNB2 of the signal from the RU, or the propagation time between the RU and gNB2.

In one example, an entity (e.g., LMF, gNB, or UE or RU) may get or have an entry from column 1 and an entry from column 2 of TABLE 5.

TABLE 5

| Carrier Phase measurements | Carrier phase measurement |
|---|---|
| from gNB1 | from gNb2 |
| Δφ_{bsu11}, Δφ_{bsu12}, Δφ_{bsr11}, | Δφ_{bsu21}, Δφ_{bsu22}, Δφ_{bsr21}, |
| and Δφ_{bsr12} | and Δφ_{bsr22} |
| Δφ_{bs1-sd1} and Δφ_{bs1-sd2} | Δφ_{bs2-sd1} and Δφ_{bs2-sd2} |
| Aφ_{ue-gnb1} and Δφ_{ru-gnb1} | Δφ_{ue-gnb2} and Δφ_{ru-gnb2} |
| Δφ_{bs1-sd} | Δφ_{bs2-sd} |

The entity may calculate the double difference of the phase difference between the first carrier (sub-carrier), f_{c1}, and the second carrier (sub-carrier), f_{c2},

Δφ_{ue-dd}=Δφ_{bs1-sd}−Δφ_{bs2-sd}

Which may be found to equal

Δφ_{ue-dd}=(((τ1−τ2)−(τ1ᵣᵤ−τ2ᵣᵤ))2π(f_{c1}−f_{c2}))mod 2π

Δφ_{ue-dd}=((τ1−τ2)−(τ1ᵣᵤ−τ2ᵣᵤ))2π(f_{c1}−f_{c2})−2πN

The virtual frequency may be given by f_{vc}=f_{c1}−f_{c2}, with f_{vc}<<f_{c1} and f_{vc}<<f_{c2}. As the virtual frequency is small, the value of N may be estimated using legacy positioning methods. A refined estimate of τ1τ2 may then be obtained using the double difference carrier phase method.

A gNB or TRP or base station may be configured to transmit a positioning reference signal in the downlink direction, e.g., the positioning reference signal may be a DL positioning reference signal (PRS).

A UE may be configured to receive a positioning reference signal in the downlink direction, e.g., the positioning reference signal may a DL positioning reference signal (PRS).

The configuration of the downlink PRS may include:
Time domain resources, e.g., number of symbols and starting position within a slot of DL PRS.
Time domain behavior, whether transmission is aperiodic, semi-persistent or periodic transmission, including periodicity and/or offset for semi-persistent and periodic transmissions.
Frequency domain resources, e.g., starting position in frequency domain (e.g., FD shift), and length in frequency domain (e.g., number of PRBs or C-SRS).
Transmission comb related information. Number of transmission combs and transmission comb offset.
Code domain information, e.g., sequence ID, and group or sequence hopping type (e.g., neither, groupHopping or sequenceHopping).

Some of the aforementioned parameters may be common across the multiple TRPs, e.g., configured with a common configuration, and some can be distinct, e.g., specific for each TRP.

In one example, the reception of the DL PRS at the UE may be Omni-directional, e.g., a same spatial receive filter may receive transmissions from multiple TRPs.

In one example, the reception of the DL PRS at the UE from different TRPs may be on separate beams wherein a reception on a beam is from to one or more TRPs.

In one example, the gNB may report (e.g., to UE or to LMF) the reference symbol (e.g., corresponding to a reference time in the gNB). For example, the reference symbol may be reported similarly as previously described (e.g., at paragraph [0267]).

In one example, the gNB may configure or be configured the reference symbol (e.g., corresponding to a reference time in the gNB). For example, the reference symbol may be configured similarly as previously described (e.g., at paragraph [0268]).

In one example, the reference symbol (e.g., corresponding to a reference time in the gNB) may be specified in the system specification similarly as previously described (e.g., at paragraph [0268]). In one example, the default value may be specified in the system specifications and is used if no other value is configured by RRC signaling and/or MAC CE signaling and/or L1 control (e.g., DCI) signaling. e.g., reference time be start of DL or UL symbol 0 of SFN 0 or the symbol of the DL PRS, or the first DL PRS symbol in the slot in which DL PRS is transmitted.

In one example, the gNB may report (e.g., to UE or another gNB or to LMF) the phase at the start of the reference symbol, i.e., ϕ_{b0}. For example, the gNB may report the phase at the start of the reference symbol similar as previously described (e.g., at paragraphs [0269]-[0273]).

In one example, the gNB may report an indication (e.g., to UE or another gNB or to LMF) similarly as previously described (e.g., at paragraphs [0274]-[0277]).

In one example, the gNB may transmit the DL PRS similarly as previously described (e.g., at paragraphs [0278]-[0294]).

In one example, the UE may report (e.g., to gNB or to LMF) the reference symbol (e.g., corresponding to a reference time in the UE). For example, the reference symbol may be reported similarly as previously described (e.g., at paragraph [0295]).

In one example, the UE may be configured the reference symbol (e.g., corresponding to a reference time in the UE). The reference symbol may be configured similarly as previously described (e.g., at paragraph [0296].

In one example, the reference symbol (e.g., corresponding to a reference time in the UE) may be specified in the system specification similarly as previously described (e.g., at paragraph [0297]).

In one example, the UE may report (e.g., to gNB or to LMF) the phase at the start of the reference symbol, i.e., ϕᵤ₀, similarly as previously described (e.g., at paragraphs [0300]-[0304].

In one example, the UE may report an indication (e.g., to gNB or to LMF) similarly as previously described (e.g., at paragraphs [0305]-[0323]. if phase continuity has been maintained between the reference time (e.g., most recent reference time) and the reception of the corresponding DL positioning reference signal.

In one example, the UE may measure the phase between a reference signal and corresponding received DL PRS symbol, similarly as previously described (e.g., at paragraph [0324]. In one example, to measure the phase difference at the UE the reference signal may be multiplied by the complex conjugate of the received DL positioning reference signal at the UE, similarly as previously described (e.g., at paragraphs [0325]-[0326].

In one example, the UE may report (e.g., to gNB or to LMF) the measured phase difference between the reference signal and the corresponding received DL positioning reference signal e.g., the UE measures the carrier phase of the received DL PRS from a TRP or gNB, for example, this measurement may be relative to the reference phase of the UE.

In one example, the phase difference may be reported if DL PRS is detected and measured.

In one example, the phase difference may be reported if phase continuity is maintained between the corresponding reference time (e.g., most recent) and time of reception of the DL positioning reference signal.

In one example, the phase difference may be reported regardless of maintaining phase continuity between the corresponding reference time (e.g., most recent) and time of reception of the DL positioning reference signal.

In one example, the UE may report the phase difference for one subcarrier (or carrier frequency). In one example, the sub-carrier (or carrier frequency) may be at the middle (center) of the DL positioning reference signal allocation. In one example, the sub-carrier may be at the start of the DL positioning reference signal allocation. In one example, the sub-carrier may be at the end of the DL positioning reference signal allocation. In one example, if the number of sub-carriers in the allocation is even, the middle (center) sub-carrier may be one of:
The average phase (or frequency) of the two middle sub-carriers.
The sub-carrier with the higher frequency of the two middle sub-carriers.
The sub-carrier with the lower frequency of the two middle sub-carriers.

In one example, the UE ay report (e.g., to gNB or to LMF) the phase difference for all sub-carriers of the DL positioning reference signal.

In one example, the UE may report (e.g., to gNB or to LMF) the phase difference for the carrier frequency. For example, this may be an average or a composite value computed for all sub-carriers.

In one example, the UE may report (e.g., to gNB or to LMF) the phase difference for each PRB of the DL positioning reference signal. In one example, the phase may be reported for the middle (center) sub-carrier of the PRB (or center of PRB). In one example, the phase may be reported for the first sub-carrier of the PRB. In one example, the phase may be reported for the last sub-carrier of the PRB. In one example, the number of sub-carriers per PRB may be even (e.g., 12), the middle (center) sub-carrier may be one of:
The average phase (or frequency) of the two middle sub-carriers.
The sub-carrier with the higher frequency of the two middle sub-carriers.
The sub-carrier with the lower frequency of the two middle sub-carriers.

A UL positioning reference signal may be a positioning sounding reference signal—positioning SRS.

A UE may be configured to transmit a positioning reference signal in the uplink direction, e.g., the positioning reference signal may be a UL positioning reference signal (PRS) or positioning SRS.

A gNB or TRP or base station may be configured to receive a positioning reference signal in the uplink direction, e.g., the positioning reference signal may be a UL positioning reference signal (PRS) or positioning SRS.

The configuration of the uplink PRS or positioning SRS may include:
Time domain resources, e.g., number of symbols and starting position within a slot of UL PRS or positioning SRS.
Time domain behavior, whether transmission is aperiodic, semi-persistent or periodic transmission, including periodicity and/or offset for semi-persistent and periodic transmissions.
Frequency domain resources, e.g., starting position in frequency domain (e.g., FD shift), and length in frequency domain (e.g., number of PRBs or C-SRS).
Transmission comb related information. Number of transmission combs and transmission comb offset.
Code domain information, e.g., sequence ID, and group or sequence hopping type (e.g., neither, groupHopping or sequenceHopping).

Some of the aforementioned parameters may be common across the multiple TRPs, e.g., configured with a common configuration, and some can be distinct, e.g., specific for each TRP receiving the UL PRS or positioning SRS.

In one example, the transmission of the UL PRS or positioning SRS at the UE may be Omni-directional, e.g., a same spatial receive filter may transmit to multiple TRPs.

In one example, the transmission of the UL PRS or positioning SRS at the UE to different TRPs may be on separate beams wherein a transmission on a beam is to one or more TRPs.

In one example, the UE may report (e.g., to gNB or to LMF) the reference symbol (e.g., corresponding to a reference time in the UE). For example, the reference symbol may be reported similarly as previously described (e.g., paragraph [0397].

In one example, the UE may be configured the reference symbol (e.g., corresponding to a reference time in the UE). T For example, the reference symbol may be configured similarly as previously described (e.g., at paragraph [0398].

In one example, the reference symbol (e.g., corresponding to a reference time in the UE) may be specified in the system specification. In one example, the default value may be specified in the system specifications and is used if no other value is configured by RRC signaling and/or MAC CE signaling and/or L1 control (e.g., DCI) signaling. e.g., reference time be start of DL or UL symbol 0 of SFN 0 or the symbol of the UL PRS (e.g., positioning SRS), or the first DL PRS symbol in the slot in which UL PRS (e.g., positioning SRS) is transmitted.

In one example, the UE may report (e.g., to gNB or to LMF) the phase at the start of the reference symbol, i.e., ϕᵤ₀ similarly as previously described (e.g., at paragraphs [0400]-[0404]).

In one example, the UE may report an indication (e.g., to gNB or to LMF) similarly as previously described (e.g., at paragraphs [0405]-[0424]).

In one example, the gNB may report (e.g., to UE or another gNB or to LMF) the reference symbol (e.g., corresponding to a reference time in the gNB). For example, the reference symbol may be reported similarly as previously described (e.g., at paragraph [0425]).

In one example, the gNB may configure or be configured the reference symbol (e.g., corresponding to a reference time in the gNB). The start of the reference symbol may be used for determining the reference phase ϕ_{b0} at the start of the reference symbol. The configuration can be by RRC signaling and/or MAC CE signaling and/or L1 control (e.g., DCI) signaling. For example, the reference symbol may be configured similarly as previously described (e.g., at paragraph [0426]).

In one example, the reference symbol (e.g., corresponding to a reference time in the gNB) may be specified similarly as previously described (e.g., at paragraph [0427]).

In one example, the gNB may report (e.g., to UE or another gNB or to LMF) the phase at the start of the reference symbol, i.e., ϕ_{b0} similarly as previously described (e.g., a paragraphs [0428]-[0432]).

In one example, the gNB may report an indication (e.g., to UE or another gNB or to LMF) similarly as previously described (e.g., at paragraphs [0433]-[0436]).

In one example, the gNB may measure the phase between a reference signal and corresponding received UL PRS or positioning SRS symbol similarly as previously described (e.g., at paragraph [0409]).

In one example, to measure the phase difference at the gNB the reference signal may be multiplied by the complex conjugate of the received UL positioning reference signal or positioning SRS at the gNB similarly as previously described (e.g., at paragraphs [0452]-[0453]).

In one example, the gNB may report (e.g., to UE or to LMF or another gNB) the measured phase difference between the reference signal and the corresponding received UL positioning reference signal or positioning SRS, e.g., the TRP/gNB measures the carrier phase of the received UL PRS or positioning SRS from a UE, for example, this measurement may be relative to the reference phase of the TRP/gNB.

In one example, the phase difference may be reported if UL PRS or positioning SRS is detected and measured.

In one example, the phase difference may be reported if phase continuity is maintained between the corresponding reference time (e.g., most recent) and time of reception of the UL positioning reference signal or positioning SRS.

In one example, the phase difference may be reported regardless of maintaining phase continuity between the corresponding reference time (e.g., most recent) and time of reception of the UL positioning reference signal or positioning SRS.

In one example, the gNB may report the phase difference for one subcarrier (or carrier frequency). In one example, the sub-carrier (or carrier frequency) may be at the middle (center) of the UL positioning reference signal or positioning SRS allocation. In one example, the sub-carrier may be at the start of the UL positioning reference signal or positioning SRS allocation. In one example, the sub-carrier may be at the end of the UL positioning reference signal or positioning SRS allocation. In one example, if the number of sub-carriers in is even, the middle (center) sub-carrier may be one of:
The average phase (or frequency) of the two middle sub-carriers.
The sub-carrier with the higher frequency of the two middle sub-carriers.
The sub-carrier with the lower frequency of the two middle sub-carriers.

In one example, the gNB may report (e.g., to UE or to LMF) the phase difference for all sub-carriers of the UL positioning reference signal or positioning SRS.

In one example, the gNB may report (e.g., to UE or to LMF) the phase difference for the carrier frequency. For example, this may be an average or a composite value computed for all sub-carriers.

In one example, the gNB may report (e.g., to UE or to LMF) the phase difference for each PRB of the UL positioning reference signal or positioning SRS. In one example, the phase may be reported for the middle (center) sub-carrier of the PRB (or center of PRB). In one example, the phase may be reported for the first sub-carrier of the PRB. In one example, the phase may be reported for the last sub-carrier of the PRB. In one example, the number of sub-carriers per PRB may be even (e.g., 12), the middle (center) sub-carrier may be one of:
The average phase (or frequency) of the two middle sub-carriers.
The sub-carrier with the higher frequency of the two middle sub-carriers.
The sub-carrier with the lower frequency of the two middle sub-carriers.

In one example, one or more of the measurements or configurations previously described may be received by a UE and/or gNB and/or LMF. Measurements may be performed for at least two carriers f_{c1} and f_{c2}.

Using the RTT method or other Rel-16/17 positioning methods (e.g., RSTD or RTOA), the UE and/or gNB and/or LMF may estimate a coarse value of the propagation delay or time different or time of arrival). Using this coarse value, the value of N may be determined assuming a virtual carrier f_{c}=f_{c1}−f_{c2}, with f_{c}<<f_{c1} and f_{c}<<f_{c2}

Using the double difference carrier phase method or other Rel-16/17 positioning methods, the UE and/or gNB and/or LMF may estimate a coarse value of the propagation delay (or time of arrival) difference from gNB1 and gNB2 at the UE, with the assistance of the carrier phase measurements and positioning (e.g., location) information of a reference unit (RU). Using this coarse value, the value of N may be determined assuming a virtual carrier f_{vc}=f_{c1}−f_{c2}, with f_{vc}<<f_{c1} and f_{vc}<<f_{c2}.

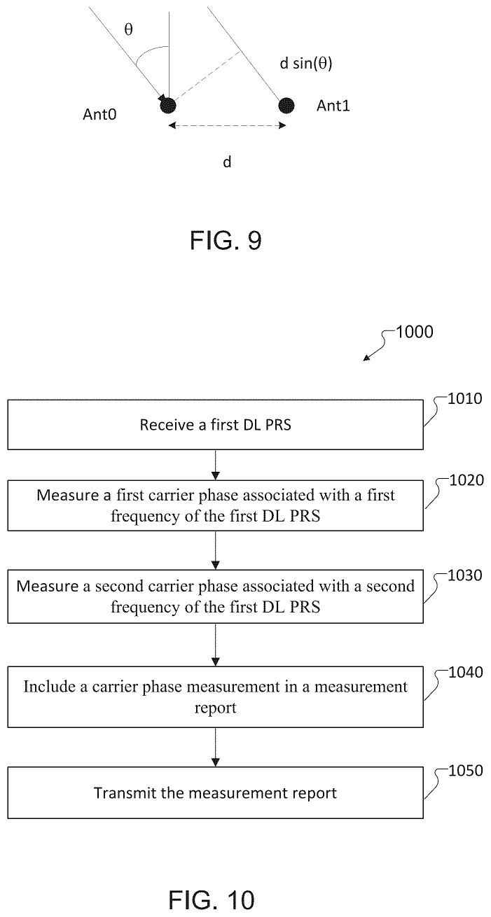

FIG. 10 illustrates an example method 1000 of positioning via round-trip carrier-phase method with multiple-carriers according to embodiments of the present disclosure. An embodiment of the method illustrated in FIG. 10 is for illustration only. One or more of the components illustrated in FIG. 10 may be implemented in specialized circuitry configured to perform the noted functions or one or more of the components may be implemented by one or more processors executing instructions to perform the noted functions. Other embodiments of positioning via round-trip carrier-phase method with multiple-carriers could be used without departing from the scope of this disclosure.

As illustrated in FIG. 10, the method 1000 begins at step 1010. At step 1010, a UE receives a first DL PRS. In one embodiment, the DL PRS may be received from a first TRP.

At step 1020, the UE measures a first carrier phase associated with a first frequency of the first DL PRS. At step 1030, the UE measures a second carrier phase associated with a second frequency of the first DL PRS.

At step 1040, the UE includes a carrier phase measurement in a measurement report. In one embodiment, the carrier phase measurement may be based on the measurement of the first carrier phase and the second carrier phase.

At step 1050, the UE transmits the measurement report. In one embodiment, the measurement report may be transmitted to a network.

Although FIG. 10 illustrates one example of a method 1000 of positioning via round-trip carrier-phase method with multiple-carriers, various changes may be made to FIG. 10. For example, while shown as a series of steps, various steps in FIG. 10 could overlap, occur in parallel, occur in a different order, or occur any number of times.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle.

What is claimed is:

1. A user equipment (UE) comprising:
a transceiver configured to receive, from a first transmit receive point (TRP), a first downlink (DL) positioning reference signal (PRS); and
a processor operably coupled to the transceiver, the processor configured to:
measure a first carrier phase associated with a first frequency of the first DL PRS,
measure a second carrier phase associated with a second frequency of the first DL PRS, and
include, in a measurement report, a carrier phase measurement based on the measurement of the first carrier phase and the second carrier phase,
wherein the transceiver is further configured to transmit the measurement report to a network.

2. The UE of claim 1, wherein the carrier phase measurement is a difference between the measurement of the first carrier phase and the measurement of the second carrier phase.

3. The UE of claim 1, wherein the transceiver is further configured to receive a difference between the first frequency and the second frequency.

4. The UE of claim 1, wherein the carrier phase measurement in the measurement report is for a first in time multi-path component.

5. The UE of claim 1, wherein, the transceiver is further configured to receive carrier phase measurements of a positioning reference unit (PRU) and a location information of the PRU.

6. The UE of claim 1, wherein:
the transceiver is further configured to receive, from a second TRP, a second DL PRS, and
the processor is further configured to:
measure a third carrier phase associated with a third frequency of the second DL PRS,
measure a fourth carrier phase associated with a fourth frequency of the second DL PRS, and
the carrier phase measurement in the measurement report is further based on the measurement of the third carrier phase and the measurement of the fourth carrier phase.

7. The UE of claim 1, wherein the transceiver is further configured to:
transmit, to a base station (BS), a sounding reference signal (SRS) for positioning, and
receive a carrier phase measurement based on measurement of a third carrier phase and a fourth carrier phase associated with third and fourth frequencies, respectively, of the SRS for positioning.

8. A base station (BS) comprising:
a transceiver configured to receive, from a user equipment (UE), a sounding reference signal (SRS) for positioning; and
a processor operably coupled to the transceiver, the processor configured to:
measure a first carrier phase associated with a first frequency of the SRS,
measure a second carrier phase associated with a second frequency of the SRS,
include, in a first measurement report, a carrier phase measurement, and
transmit, to a location management function (LMF), the measurement report, and
wherein the carrier phase measurement is based on the measurement of the first carrier phase and measurement of the second carrier phase.

9. The BS of claim 8, wherein the carrier phase measurement is a difference between the measurement of the first carrier phase, and the measurement of the second carrier phase.

10. The BS of claim 8, wherein the carrier phase measurement in the first measurement report is for a first in time multi-path component.

11. The BS of claim 8, wherein the transceiver is further configured to transmit carrier phase measurements of a positioning reference unit (PRU), and location information of the PRU.

12. The BS of claim 8, wherein:
the transceiver is further configured to:
transmit, to the UE, a downlink (DL) positioning reference signal (PRS), and
receive, from the UE, a second measurement report, and
the second measurement report includes a carrier phase measurement based on:
a third carrier phase associated with a third frequency of the DL PRS, and
a fourth carrier phase associated with a fourth frequency of the DL PRS.

13. The BS of claim 12, wherein:
the transceiver is further configured to transmit a difference between the third frequency and the fourth frequency.

14. A method of operating a user equipment (UE), the method comprising:
receiving, from a first transmit receive point (TRP), a first downlink (DL) positioning reference signal (PRS);
measuring a first carrier phase associated with a first frequency of the first DL PRS,
measuring a second carrier phase associated with a second frequency of the first DL PRS,
including, in a measurement report, a carrier phase measurement based on the measurement of the first carrier phase and the second carrier phase, and
transmitting the measurement report to a network.

15. The method of claim 14, wherein the carrier phase measurement is a difference between the measurement of the first carrier phase and the measurement of the second carrier phase.

16. The method of claim 14, further comprising receiving a difference between the first frequency and the second frequency.

17. The method of claim 14, wherein the carrier phase measurement in the measurement report is for a first in time multi-path component.

18. The method of claim 14, further comprising receiving carrier phase measurements of a positioning reference unit (PRU) and a location information of the PRU.

19. The method of claim 14, further comprising:
receiving, from a second TRP, a second DL PRS,
measuring a third carrier phase associated with a third frequency of the second DL PRS, and
measuring a fourth carrier phase associated with a fourth frequency of the second DL PRS,
wherein the carrier phase measurement in the measurement report is further based on:
the measurement of the third carrier phase, and
the measurement of the fourth carrier phase.

20. The method of claim 14, further comprising:
transmitting, to a base station (BS), a sounding reference signal (SRS) for positioning; and
receiving, a carrier phase measurement based on measurement of a third carrier phase and a fourth carrier phase associated with third and fourth frequencies, respectively, of the SRS for positioning.
